(19) United States
(12) Patent Application Publication
(10) Pub. No.: US 2013/0132320 A1
(43) Pub. Date: May 23, 2013

(54) INNOVATION EXPERT SYSTEM, IES, AND ITS PTR DATA STRUCTURE, PTR-DS

(71) Applicant: Sigram Schindler, Berlin (DE)

(72) Inventor: Sigram Schindler, Berlin (DE)

(73) Assignee: SIGRAM SCHINDLER BETEILIGUNGSGESELLSCHAFT MBH, Berlin (DE)

(21) Appl. No.: 13/743,917

(22) Filed: Jan. 17, 2013

Related U.S. Application Data
(63) Continuation-in-part of application No. 13/608,543, filed on Sep. 10, 2012.
Application No. 13/608,543 is a continuation-in-part of application No. 12/756,254, filed on Apr. 8, 2010, now abandoned.
Application No. 13/608,543 is a continuation-in-part of application No. 13/229,362, filed on Sep. 9, 2011.
Application No. 13/229,362 is a continuation of application No. 13/093,682, filed on Apr. 25, 2011, now abandoned.
(60) Provisional application No. 61/533,499, filed on Sep. 12, 2011.
(60) Provisional application No. 61/537,202, filed on Sep. 21, 2011.
(60) Provisional application No. 61/539,699, filed on Sep. 27, 2011.
(60) Provisional application No. 61/542,988, filed on Oct. 4, 2011.
(60) Provisional application No. 61/546,187, filed on Oct. 12, 2011.
(60) Provisional application No. 61/569,534, filed on Dec. 12, 2011.
(60) Provisional application No. 61/590,474, filed on Jan. 25, 2012.
(60) Provisional application No. 61/592,072, filed on Jan. 30, 2012.
(60) Provisional application No. 61/599,607, filed on Feb. 16, 2012.
(60) Provisional application No. 61/610,656, filed on Mar. 14, 2012.
(60) Provisional application No. 61/614,827, filed on Mar. 23, 2012.
(60) Provisional application No. 61/622,653, filed on Apr. 11, 2012.
(60) Provisional application No. 61/624,554, filed on Apr. 16, 2012.
(60) Provisional application No. 61/639,270, filed on Apr. 27, 2012.
(60) Provisional application No. 61/656,286, filed on Jun. 6, 2012.
(60) Provisional application No. 61/671,977, filed on Jul. 16, 2012.
(60) Provisional application No. 61/673,525, filed on Jul. 19, 2012.
(60) Provisional application No. 61/680,420, filed on Aug. 7, 2012.
(60) Provisional application No. 61/683,377, filed on Aug. 15, 2012.
(60) Provisional application No. 61/684,899, filed on Aug. 20, 2012.
(60) Provisional application No. 61/697,593, filed on Sep. 6, 2012.
(60) Provisional application No. 61/319,088, filed on Mar. 30, 2010.
(60) Provisional application No. 61/313,860, filed on Mar. 15, 2010.
(60) Provisional application No. 61/304,549, filed on Feb. 15, 2010.
(60) Provisional application No. 61/296,089, filed on Jan. 19, 2010.
(60) Provisional application No. 61/263,679, filed on Nov. 23, 2009.
(60) Provisional application No. 61/261,585, filed on Nov. 16, 2009.
(60) Provisional application No. 61/259,930, filed on Nov. 10, 2009.
(60) Provisional application No. 61/252,894, filed on Oct. 19, 2009.
(60) Provisional application No. 61/240,401, filed on Sep. 8, 2009.
(60) Provisional application No. 61/236,366, filed on Aug. 24, 2009.
(60) Provisional application No. 61/234,376, filed on Aug. 17, 2009.
(60) Provisional application No. 61/227,565, filed on Jul. 22, 2009.
(60) Provisional application No. 61/223,127, filed on Jul. 6, 2009.
(60) Provisional application No. 61/219,209, filed on Jun. 22, 2009.
(60) Provisional application No. 61/184,938, filed on Jun. 8, 2009.
(60) Provisional application No. 61/183,279, filed on Jun. 2, 2009.
(60) Provisional application No. 61/181,998, filed on May 28, 2009.
(60) Provisional application No. 61/170,217, filed on Apr. 17, 2009.
(60) Provisional application No. 61/169,159, filed on Apr. 14, 2009.
(60) Provisional application No. 61/168,036, filed on Apr. 9, 2009.
(60) Provisional application No. 61/497,140, filed on Jun. 15, 2011.
(60) Provisional application No. 61/504,435, filed on Jul. 5, 2011.
(60) Provisional application No. 61/515,493, filed on Aug. 5, 2011.
(60) Provisional application No. 61/522,865, filed on Aug. 12, 2011.
(60) Provisional application No. 61/526,831, filed on Aug. 24, 2011.
(60) Provisional application No. 61/528,431, filed on Aug. 29, 2011.
(60) Provisional application No. 61/531,538, filed on Sep. 6, 2011.
(60) Provisional application No. 61/352,528, filed on Jun. 8, 2010.
(60) Provisional application No. 61/374,312, filed on Aug. 17, 2010.
(60) Provisional application No. 61/380,377, filed on Sep. 7, 2010.
(60) Provisional application No. 61/384,770, filed on Sep. 21, 2010.
(60) Provisional application No. 61/387,217, filed on Sep. 28, 2010.
(60) Provisional application No. 61/389,829, filed on Oct. 5, 2010.
(60) Provisional application No. 61/394,822, filed on Oct. 20, 2010.
(60) Provisional application No. 61/407,076, filed on Oct. 27, 2010.
(60) Provisional application No. 61/408,291, filed on Oct. 29, 2010.
(60) Provisional application No. 61/408,790, filed on Nov. 1, 2010.
(60) Provisional application No. 61/410,066, filed on Nov. 4, 2010.
(60) Provisional application No. 61/410,971, filed on Nov. 8, 2010.
(60) Provisional application No. 61/412,822, filed on Nov. 12, 2010.
(60) Provisional application No. 61/413,517, filed on Nov. 15, 2010.
(60) Provisional application No. 61/414,483, filed on Nov. 17, 2010.
(60) Provisional application No. 61/415,021, filed on Nov. 18, 2010.
(60) Provisional application No. 61/415,964, filed on Nov. 22, 2010.
(60) Provisional application No. 61/416,478, filed on Nov. 23, 2010.
(60) Provisional application No. 61/417,330, filed on Nov. 26, 2010.
(60) Provisional application No. 61/417,477, filed on Nov. 29, 2010.
(60) Provisional application No. 61/418,179, filed on Nov. 30, 2010.
(60) Provisional application No. 61/420,058, filed on Dec. 6, 2010.
(60) Provisional application No. 61/426,825, filed on Dec. 23, 2010.
(60) Provisional application No. 61/427,244, filed on Dec. 27, 2010.
(60) Provisional application No. 61/428,941, filed on Dec. 31, 2010.
(60) Provisional application No. 61/431,129, filed on Jan. 10, 2011.
(60) Provisional application No. 61/435,551, filed on Jan. 24, 2011.
(60) Provisional application No. 61/440,053, filed on Feb. 7, 2011.
(60) Provisional application No. 61/442,896, filed on Feb. 15, 2011.
(60) Provisional application No. 61/447,401, filed on Feb. 28, 2011.
(60) Provisional application No. 61/472,915, filed on Apr. 7, 2011.
(60) Provisional application No. 61/476,162, filed on Apr. 15, 2011.
(60) Provisional application No. 61/477,870, filed on Apr. 21, 2011.
(60) Provisional application No. 61/704,848, filed on Sep. 24, 2012.
(60) Provisional application No. 61/708,253, filed on Oct. 1, 2012.
(60) Provisional application No. 61/710,219, filed on Oct. 5, 2012.
(60) Provisional application No. 61/717,706, filed on Oct. 24, 2012.
(60) Provisional application No. 61/750,084, filed on Jan. 8, 2013.

(51) Int. Cl. G06N 5/02

(52) U.S. Cl. CPC G06N 5/02
USPC 706/46

(57) ABSTRACT

The claimed Innovation Expert System, IES, and for a given innovation/invention the claimed Data Structure DS—structurally being the same for any innovation/invention—meet two kinds of functional requirements. They support:

(I) determining all the innovation's/invention's technical/legal relations to given prior art information,
(II) instantly recognizing and answering any reasonable query about any such relation alias fact.
Functionality (I) enables generating/providing functionality (II)—jointly implemented by IES and DS, also usable by other expert systems. DS results from screening the innovation for technical/legal informal fundamental facts, transforming them into technical/legal formal fundamental facts, these into technical/legal primary facts, these into technical/legal secondary semantic/creative/inventive and pragmatic facts, and these into argument chains being the final technical/legal facts. All facts use the number and kinds of independent creative/inventive concepts alias thoughts needed for finding/qualifying the invention over prior art, as induced by HIGHEST COURTS of Germany and recently the US.

### I. THE CLAIMED INVENTIONS: THE IES AND THE PTR-DS UNDERLYING IT

Any innovation alias invention—embodying technically creative steps, “technically” meaning “a technique embodying”, this technique not being limited to a “machine or transformation”^{i),*),4),7)}—comprises a new technique teaching, TT.0, disclose⁵⁾ in an enabling way by a document.0, being nonobvious over pertinent ordinary skill(s) and prior art, whereby the latter is represented by a reference set RS of documents.i disclosing TT.i's, 1≦i≦l, which potentially anticipate^{III.2} TT.0. All doc.i's, i≧0, are to be interpreted by the person of pertinent ordinary skill for deriving from them their TT.i's. The pair <innovation/TT.0, prior art RS> is called “PTR” (“problem of TT.0 & RS”).

The Innovation Expert System, IES, hence is a PTR Expert System. It is defined by the practical functional requirements it meets: These two kinds of functionalities comprise supporting, for any PTR, in its careful analysis

(I) deriving from it all technical and legal facts alias relations between TT.0 and a given RS respectively a given context, such as a given legal system (in the US e.g. to 35 USC §§112, 102/103, and 101) and then
(II) leveraging on this analysis instantly recognizing and answering any reasonable query for any such relation.

Its kind (I) functionality uses a subsystem, which comprises a “PTR-PS” (=“PTR Problem Solver”^{III.1/3,IV,V}), such as the FSTP-Test¹⁾, which is not part of this patent application—except that the “PTR-S” (=“PTR Solution”^{III.1}) delivered by a PTR-PS'es execution enables generating a PTR/TT.0 specific “PTR-DS” (=“PTR Data Structure”^{IV}), which in turn enables IES to provide the kind (II) functionality. The IES as well as the generation of a PTR-DS is the subject matter of this patent application. This way of thinking about an IES/PTR-DS is called “FSTP Technology^{III.3}”.

I.e.: The claimed IES (FSTP=“facts screening & transforming processor”) would be able to provide its type (II) services using an also claimed PTR-DS of any underlying PTR and derived by means of any PTR-S. Thereby the PTR-DS represents screening PTR's documents for all technical and legal informal fundamental facts, transforming them into technical and legal formal fundamental facts, transforming these into technical and legal primary facts (the US “Graham facts”), and transforming these into the technical and legal secondary semantic/creative/inventive and pragmatic facts^{4)a.-g.}—the facts' “legal” aspects not yet known by the FSTP Test¹⁾. These technical and legal facts are based on a “creativity/inventivity/pragmaticity” metric induced by HIGHEST COURTS, in particular of the US, which identified the number and kinds of independent creative/inventive/pragmatic thoughts resp. concepts^{III.3.2.4)a.-g.} needed for finding/creating/qualifying TT.0 over RS. This thinking^{*)} underlying FSTP Technology may be modeled as a new law of nature^{III.1}, which is axiomatized by the mathematical/epistemological FSTP Model of Innovation¹⁰⁾.

### II. EPISTEMOLOGICAL FUNDAMENTALS OF THE CLAIMED INVENTIONS

The success of many companies and even societies has been based on innovations they were using or marketing or even creating. Dealing with innovations frequently means detecting and unlocking—as to whatsoever subject matter(s)—some novel pieces of rationality^{*)}, which were unknown or not understood before (i.e. belonging to metaphysics/irrationality/fictionality) and enabled better life thereafter, i.e. after their rationalization became available. This novel rationality embodied by an innovation may be straightforward to create^{4)g.(7)}, such as that of a specific acoustic alarm supporting the GUI of a computer application, or be of measurable inventivity^{III.1}, such as a controller of a combustion process—and in the latter case may be granted temporary commercial protection by patent law.

A PTR-DS enables an IES to support unfolding, improving, evaluating, communicating²), arguing about, and protecting the rationality of an innovation^{*),3),4)} in any subject area in a scientifically accurate way. While “rationalizing” innovations ever were created in many arts, hitherto they initially never could enjoy the scientific support—as provided by FSTP Technology—based on leveraging recent HIGHEST COURTS' precedents.

Historic spin-offs from prior arts caused by their “rationalizing innovations”—which got truly scientific support only after longtime—are: Construction engineering technologies evolving from architectures, transport technologies from vehicle manufacturing, medical technologies from healing practices, financial technologies, trade technologies, . . . . The lesson learned from them and conveyed by this new “innovation technology” is how to accelerate, improve and/or evaluate any such innovation right from its first beginning. I.e.: Hitherto it was unknown that rationalizing “innovativity” in all subject areas, i.e. that “pushing back frontiers to their unknown”, is amenable to scientific rigor^{1),*)}. This new innovation science/technology itself is the rationalizing springing-off from patent law precedents, as it has been developed by HIGHEST COURTS by protecting innovations in their resp. underlying craft-based arts^{*),4)}.

Already the above first quoted historic analogy to this emerging innovation natural science shows that its rationalization process, i.e. developing the building construction technology, may be a dramatic expansion and sharpening of the previously only existing terms/notions: While the building construction technology is based on mathematical/physical models of a building (to be analyzed) based on systems of differential equations, the architects designing this very building would not really understand such differential equations—but would just know they are compulsory, today. No such deep discrepancy exists with the innovation technology emerging, when analyzing a TT.0 by FSTP Technology. Here the terms/notions of TT.0 inventors and of FSTP Technology are much closer to each other.

Upfront to explanations^{IIII} as to the emerging innovation science resp. FSTP Technology, some more background information is provided about the underlying FSTP Model of Innovation¹⁰⁾ by the subsequent paragraphs^{*)}.

Although it was not understood that way at the time it happened, any one of the above technologies evolved by means of an underlying specific purely intuitive model^{*)} of its art's specific reality, whereby any such mental model intuitively evolved such as to support a person of pertinent skill in describing/recognizing a resp. class of problems he is dealing with and solutions of them. Not only technologies but also mathematics, natural sciences, jurisdiction, sociology, economy, sports, welfare, . . . , evolved together with their skills and specific and intuitive models of them.

As opposed to their diversity, the FSTP Model of Innovation¹⁰⁾ is universal and fully axiomatized. It hence is capable of precisely/uniquely/non-mistakably identifying—for whatsoever art/science with some affinity to rationality, i.e. allowing describing at least one of its facts/relations⁴⁾ by means of a predicate—the single steps of its evolvement over some given prior art: The FSTP Model thus enables any PTR-PS, such as the FSTP Test, to mathematically determine, for its innovation/TT.0 the various creative steps indispensably required for finding this innovation/TT.0, when starting the search for it from its prior art RS. Any PTR-PS thereby in particular determines, for this innovation/TT.0, a lower bound for its creative/inventive height≧0 over this prior art, which it (this innovation/TT.0) embodies.

The notional fundamentality of the FSTP Model is that of purely mathematical models and their axioms^{*),10)}. I.e.: It is more fundamental than the models of physics, e.g. mechanic, optical, . . . While their axioms alias laws leave the area of logics and hence need verification by physical experiments, the FSTP Model remains within the area of mathematics/logics^{*)}—just as any purely mathematical model—and hence needs no such verification. But this implies that many potential IES users are not used to the terminological/notional preciseness required by applying FSTP Technology—even if they are familiar with other sciences and/or technologies, where similar problems arise²⁾. The subsequent introduction and explanation of these terms/notions^{III.3.2} is therefore unfortunately non-trivial.

A final remark shall help to understand the unusual foot-/endnote structure of this patent application. Its introductory Sections^{I.-III.} summarize key features of FSTP Technology as such, while the foot-/endnotes provide background information:^{*),2),3)} from philosophy/epistemology/linguistics,⁴⁾⁻⁷⁾ from HIGHEST COURTS' patent precedents and advanced IT, and ⁸⁾⁻¹⁰⁾from standardization/mathematics/logics.

### III. MATHEMATICALLY MODELING A PTR AND RECENT HIGHEST COURTS' PATENT PRECEDENTS

This Section III provides the epistemological/mathematical “Knowledge Representation (KR)” fundament for a decisive feature of a future Mathematical Innovation Theory, of which Patent Technology alias FSTP Technology is a first result. It is focused on KR issues underlying recognizing innovations, i.e. it vastly omits legal issues. Hence, a “patent business practitioner” may skip it—though it would facilitate grasping this innovation.

### III.1—The PTR and its Solution

Modeling the PTR comprises informal and formal descriptions of PTR's TT.i's, to be derived from its “doc.i's” annotated items of information^{III.1,IV.,V.}. A description is “formal”, if it is exact for the person of pertinent ordinary skill (often excluding using natural language onlyⁱⁱ⁾). I.e., it identifies

(a) X.i.n, n=1, 2, 3, . . . , N, 0≦i≦l as N “elements” and “peer elements” of its TT.0 resp. TT.i's disclosed by doc.i,
(b) X.i.n, n=1, 2, 3, . . . , N, 0≦i≦l as FOL “predicates”^{5),7)} of these X.i.n's—precisely: all relevant ones^{III.3.2N6}—and
(c) C.k, k=1, 2, 3, . . . , K as “concepts”^{5)b.,7)c,9)1.} with values needed for defining the N X.0n^{III.3.2}.

The “PTR solution, PTR-S”—also called “PTR's knowledge, K(PTR)”^{III.3.1} (abstracting from its o-/AD-/BID “knowledge representations, KRs”^{III.2/3/4,IV,V})—comprises the items of information (a)-(h), called:

(d) “reference set, RS”, the set of TT.i's disclosed by doc.i, 1≦i≦l, being its TT.0's prior art^{T.}0's prior art^{5),6),7)},
(e) “technical fundamental informal facts”, being disclosures⁵),⁶),⁷) of all TT.i properties in doc.i, 0≦i≦l.
(f) “technical fundamental formal facts”, being X's properties precise descriptions by the above X.i.n's^{5),6),7)}.
(g) “technical primary facts”, the “Anticipates/Not-anticipates-&-not-contradicts/Contradicts, ANC”¹⁾ relations between all X.i.n's, i>0, and X.0.n's (i.e. the US “Graham technical facts”, here put more precisely as formally).
(h) “technical secondary fact”, determined by a “PTR-PS”^{III.3.1,IV.,V.}—one of i)-iii)¹⁾, but here considering ii) only:

i) The (close to classic) technical secondary “basic” fact as straightforward consequence of its Graham facts.

ii) The (innovative) technical secondary “semantic/creative” alias “plcs” fact as pair of two components:
1.) The “creative/inventive alias plcs-height, Q^{plcs}” (plcs=patent law carrying semantics) of TT.0 over RS. The metric unit of plcs-height is an “independent thought⁴⁾”: At least Q^{plcs} such thoughts are needed for finding TT.0 starting from RS^{III.3.2.N1}. I.e.: There is no q=Q^{plcs}, an “anticipation-combination, AC^{III.2}”, and q “1-concept-creations, 1-CCs” alias a “q-CC”⁴⁾, with “AC/mod(q-CC) ants TT.0.”^{III.3.2}.
2.) The “Q^{plcs}-paths-set, Q^{plcs}-PS”, being the set of all “Q^{plcs}-AC-sets”, each of them being the set of all pairs <x, y>, x being a Q^{plcs}-AC, y one of the Q^{plcs}! elements of the set of Q^{plcs}-CCs^{4)b.,6)a.} for this very Q^{plcs}-AC.

iii) The technical secondary “pragmatic” alias “pmgp”⁴⁾ fact as pair of:
1.) The “pragmatic alias pmgp-height, Q^{pmgp}” (pmgp=patent monopoly granting pragmatics) of its TT.0 over its RS. The metric unit of pmgp-height is the same as above, but the AC/mod(q-CC) now are additionally subject to pmgp¹⁾, which potentially affects q-CCs and thus may make Q^{pmgp} become < or ≧Q^{plcs}. hereby PTRs with “really highly creative” TT.0s usually would not be affected by pmgp^{III.3.2.N1}.
2.) The “Q^{pmgp}-paths-set, Q^{pmgp}-PS”, being the Q^{plcs}-PS analogon with all paths pmgp approved^{1),4)g.(5-9)}, too.

### III.2—FSTP Notions Enabling HIGHEST COURTS' Induced “Conceptual Disaggregations of Inventions”

The FSTP/PTR Model of Innovation¹⁰⁾—for deriving from a PTR its legal solution PTR-S^{IIL.1} the advanced IT way*⁾—is based on HIGHEST COURTS' notions of creating “independent thoughts” resp. notional equivalent “inventive concepts”^{iii),4),III.3.2}. For clearly defining these new fundamental notions, additional^{III.1} FSTP notions—in line with most national patent systems (“NPSes”)—are “modeled by” (abbr. by “≈”) first still tolerating vagueness until the notion of “concept” is clearly defined^{III.3.2}. These FSTP notions (becoming precise only later^{III.3.2}) are:

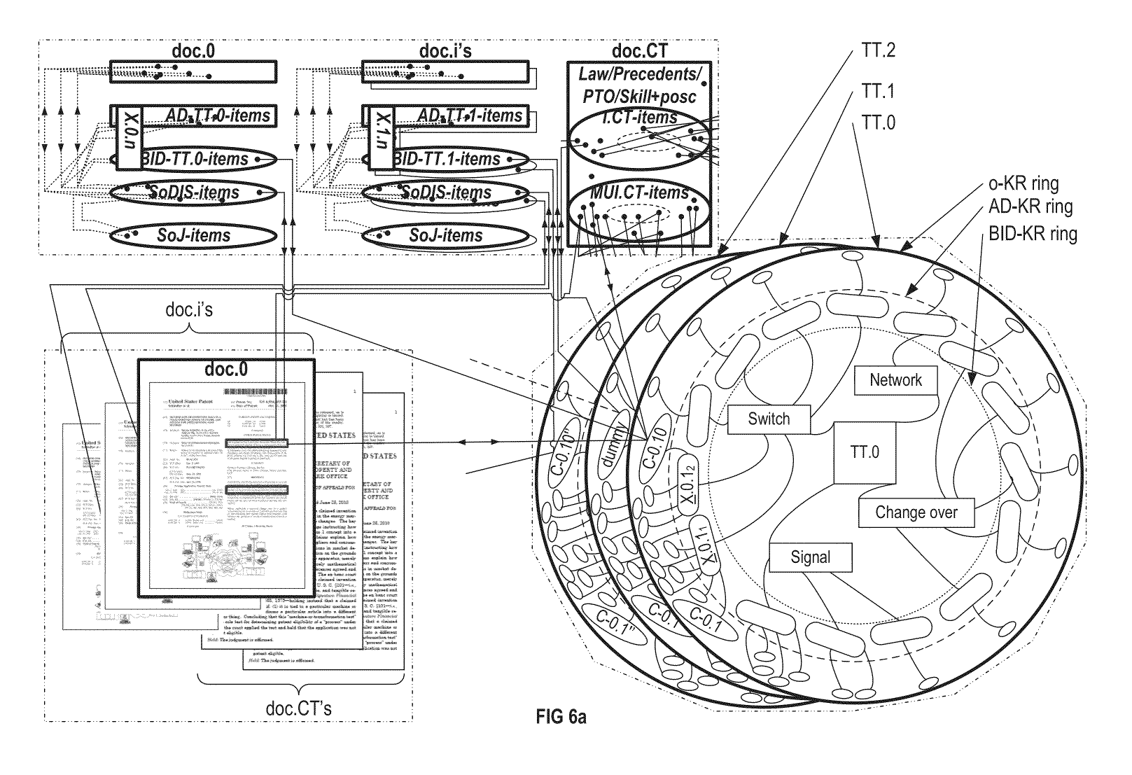

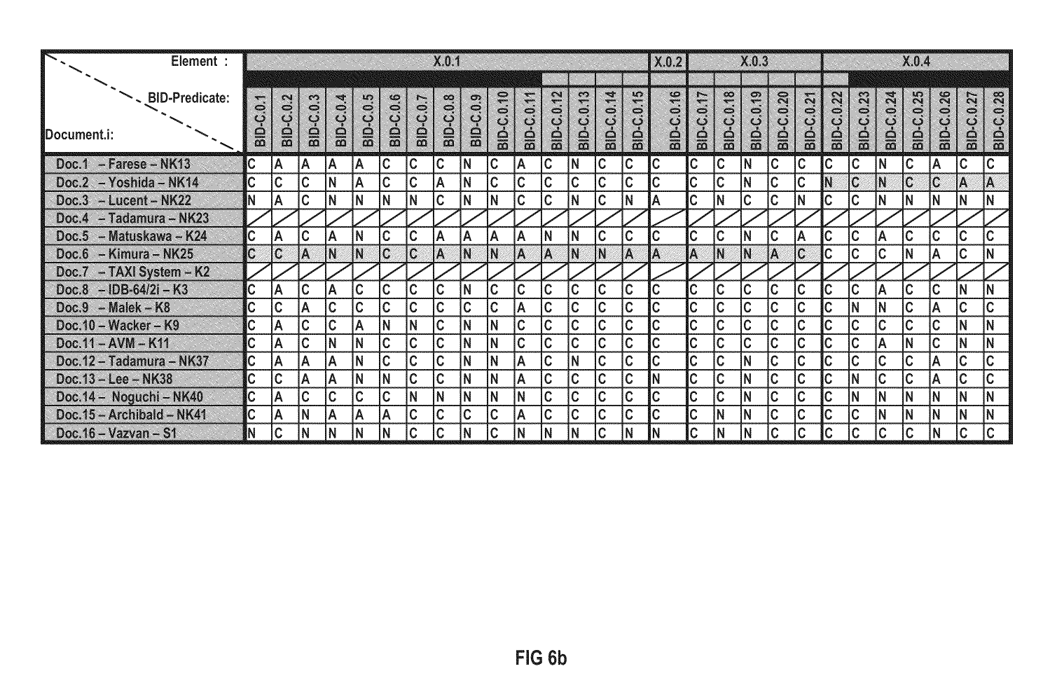

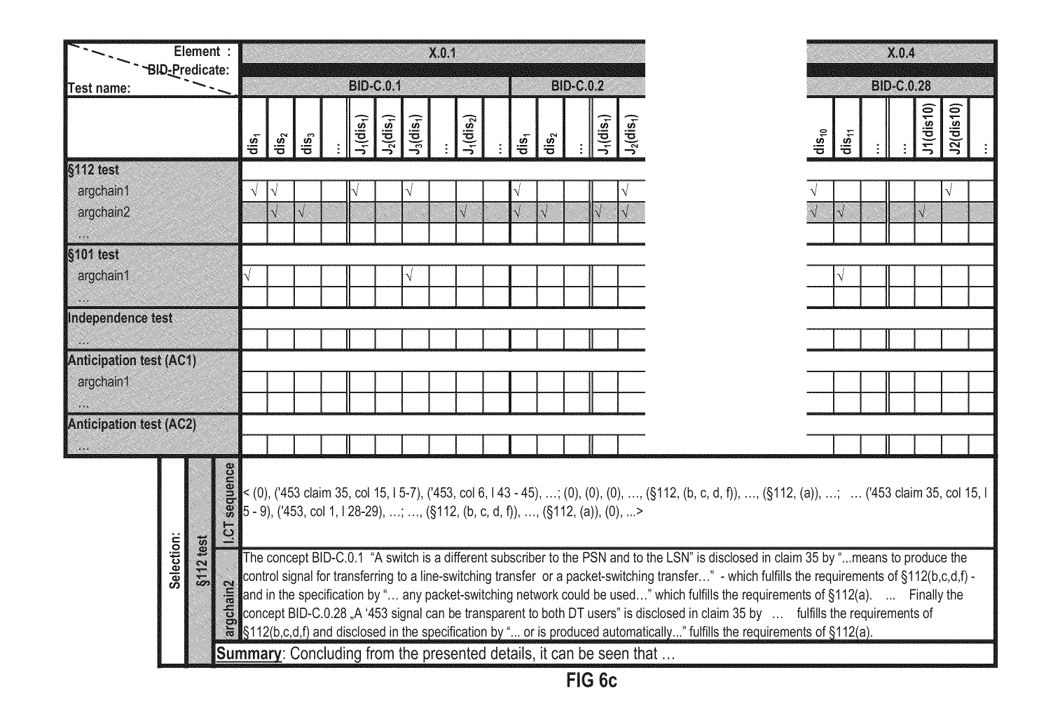

“anticipation-combination, AC”≈any N-tupel∈ps+pa*, whereby “ps+pa*”::=the set of the (l+1)**N N-tuples, any one of their n components being either an X.i.n (1≦i≦) or some ∈ps, and “AC^{ps}”::=all N components∈ps,
“q-CC”≈a sequence of q 1-CCs⁴) of “concept creations”^{6)a.} in an AC, q=0, 1, 2, . . . , “0-CC” being the null-creation,
“Q^{plcs}-AC”≈any AC: ∃Q^{plcs}-CC with Q^{plcs}-AC/mod(Q^{plcs}-CC) ants TT.0, with Q^{plcs} being minimal,
“plcs^{xxx}-height, Q^{plcs/xxx}”≈Q^{plcsIII.1} under one of the 4 options iii) below ^{4)c.}, indicated by “xxx”,
“Q^{pmgp}-AC” and “pmgp^{xxx}-height, Q^{pmgp/xxx}”≈analogously^{III.1,V.1,FIG 6b}, with “Q-AC”≈minimally limitation ignored.

Let for any AC and q-CC, q=0, 1, 2, . . . , the above^{III.1} anticipation relation of “AC/mod(q-CC) to TT.0” be called:

i) “contradictionless”, if “AC/mod(q-CC) not-contradicts (TT.0 or any TT.i involved⁶) in this AC)”, q≧0.
ii) “element integrity preserving”, if AC/mod(q-CC) antsTT.0 “element-wise/element-by-element”^{5)d.,6)c.}.
iii) “free” resp. “normal” (default), if none resp. both of i) & ii) apply, “xxx” id-ing 1 of the 4 “anticipation options”.
To i): In HIGHEST COURTS' precedents, a TT.i contradicting TT.0 often is to be excluded from any AC, as TT.i then “teaches away” the skilled person from deriving TT.0 from the given prior art RS¹⁾.
To ii): All HIGHEST COURTS' precedents agree: An AC must neither be .) “cherry picking” X.i.n_{φ.i}'s from different TT.i's, i>0—if X.0.n and some peer X.i.n's are conjunctions of resp. several X.i.n_{φ.i}, 0≦i≦l, φ.i=1, 2, 3, . . . —for ant-ing of TT.0 its X.0.n^{5)d.,6)}^{a.,6)}^{c.,9)}, nor :) combining more than maximally 3 doc.i's.
To iii): Due to checking the Q^{plcs/xxx}-PS by pmgp, the resulting Q^{pmgp/xxx} may become <or=or>Q^{plcs/xxx}.

Deriving from a PTR its legal solution, PTR-S^{III.1}, the scientific way*⁾—only this approach to deriving PTR-S guarantees nationally and internationally consistent and predictable patent jurisdiction and hence has recently been prompted/induced by HIGHEST COURTS, in particular in the US—requires a more fundamental understanding of the interplay between patent jurisdictions' needs and potentials on the one side and on the other side the actual capabilities of advanced IT as to facts determination and claim/patent interpretation. For showing that this interplay between such cutting edge IT and HIGHEST COURTS' patent precedents actually is extremely fertile⁹)5., the most substantial decisions of the SUPREME COURT as well as the CAFC and the broad discussions they stimulated among US patent law professionals are outlined below⁴). These HIGHEST COURTS' patent decisions are underlying and controlling both innovations of this patent application as well as the drafting of its decisive Section V.

This discussion^{4)e.-g.} in the US is indeed utmost remarkable as it represents epistemologically a huge step forward in patent jurisdiction towards its unquestionability and predictability—exceeding in size as to its semantics and pragmatics the detection of the Graham facts in the 1960s—i.e. towards making its facts determination and claim interpretation mature to become, as spin-off^{II.} from patent precedents, the fundament of patent technology^{iv}).

III.3—Modeling K(PTR) by Concepts^{v)} and Compound Concept Disaggregation. Section V. discloses both: Generating a PTR-DS in an enabling way to the person of posc^{III.3.2D1/N1,D2/N2,D4/N4} in creating/developing/analyzing/protecting/attacking inventions and in advanced IT as well as the functionality of the IES. This Section III.3 provides the KR—more generally: “advanced IT”—fundament on which both innovations are based, in particular the fundamental notions of “concept” and “disaggregating compound concepts into independent concepts”. But these notions also may be used without knowing much of this background, which means that patent practitioners may skip this Section.

III.3.1 The PTR-DS facilitates patent business—when using today's clear patent precedents of the HIGHEST COURTS⁴⁾ as to the indication of an invention's (non)obviousness over its prior art^{III.1}—by an application of basic means from pertinent advanced IT (System Design, Semantics Research, Terms Rewriting⁾*, DL⁾*, KR⁾*) and mathematics. More precisely: The process of generating the PTR-DS^{IV.}, i.e. providing the basis for this facilitation, is itself based on an integrated application of two other advanced interactive patent business IT services, which both are outside of the scope of this patent application. These are: A PTR document mark-up (PTR-DMU) service, such as the USPTO's PE2E service^{IV.,V.}, and a PTR problem solving service, such as the FSTP-Test service¹⁾: For a PTR, the

PTR-DMU service transforms interactively PTR's doc.i's into sets of “MUI” items (“marked-up information” items), which comprise PTR's technical⁷⁾ and legal fundamental informal facts, i≧0—and
PTR-PS service transforms interactively the so defined technical MUIs into PTR's technical fundamental formal facts, its technical primary facts, and its technical secondary facts^{III.1} (leaving the involved KR transformations^{III.3.2} from “o-PTR” to “AD-PTR” to “BID-PTR” and back aside for the moment^{vi)}).

The notion of “technical” assumed here is today more US than EU like^{vii)}.

This solution of the PTR problem^{III.1} is derived by any PTR-PS from the “LAW OF INNOVATION”, being a new “law of nature”^{4)a.,d.}, saying: “The creativity/inventivity embodied by a nonpathological innovation/TT.0 over some prior art, RS, is indicated by the number of independent thoughts indispensably needed for finding TT.0 when starting the search for it from RS—which is an invariant over all knowledge representations of PTR”^{III.3.2}. It thus is the indisputable measure of the degree/amount of novelty of TT.0 over this prior art RS.

The first part of this new law of nature has been induced by the HIGHEST COURTS' precedents, which assumes and repeatedly communicated (implicitly)^{4)a.-g.} that this is the right way of quantifying and qualifying the “creativity/inventivity indication” embodied by an invention/innovation/TT.0 over its prior art RS. This new law of nature is a metaphysical/fictional phenomenon carved out of the transcendent/imaginary⁾*, just as any law of physics is carved out of metaphysics⁾*. The axiomatization¹⁰⁾ of this new law of nature turns all hitherto developed plainly speculative/philosophical ideas about the creativity/inventivity process embodied by a PTR's TT.0^{4)b.} over its RS into mathematical consequences of these axioms. This meets Kant's postulate³⁾ about “special doctrines of nature”, here about this HIGHEST COURTS induced “law of innovation” as to a TT.0's creativity/inventivity: In the creativity/inventivity “only so much real science can be found, as there is mathematics found”. The mathematics found in a PTR, PTR-S alias K(PTR), has many representations^{D3/N3} defined by the set of concepts used for coding it, i.e. KR(PTR)s.

I.o.w.: Determining the independent thoughts embodied by K(PTR) is always started informally by screening the disclosures of PTR's doc.i. Becoming precise about these thoughts²⁾ requires PTR's mathematical modeling by independent and hence often disaggregated concepts⁹⁾. This presentation of the PTR enables

proving the existence of this LAW OF INNOVATION, i.e. any PTR's above invariance over all its KRs^{III.3.2}, and
clearly representing, separating from each other, and thus analyzing independently of each other the various pragmatic aspects associated with any PTR^{9)5.},
which confirms the usefulness of this mathematical modeling by means of “disaggregating compound concepts into independent concepts”^{III.3.2}. While the notion of compound concept as such often is indefinable, the notion of independent concept therein usually is mathematically definable and hence enables mathematically solving the PTR by unquestionable facts determination—on which the courts' patent precedents may be based in the future.

This new law of nature of innovation invites developing predicate/term rewriting^{)[BN]}* algorithms for finding PTR-PS, e.g. “symbolic differentiation” based ones. The “concept rewriting” FSTP-Test¹⁾ is more “symbolic integration” based^{6)a.} and currently seems to be the most intuitive^{4),6),IV.,V.} such application of this new law of nature.

Executing a PTR-PS always means first transforming the originally diffuse/amorphous PTR in its entirety into an only finite set of clear facts determination problems, described by independent concepts and relations among them, often represented by predicates^{9)1.-2.}. This finite set of concepts/relations/predicates enables the finite set of argument-chains^{III.3.2,V.} comprising complete answers to any one of the only finitely many meaningful questions as to indicating/justifying e.g. TT.0's creative/inventive height over its prior art RS, and/or its claim being non-preemptive and/or its scope is well defined and/or . . . ^{9)5.}. But, in spite of the finiteness of these sets, such answers cannot be delivered in real-time: Today deriving them is highly interactive and search driven, i.e. time-consuming—in no way possible instantly. But, due to this finiteness, the generation of the complete PTR-DS (by applying the method invented and disclosed^{V.} by this patent application) may be performed up-front, such that PTR-DS is enabled to both: Automatically and instantly recognizing any query about the PTR's technical and legal facts as rational or not, as well as retrieving the complete answer to this query and presenting it in a user requested representation^{IV.,V.}.

These PTR-DS capabilities enable any of its application systems using it, i.e. a variety of automated real-time decision support systems—such as the IES, being one of the claimed inventions—or the upcoming “Transition Control Systems” (between evolutionary states of a huge system e.g. a nation's branch of economy), or “Automatic Marketing Systems” (in particular of the new kind of green/energy/health/medical/gene/nano/ . . . innovations¹⁾)—to deliver such services.

Before introducing the notions of compound and independent concepts—and for facilitating understanding the ftn⁴⁾⁻⁷⁾ dealing with them—an example for their potential degree of complexity, in particular if standardized^{viii)}.

III.3.2 A PTR-DS is a coding of K(PTR) using a set of “concepts^{4)d.}, {o-C}∪{AD-C}∪{BID-C}”^{D3/N3}, subcategories of these 3 categories of Cs being “{cr-C}” and “{de-C}”, “creative/inventive”-Cs modeling “plcs”-facts^{III.1} resp. “definitional”-Cs modeling “disclosure”-facts. A de-C defines a cr-C's (meta-)semantics”^{4)g.(6-8),9)1.,V}.

A C is defined by its “universe, U(C)”: simplified being C's “value set, vC”, precisely being a unique mapping M of C's “domain, dC” onto vC; then U(C)={(x, y)|x∈dC [symbol] y=M(x)∈vC}. A C may be viewed as a highly parameterized “class” capable of “objects” with actual parameter values, such objects called concepts, too.

A C is called “binary” if vC={T,F}. For binary C′ and C″ let: the “truth set, TS(C′)”::={x∈dC′|M(x)=T}⊂dC′⁹⁾¹, and “C′ anticipates C″”, i.e. “C′ ants C″”, if TS(C′)=TS(C″). This notion of “concept” enables exactly describing and/or analyzing all properties of all the elements of claimed inventions⁹⁾, as required by patent jurisdiction.

The prefix “o/AD/BID” of a concept identifies the “knowledge representation, KR”^{III.1} of K(PTR) in which any C is given—“original, o” or “aggregated [symbol] disclosed, AD” or “binary [symbol] independent [symbol] disclosed, BID”^{5i),9)1.} The “o” prefix of a C identifies the “marked-up items, MUI^{m}.i”, 1≦m≦Mⁱ, of information in document.i^{D3,IV.,V.}, 0≦i≦l, disclosing^{5)b.} C therein. All these and the subsequent^{D1-D5} terms/notions are customized for providing a fundament for mathematically modeling the rationality in HIGHEST COURTS' patent precedents⁴⁾, and only this rationality.

o-Cs/AD-Cs initially need to be determined only “casually”^{5)b.,7)c.} as then modeling meta-semantics; they then are called “meta-Cs”. BID-Cs got to model precise semantics^{N3,N5i).),9(1.-2.}. Any one of the 3 KRs of K(PTR) is modeled by 3 disjoint C-sets: “{posc-C}” models “pertinent ordinary skill(s)/creativity, posc” as defined by class/skill text books¹⁾ and ordinary creativity (posc is often abbr. by “ps”), “{pa-C}” models “prior art, pa” defined by doc.i, i>0, and “{cr-C}” models the “invention/TT.0” defined by doc.0 over ps^{III.1,N5i),9)1.}. “{o-cr-c}∪{AD-cr-C}∪{BID-cr-C}” is the total set of “inventive/creative Cs”^{4)a.} embodied by TT.0 over ps+pa in in o-/AD-/BID-KR. In any KR an AC^{III.1}∈ps+pa* may ant some or all such cr-Cs. Determining only the “compound” AD-cr-Cs—and their original o-cr-Cs^{D3/N3}—is often misleading^{4)g.(5-8),7)c.}. I.e., often the BID-cr-Cs are needed, which they “comprise”^{N5i),9)1.}: HIGHEST COURTS' legal demands thus may be met, and seen from a KR technology point of view this is indispensable^{4)g.(5-8)}.

FSTP Technology serves for eventually determining the number and kinds^{4)g.(5-8)} of independent thoughts^{D1-2} embodied by a PTR's TT.0, i.e. the number and kind of BID-cr-Cs modeling these thoughts^{N1}. Any cr-C is mentally created by such a thought, which either 1.) modifies of a C∈“ps+pa” its U(C) by changing/removing/adding an ∈ vC or dC, or 2.) combines such CS∈ps+pa in a nontrivial way previously unknown in ps+pa^{5)d.,6)c.} or 3.) defines a BID-cr-C totally unknown in PTR's ps+pa. There is no other way such a BID-cr-C rationally may come into existence^{*)),D1/2,N1/2,9)4.}. The existence of BID-cr-Cs requires that their U(BID-cr-C)s are disclosed by PTR's doc.i's^{V}.

These BID-cr-Cs are indispensably created at TT.0 invention time (after TT.0's inventor has created their resp. thoughts^{4)a.,/b.,N1/2}); they provide the basis for deriving the creative height of TT.0 over RS^{III.1}, Q^{plcs}, the HIGHEST COURTS' induced way^{4)g.(2-8)}. Often the inventor never became aware of his/her creative/inventive concepts/thoughts underlying his/her TT.0 and hence disclosed them in doc.0^{5)b.,V.} only implicitly. They are implied by aggregated or independent o-/AD-de-Cs defining “definitional” subject matter modeling “disclosure” facts (to be used in claim construction), need not 1-to-1 define BID-cr-Cs, and also may ex- and/or implicitly be disclosed. I.e., neither the o-/AD-/BID-cr-Cs nor their o-/AD-/BID-de-Cs need to be immediately recognizable within doc.0. Nevertheless, rationality tells^{*)),D1/N1}: These BID-de-Cs/BID-cr-Cs alias elementary de-Cs/cr-Cs⁹⁾ eventually scientifically correctly model the “fundamental building blocks” of this invention/TT.0, i.e. the independent thoughts embodied by TT.0. The number and specific “locations of need” of these BID-cr-Cs in the TT.0—i.e. its “inventive/creative concepts” implied by HIGHEST COURTS' precedents^{4)a.-f.}—determine TT.0's creative height^{III.1/.2}, Q^{plcs}, over the ps+pa identified by RS, the BID-ps+pa−Cs thereby model what existed already prior to TT.0 invention time^{5)d.,6)c.}, and the BID-de-Cs thereby model where and how the BID-cr-Cs are defined^{4)g.(5-8)}.

The classical way of facts determination trusts—putting it in FSTP terminology—in TT.0's AD-cr-Cs and their AD-de-Cs, i.e. is fully based on only them though they often are deficient^{4)g.(5-8),7)}. The HIGHEST COURTS demand more careful facts determinations⁴⁾ without saying how it would work. FSTP Technology removes the deficiencies of classical facts determinations by seeking, in doc.0, for refinements^{4)e.,N5i),9)1.} of the AD-cr-Cs/AD-de-Cs to BID-cr-Cs/BID-de-Cs they comprise^{9)1.}. These refinements are always disclosed for the person of posc by doc.0, where it describes in an enabling way the inventive details of how its TT.0 may actually be realized.

This FSTP implementation of the HIGHEST COURTS' resp. suggestions^{4)e.-g.}—based on refinements of the AD-cr-Cs by BID-cr-Cs, i.e. not changing the AD-cr-Cs' meanings by definition of the notion “refinement”—raises questions, which are outlined by the two following bullet points.

The fundamental question is based on the following consideration. All our knowledge about physics and engineering disciplines tells us that transforming a problem presentation to an appropriate coordinate system (in our context: to an appropriate KR of the PTR) often greatly simplifies it and makes it much easier to solve than in the original coordinate system, i.e. in the “o-KR”^{D3/N3} of doc.0. Actually, this phenomenon also applies for the PTR and is leveraged on by transforming it, by FSTP Technology, from its o-KR to its AD-KR and then to its BID-KR^{D3/N3}. Thus the question is, whether this kind of simplification of the PTR, as achieved by these knowledge representation transformations (KRT), would not carry through to reducing e.g. the number of the HIGHEST COURTS' demanded independent thoughts⁴⁾ alias creative/independent concepts^{4)e.} (indispensably required for finding its solution/TT.0 over its prior art RS, when starting the search for it from RS).
The second—additional—question then is: Even if TT.0's creative height is uniquely determinable this way, can't it be that there are alternative and dramatically different sets of BID-cr-Cs based on alike ACs^{III.2}?

The normal expectation is—as expressed by experts from mathematics/IT/linguistics/ . . . and the more from patent law areas—that KRTs indeed would have such impacts. But the contrary is true. All significant facts turn out to be (for non-pathological PTRs) invariants over all KRTs—unless doc.0 is contradictory, which is excluded here.

For providing an idea of the problems any PTR-PS is confronted with when deriving PTR's BID-cr-Cs^{7)c.}, the working of the FSTP-Test¹⁾ is briefly outlined. It models, for any AC^{III.1/2}—comparing it to TT.0 by bringing the FOL predicates of both into a normal form by a fictional “1-crⁱ-C”, where in this AC at least one independent thought is needed^{6)a.,7)c.} for creating this 1-crⁱ-C, such that by q of them the AC/mod(q-crⁱ-C) ants TT.0.

To enable a clear understanding of these problems, mathematics-compliant definitions^{2),3)} are provided for what the meanings are of the terms “independent”, “creative thoughts”, and “inventive concepts”, what in turn requires such definitions e.g. of the notions “AD-KR(PTR)” resp. “BID-KR(PTR)”, for short “AD-PTR”/“BID-PTR”. These definitions are elaborated on next, prompting a thorough analysis of various o-/AD-/BID-PTR issues encountered. Clarifying these notions underlying any patent system shows that the HIGHEST COURTS' hints⁴⁾ imply a “paradigm change”⁴⁾: They demand a ground laying enhanced understanding of all patentability aspects of inventions^{V}.

This thorough analysis shows that this HIGHEST COURTS' patent precedents⁴⁾ actually repeatedly hinted at a “straight line”, which since ever has been pursued by mankind's development of rationality alias precise knowledge^{*))} at least since Aristoteles and clearly stated already by Leibniz, Newton, Kant et al³⁾: At the straight line of creating independent thoughts/concepts—here sensed by the HIGHEST COURTS' in their striving for factual and legal unquestionability/consistency/predictability/stability in patent jurisdiction.

A patent business practitioner need not get into the mathematical discussion of this “straight line” metaphor—for the eternal evolvement of rationality, here: that created by/for mankind. Geometrically it is a “tangential manifold” of the manifold of “rational relations”^{*))}, which separates it from the “rational relations less” manifold⁴⁾, i.e. from the “inaccessible by today's rationality”. He/She also needs not go into any mathematical detail of the subsequent elaborations^{4)b.} All he/she got to grasp is the meaning of the subsequent definitions as to a PTR and its K(PTR). The Defs/Notes 1-6 shall thereby enable getting a firm grip of this practical side of “scientifically clean” patent technology.

Def 1: A “thought” is called “independent”—here: “cr-independent”—if it creates an independent cr-C.
Note 1: The “cr-” prefix of independent, i.e. this limitation of broader notions of independency of thoughts/concepts, is used to remind of the lack of preciseness of the notions of the natural language terms^{2),3)} of “mental step”^{4)a.(i)}, “inventive concept”^{4)a.(ii)}, “independent thought”, “inventive step”, . . . —used by all NPSes. By contrast, here the meaning of “independent”—as used by HIGHEST COURTS' precedents in these terms/notions—is defined mathematics compliant¹⁰⁾. I.e.: The below Def 2 of the “cr-independency” alias “ind” relation specifies what HIGHEST COURTS' precedents^{4)a.} precisely mean when talking of independent thoughts/steps/concepts/ . . . . Due to their precedents, there seems to be no other rational^{*))} meaning of this term.
Def 2: A {BID-C} is called “ind_{c}”^{D4/N4} if [symbol] ∃(C′∈{BID-C} [symbol] 1-CC of dC′): .) [symbol] ^{∀}^{_{C}}^{∈{BID-C}\C′}C= [symbol] ^{∀}^{_{C}}^{∈{BID-C}}C [symbol] : {:) {BID-C}\C′≠{{BID-C}\C′}\C′mod(1-CC)}, whereby “C” stands for the mirror predicate of C^{9)1.-2.}. Let “dep”::= [symbol] ind.
Note 2: This mathematical definition of the meaning of the HIGHEST COURTS' term “independent”^{4)a.,4)g.(5),9)5.} holds only for BID-concepts—due to the notional obscurity of many AD-Cs^{4)g.(5),7)c.,9)1.-2.}. The definition of ind {BID-C} says that for any C′ holds: .) It adds a TT.0 limitation to those defined by {BID-C}\C′, and :) [symbol] ∃i:∃C′.i, C″.i∈Q^{plcs}-AC [symbol] modifying dC′.i—i.e. the definition of C′.i—by a 1-CC.i:C+.i/mod(1-CC) ant C′.0=>C″.i/mod(1-CC) ant C″.0^{9)3.} [symbol] none of both ant relations existed prior to modifying dC′.i by the 1-CC.

In particular: A PTR may have different maximal ind {BID-cr-C}s. And: A maximal ind {BID-cr-C} of a TT.0 is defined over its PTR's one or several posc(s) and over this PTR's RS, with a TT.i potentially exerting such an impact.

All below statements, e.g. Theorem 2 as to the invariances over all normalizing KRs of the PTR problem, are subject to a posc person's confirmation of ind {BID-cr-C}—the rest of their proofs then is unquestionable maths. A court should never cross the red line of such an affidavit as to posc facts of the person of posc, unless the court documents its resp. posc expertise. Unfortunately it is occasionally crossed by a court—with a disastrous results).

Def 3: Let—for a KR(PTR)—“USSCov(KR(PTR))” be its doc-wise coverage by INDKR(PTR) finite U(C.i) subsets USS^{indKR(PTR)}: ∪^{1≦indKR(PTR)≦INDKR(PTR)}{USS^{indKR(PTR)}}=∪^{∀}^{_{C}}^{∈KR(PTR)}U(C).

Z is called a “representation transformation, RT” between {USS^{indZ′-KR(PTR)}} and {USS^{indZ″-KR(PTR)}}, if Z is an o-/AD- or an AD-/BID bijection of z′-KR(PTR) onto z″-KR(PTR) [symbol] ∀z∈{o,AD,BID} holds for 0≦i≦l^{N3.,V.};

z-KR(TT.i)=∪^{∀}^{_{z-C.i}}^{∈}^{_{z-KR(TT.i)}}U(z-C.i) is disclosed by MUI^{m}.i, 1≦m≦Mⁱ [symbol] BID-KR(TT.i)=∪^{1≦j≦J}U(BID-cr-C.i.j).

Note 3: o/AD/BID/KR may be skipped, if evidenced by context. The U(z-C.i) may be trivialized for i>0^{6)a.}. This description of K(PTR)'s representation transformations shows that o-PTR often—not always—identifies TT.0's element^{III.1} X.0.n of the claim at issue. Anyway, the eventually determined X.0.n's are not subject to AD-/BID-RTs. I.e.: These bijections perform RTs only of the elements' properties (described by Ps based on Cs and vice versa^{9)1.-3.,9)5.}).

Analyzing a PTR^{III.1} and ignoring the intricacies of its o-/AD-KR(PTR) often is misleading^{4)g.(5-8),7)c.}. Hence, for scientifically determining e.g. the fact of its o-TT.0's creative height over its prior art o-RS, the casual o-/AD-cr-Cs' legal obscurity—e.g. as to their independency, hardly detectable in PTR's o-/AD-KR^{7)c.,9)5.}—must be removed by screening doc.0 for disclosures^{5)b.} of additional and “legally clean”^{9)5.} BID-cr-Cs, which semantically refine^{9)5.} TT.0's o-/AD-cr-Cs. Only thus qualified o-/AD-cr-Cs are—in terms of Knowledge Engineering and IT—correct and legally^{4),8)5.} dependable, i.e. legally not error-prone, in terms of “plcs” and “pmgp”^{1),9)5}. The below 2 bullet points elaborate on these two Zs, AD-RT and BID-RT (for short just “AD” and “BID”). For a TT.0, AD transforms the set of legally often misconceived informal/textual/graphical USS(o-KR(TT.0))s to a set of formal^{III.3.1} yet still legally misleading USS(AD-KR(TT.0))s, only BID then transforms this set to a legally clean^{9)5.} set of USS(BID-KR(TT.0))s. Thereby BID achieves/assesses the independency of the various possible {BID-cr-C} of TT.0 established by ∀CTRs.

Starting the just mentioned important first step AD of analyzing a PTR's TT.0 is described in detail in WO 2012/022612^{Section.II.A.1}. AD ends by delivering TT.0's technical fundamental formal AD-X.i.n^{III.1,III.3.1}, only casually identified—i.e. often still fuzzy/error-prone as using compound concepts^{4)g.(1-8)7)c.,9)5.}. This “AD bijection”—which must not change the o-KR(PTR) problem described by the doc.i's, 0≦i≦l—uses on both sides only vaguely defined Cs, their USSes, and their semantics. I.e.: The o-KR obscurity of TT.0 holds also for its AD-KR, yet already significantly decreased. I.o.w.: AD-RT transforms verbal/graphics o-facts disclosed by doc.0—i.e. eventually all and precise, yet initially only vague informal technical fundamental facts^{III.1}—into somewhat less vague as formal technical primary facts^{III.1}, often still being legally error-prone. Yet, any such formalization enables defining initially also vague BID-RTs, which finally enable (because of their now achieved simplicity) precisely determining TT.0's legally clean facts. I.e., any such formalization facilitates eventually disaggregating the compound Cs and Cs (modeling the compound primary facts) into “finer”, technically precise and legally clean, BID-cr-Cs/BID-cr-Cs^{9)1.-3.}. Again: Any such AD and BID needs confirmation by the poposc.
The inverse BID⁻¹ of a BID precisely defines by its {BID-cr-C} and its USS({BID-cr-C})s also its USS(AD-KR(TT.0))s and the BID-cr-Cs they comprise, which in turn enables precisely defining AD⁻¹ and the USS(o-KR(TT.0))s and the BID-cr-Cs they comprise, which in total establish the {o-cr-C} of this ADo BID alias CRTD^{D5/N5}. doc.0 may disclose different {BID-cr-C}s, which enables refining the AD and BID accordingly. In total: The AD of o-KR(PTR) determines AD-K(PTR) and adds knowledge disclosed by doc.0 about o-KR(PTR) to it derived from the latter by the poposc; and BID determines BID-K(PTR) and again adds to it knowledge about the AD-K(PTR) derived from the latter by the poposc.

Denoting |{BID-cr-C.j}|=J and the BID-cr-C.j's as “BID-C.0.jₙ” if it belongs to X.0.n, leads to Σ^{1≦n≦N} Jₙ=J, ∪^{1≦n≦N}∪^{1≦jn≦Jn}U(BID-C.0.jₙ)=BID(USSCov(AD-KR(TT.0))), and hence BID-KR(TT.0)={U(BID-cr-C.0.j)|1≦j≦J}=={{(x,T)|∀x∈BID⁻¹(BID-cr-C.0.j)}∪{(x,F)|∀x [symbol] ∈BID⁻¹(BID-cr-C.0.j)}|1≦j≦J}. The total BID-representation of PTR, BID-PTR, consists of (l+1) such sets of J subsets, each of them consisting of a pair of an (x,T) set and an (x,F) set, called the T-/F-set (of the resp. BID-cr-C). I.e.: For a PTR, a BID-TT.i comprises the RS specific set of J subsets, of which at least one is ≠ the peer subset of TT.0. AD and BID are bijections between the resp. U(C)s—not bijections “BID*” between the U(C)s' elements. Such BID*s are the commonly known “coordinate system transformation”, here between o-PTR, AD-PTR, and BID*-PTR. I.e., Definition 3 is a true generalization of this well-known notion, as it leaves room for PTRs enabling such additional bijective BID*s.

Def 4: In some situations, the truth of an expression “∃ . . . ”, “ . . . ∈ . . . ”, “∀ . . . ”, “ind . . . “ . . . = . . . ”, . . . needs confirmation^{N3-1} by the person of posc, which then is indicated by a postfix “_{c}”, “∃_{c}”, “∈_{c}”, “∀_{c}”, “ind_{c}”, “=_{c}”, . . .
Note 4: In mathematics the analogon to this additional confirmation by the posc person—such confirmations need not comprise an above-pertinent-ordinary-skill/creativity, “above-posc”, elaboration on a disclosure^{5)b.}, i.e. need nowhere exceed posc—is provided by an additional axiom. I.e.: There/Here this means that this statement's holding requires a separate axiom resp. posc confirmation. In mathematics this additional axiom may be needed only once for a whole world of mathematical theories—such as in Geometry Euclid's parallel axiom—most of them never coming back to it. Here this additional confirmation by posc may be required for any statement. Thus, these repeated posc confirmations define a little world of its own, within which the resp. statements about a PTR are true. In what follows, the “_{c}”-qualified terms are assumed to be guaranteed, i.e. to be axioms.
Def 5: Let, for a PTR, an RT being a concatenation BID∘AD applied to a PTR or its TT.0^{N5i)-iii),9)R.} be called (KR-) “normalization, RT⁰” of PTR/TT.0 into BID-PTR/-TT.0 alias PTR⁰/TT.0⁰—being a “complete RT, CRT”.
Let, for a PTR, the surjective mapping of a subset of ∀_{c}AD onto ∀_{c}RT⁰ be called PTR's “its⁰_{c}” relation.
Let, for a PTR and its {RT⁰}, the “normalization isomorphism, N≅” be defined by:
∀_{c}AD ∃_{c} its⁰ BID (PTR then is called “normalizeable”) [symbol] ∀AD′, AD″ holds AD′-TT.0≅AD″-TT.0^{N5ii)}.
An N≅ is called “non-pathological, n-p”.
   Lemma 1: For an n-p PTR trivially ∃ only 1 o-TT.0/mod(≅) (see ftn^{5)a.}).

### Theorem 1: For an n-p PTR=>∀{BID-cr-C} are ≅.

Proof: Assuming “=>” is false implies ∃RT⁰′, RT⁰″ with {BID′-cr-C}, {BID″-cr-C}:{BID′-cr-C} [symbol] ≅{BID″-cr-C}=>=>o′-TT.0≅{BID′-cr-C} [symbol] N≅{BID″-cr-C}≅o″-TT.0=>∃o′-TT.0, o″-TT.0:o′-TT.0 [symbol] ≅o″-TT.0=>contradiction to Lemma 1.
Note 5: The notes i)-vii) help understanding the preceding definitions and their use in a PTR's FSTP analysis.
i) When starting a PTR's FSTP analysis the bijection(s)^{D3} of AD and BID often cannot be precisely determined^{5)a.}, i.e. it starts with a “vaguely defined bijective” AD-/BID-RT⁰ alias normalization^{D3/N3} of TT.0 and thereafter, for i>0, alike vaguely defined bijective AD-/BID-RT⁰(TT.i). In more detail:
While the BID is there for refining the initially vague semantics of AD-KR(PTR)—as felt by the person originally marking-up the doc.i's by MUI.i's and thereby intuitively allocating “mark-up type” peering “meta-semantics” to these MUI.i's, i.e. as felt when so initially improving the o-KR(PTR) by MUIs and deriving from it an AD-KR(PTR)—to an (RS-specific) exact BID-KR(PTR), precisely/mathematically modeled by “legally clean”⁹⁾⁵. BID-cr-Cs, creative/inventive concepts (as needed by the HIGHEST COURTS^{5),9)5.}),
the AD is there for providing the basis for this BID—i.e. an AD starts from the o-KR(PTR) prior to its mark-up by MUIs, but later on is significantly supported by such MUIs^{IV.}—on the early stage of PTR analysis, when there is no clear semantics representation of TT.0, yet, i.e. by concepts. Designing this basis for identifying precise BID-cr-Cs starts with identifying the to be “marked-up items, MUIs” of information^{V.} (=syntactic units within the doc.i's, initially associated with the just described meta-semantics), which shall eventually embody the precise semantics stepwise^{ii),9)1.-5.} allocated to the BID-X.i.j by the user of the system generating a PTR-DS for this PTR. Prior to this allocation of precise semantics to the “MUIs” they don't represent legally significant semantics but only legally useless meta-semantics.
Reconsidering the preceding steps: After the user, e.g. of an IES for generating the PTR-DS, has initially found such a vague RT⁰′ of a PTR, he/she must make its BID′-X.0.j's alias BID-C.0.j's^{9)1.-5.} exact (to be confirmed by the person of posc^{D4,N4})—implying that it warrants this {BID′-cr-C} is legally clean^{9)5.} (other Cs' meanings being irrelevant). This always is possible, due to the mental simplicity^{7)b.,9)1.-3.} of these BID′-cr-Cs. Once these precise BID-X.0.j's are defined, BID is precisely invertible, thus determining precisely TT.0's AD-X.0.j's^{D3-5/N3-5}. This ends up in the above Lemma 1 that the claim/patent at issue of an n-p PTR has only a single o-TT.0/mod(≅)^{5)a.,10)}.

There is a fundamental difference between AD-RTs and BID-RTs: AD-RTs enable potentially manifold “AD-(re)conceptionalization” opportunities of the PTR—if disclosed^{5)b.} by doc.0—by potentially significantly different though vague AD-Cs^{N3:l),9)5.} if confirmed by posc^{D4/N4}). By contrast, BID-RTs enable just “AD concept refinements”—of already chosen, often vague AD-Cs—to legally clean^{9)5.} Y/N-BID-cr-Cs. I.e.: A BID cannot change the vague decisions embodied by a PTR's AD.

ii) If for an o-TT.i ∃_{c} a BID-TT.i=>∃_{c} an AD-TT.i (e.g. BID-TT.i). The inverse need not hold: For a TT.i a normalization need not exist, at all, or only for some of its BID-cr-Cs—those legally clean^{9)5.}—in particular for i=0.
iii) Though pathological, non-normalizeable, or non-unique TT.0s are ignored here, FSTP Technology may evidently handle them, too. At TT.0's invention or patenting time, such deficiencies are often avoidable by doc.0's unfortunate wording and/or appropriately cleaning it up logically.
iv) Often some o-/AD-/BID predicates are not only ≅_{c} but even the same for several RT⁰s.
v) While a PTR's AD-KR facilitates describing the meaning embodied by its TT.0 more precisely, its BID-KR is often indispensable for determining the precise creativity/inventivity embodied by its TT.0 and for precisely identifying, on this basis, its pmgp (e.g. patent-eligibility) aspects.
vi) Normalizations for a PTR/TT.0 are considered to not affect ps, i.e. that ∀RTs holds: RT(ps)::=ps. The reason is that, with the a priori knowledge of all ps concepts, also all their posc-RTs must be assumed to be known. Otherwise namely a TT based on ps concepts only, i.e. with Q^{plcs}=0, might get a Q^{plcs}>0 by a posc-RT—what contradicts the notion of plcs. This will be elaborated on elsewhere.
vii) The necessity of a PTR's AD-KRs is twofold: Firstly, they are indispensable for deriving from the doc.i's^{5)a.} their TT.i's more precisely than it often is possible by using only its o-KR^{2),3)}, i.e. for specifying the precise meanings of such wordings. Secondly, they provide the only guidelines for systematically searching for PTR'S BID-Cs and elements of their vC, as legally necessary^{4)e.} for removing the AD-Cs′ deficiencies^{7)b.} by their disaggregation.
Theorem 2: If TT.0 is normalizeable, then its creative^{N6} height over RS is invariant over ∀ normalizations.
I.e.: TT.0 is n-p in PTR=>.) Q^{plcs}(RT⁰′(PTR))=Q^{plcs}(RT⁰″(PTR))∀RT⁰′, RT⁰″ [symbol]
   :) Q^{plcs}-PS(RT⁰′(PTR))N≅Q^{plcs}-PS(RT⁰″(PTR))∀RT⁰′, RT⁰″.
      Proof: Only the first invariant .) needs to be is proven, as the excess by :) of .) is trivial. The proof of .) is based on induction over the number Q^{plcs}, by showing—showing leveraging on Theorem 1—that always Q′^{plcs}=Q″^{plcs}.
      By^{D3/N3,9)1.-3.} holds for RT⁰′ BID′-TT.0={BID′-cr-C.0.jₙ|1≦n≦N, 1≦jₙ≦Jₙ, Σ^{1≦n≦N}Jₙ=J}.
      Let denote^{III.2} BID′-AC::=<BID′-C^{AC}.i.jₙ|1≦n≦N, 1≦i≦l, 1≦jₙ≦Jₙ, Σ^{1≦n≦N}_{J}ₙ=J>^{III.2},

and BID′-Q^{AC}::=>BID′-AC^{AC}.i.jₙ|1≦n≦N, 1≦n≦l, 1≦jₙ≦Jₙ:Σ^{1≦n≦N}Jₙ=J>,

whereby BID′-ANC^{AC}.i.jₙ::=if(BID′-C^{AC}.i.jₙ=BID′-C.0.jₙ) then BID′-A^{AC}_{.i.j}ₙ else BID′-NC^{AC}.i.jₙ, as decided by the person of posc⁹⁾³.

Then holds for RT⁰′Q′^{plcs}=Σ^{1≦n≦N}min⁵⁵⁰ ^{_{AC}}|{NC^{AC}. i.jₙ|1≦jₙ≦Jₙ}|. <A>

Omitting the “⁰” in what follows, the induction proof of .) starts by showing that ∀PTR with Q^{plcs}(PTR)=0 in all KRs (=∀PTR⁰) with assumption (*)::=∃PTR“ [symbol] ∃RT′: Q^{plcs}(PTR′)=Q′^{plcs}≧1” implies a contradiction to Theorem 1. Q′^{plcs}=0 namely means^{III.1,III.2}: ∃0:-AC′∈posc+pa′* with 0-AC′/mod (0-CC′) ants TT.0′, i.e. for this 0-AC′ by <A> holds |{BID′-cr-C}^{0-AC′}}|=0, i.e. ∀BID′-C, on which BID′-TT.0 is based, are anticipated by. ps+pa′−Cs, while from (*) follows that ∀RT″ [symbol] ∀AC″∈ps+pa′* holds |{BID″-cr-C}^{AC″}|≧K+1. This is a contradiction to Theorem 1.

Assuming now ∀PTR [symbol] ∀RT with Q^{plcs}≦K holds Q^{plcs}=Q′^{plcs} ∀RT′, and (**) “∃RT [symbol] ∃RT” Q″^{plcs}=K+1”. Then from Q′^{plcs}=K follow: ∃K-AC′∈ps+pa′* with K-AC′/mod (K-CC′) ants TT.0′, i.e. for this K-AC′ by <A> holds |{BID′-c-C}^{K-AC′}|=K, i.e. ∀other BIC′-C, on which BID′-TT.0 is based, are anticipated by ps+pa′−Cs, while from (**) follows that ∀RT″ [symbol] AC″∈ps+pa′* holds |{BID″-cr-C}^{AC}″≧K+1. This is a contradiction to Theorem 1. q.e.d.

Theorem 3: TT.0 is uniquely BID-reducible^{*))[BN]} in PTR=>for TT.0 hold the above .) and :) properties, too.
Proof: Due to TT.0's unique reducibility/rewritability to BID-KR ∃ only a single¹⁰⁾ RT⁰=>.) and :). q.e.d.
Note 6: Once for a PTR a BID-KR is developed and approved by the person of posc, the so determinable creative/inventive height of PTR's TT.0 over its RS cannot be threatened by the ∃ of another BID'-KR of PTR. The invariance :) facilitates checking all (i.e. few) RT⁰s, whether for one of them there is a Q^{plcs}-path on which pmgp (i.e. §§101^{4)e.-g.,9)5.}) requires/justifies that some of its Q^{plcs} creative/inventive concepts must not be counted when determining the pmgp height of PTR's TT.0 over its prior art RS. If too many creative/inventive concepts are so “devaluated”, this may render TT.0 non-patent-eligible^{4)g.(2-5),9)5.}. Theorem 3 simply states that there are other ways for assessing for a PTR/TT.0 the invariances .) and :) over all KRs/RT⁰s, though its preconditions may a posteriori be difficult to check—i.e. must a priori be established, when drafting a claim—while those of the Theorems 1 and 2 are very easy to check also a posteriori for probably all practically occurring PTR problems.

### IV. THE PTR-DS, THE PE2E SERVICE USED FOR GENERATING IT, AND APPLICATIONS USING IT

The purpose of a PTR's PTR-DS in an IES—being one of the application systems^{III.1} for the use of which a PTR-DS is conceived—is to enable the latter to instantly answer any query for any item of the K(PTR) by automatically deriving from the PTR-DS all legally relevant information as to this item within K(PTR). I.e., the PTR-DS shall enable the IES using it to compensating, for a person involved in a verbal real-time discussion of a PTR, its inability—due to the limited capacity of its short time memory—to instantly present correctly and completely all answers for any question as to any item of the K(PTR). At any point in time the IES would know which such item is at issue—e.g. by acoustically monitoring this verbal real-time discussion and performing real-time word-spotting therein. To this end:

The 1. center of an IES deals with the analytical ground laying terms/notions/functions of knowledge representation of the FSTP Model of Innovation¹⁰⁾ and derives from the SoMUI—disclosed by Section V.—first the “plcs-only FSTP-D^{o o”} and then filters it by pmgp and thus derives FSTP-DS^{o 4)e.-g.}. I.e., it stepwise, interactively, and iteratively transforms PTR's initial o-KR(PTR) into its final BID-KR(PTR)^{III.3.2} (not yet its PTR-DS). To this end, this machine applies a PTR-PS (e.g. based on the FSTP Test) to the MUI.i-items of the SoMUI (provided to it by the 2. IES center). The SoMUI comprises, in addition to the MUI.i's provided by the doc.i's disclosing the TT.i's, also all MUI.i's provided by the docs describing .) the national patent system, NPS, and the :) posc^{4)a.(2)5)d.} to be used in the PTR analysis at issue—all MUI.i's potentially to be modified and/or used and/or annotated by the user. In this way^{V.} the 1. IES center enables its user to determine the “TSII, total set of items of information”, functionally being the PTR-DS, SoMUI⊂TSII, by identifying, determining and adding to TSII—if not yet therein—
i) all elements' and their predicates' informal properties disclosed by the doc.i^{V.}, 0≦i≦l, i.e. in their o-KR,
ii) all elements' AD-plcs relations^{*)),3),4)}, each represented as predicate(s)^{III.3.2},
iii) a maximal set of creativity/inventivity BID-concepts required for the disaggregation of the AD-plcs relations alias AD-predicates into conjunctions of BID-predicates^{III.3.2,9)1.-2.}, i.e. implying assessing their independency,
iv) the minimal creativity/inventivity embodied by PTR's TT.0 over its prior art RS, described by PTR's technical secondary BID-plcs fact^{III.1./2.}, just as
v) all BID-concept's quality being pe or npe^{4)e.} and deriving from iv) PTR's technical secondary pmgp fact^{III.1},
vi) all chains of arguments useful for a given application derivable from and leading to all elements of the TSII,
vii) all links providing instant access to all elements of TSII.
   The 2. center of the IES—its split into machines D and E (IES details skipped) reflects the vastly different subject matters dealt with by the steps i)-vii)—deals with the practical functions needed for .) generating the PTR-DS according to the user's request and :) recognizing and replying to all its queries as to the PTR. I.e.: Firstly, for inputting user given information to the 1.center's functionality for making the latter derive from this information all items of information i)-vii), and secondly, for recognizing instantly all application queries as to the PTR and replying to them instantly in a user given representation. Both is application depending and requires interacting with the application user for generating all elements of TSII appropriately and making them instantly appropriately presentable.

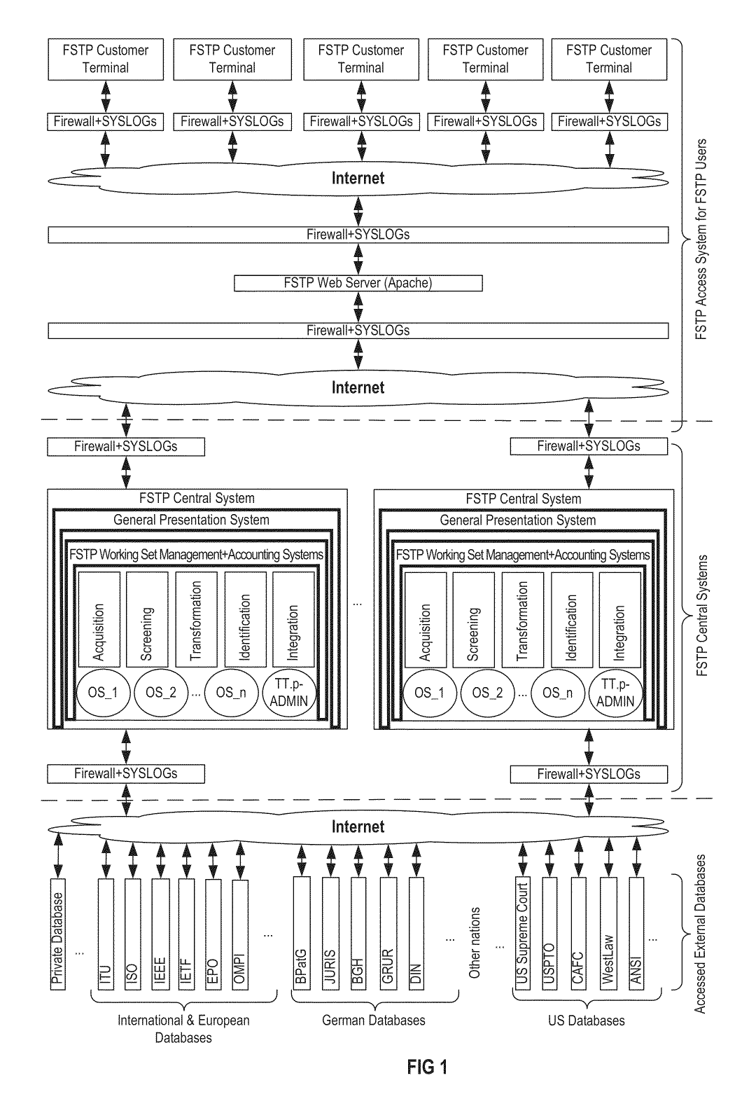

FIGS. 1-3 explain, how both centers of an IES—for its K(PTR) resp. KR(PTR) transformations—may exemplarily be functionally put together from a total of 5 machines, A-E, involved in generating resp. using the PTR-DS.

FIG. 1 shows the Internet usage of the IES. It is trivial that the IES may be used also locally, e.g. on a PC or a LAN or alike, which then would comprise a (partial) FSTP Central System. Arrows indicate function invocations.

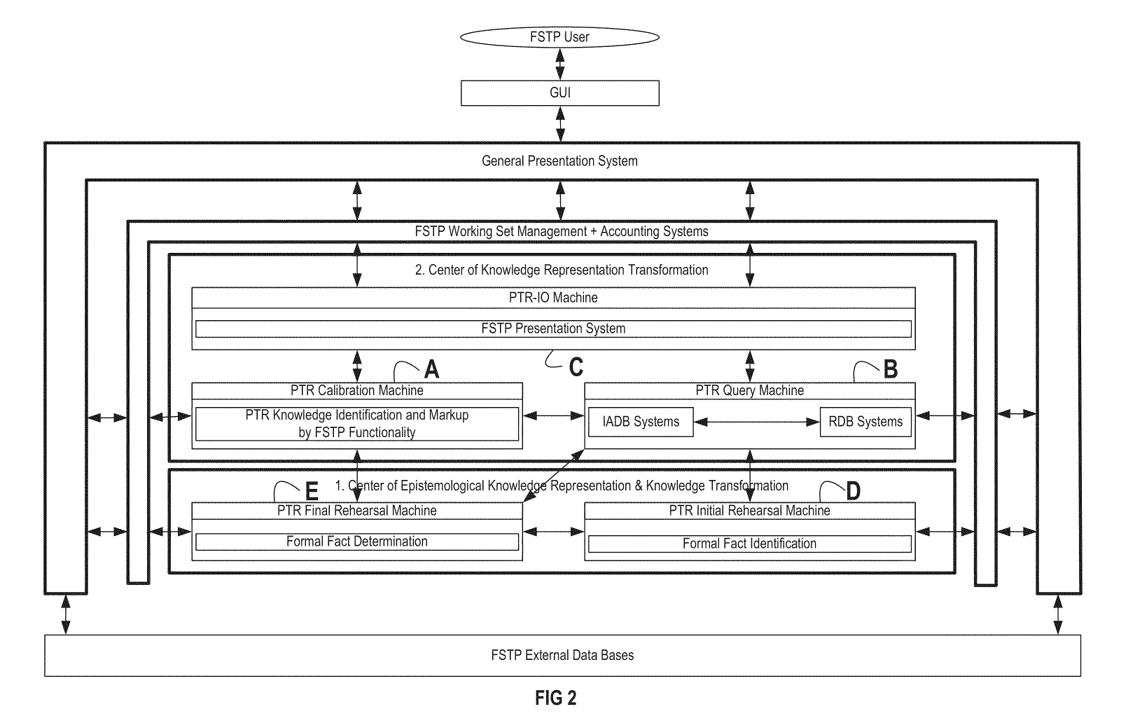

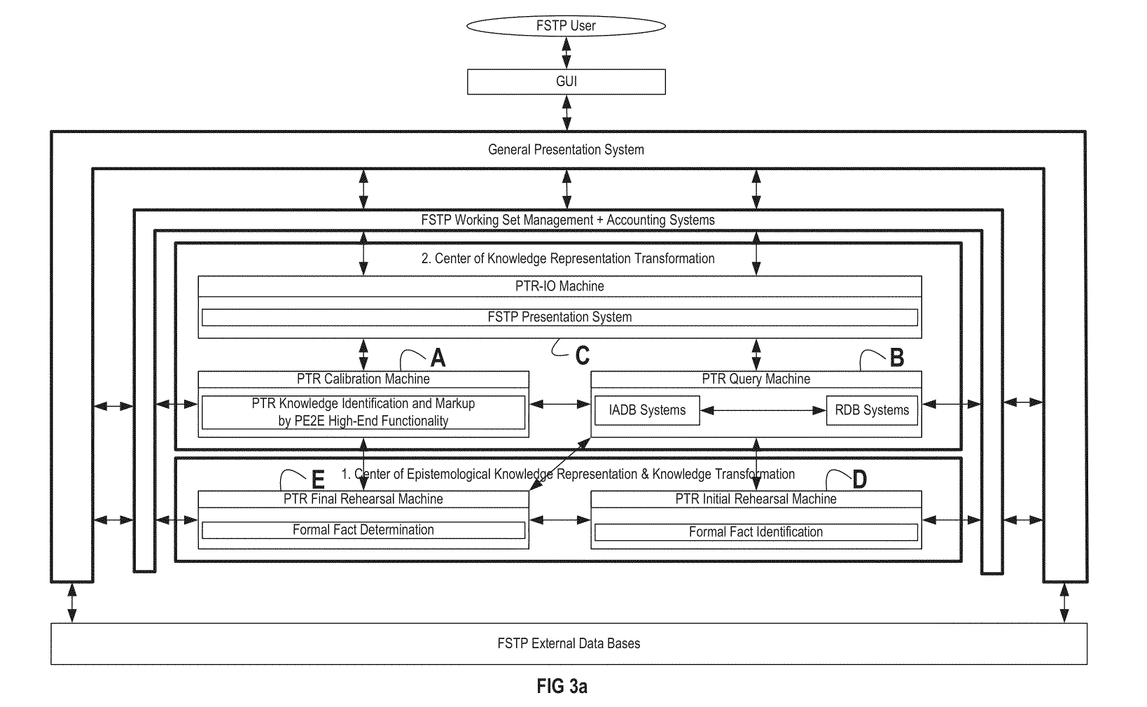

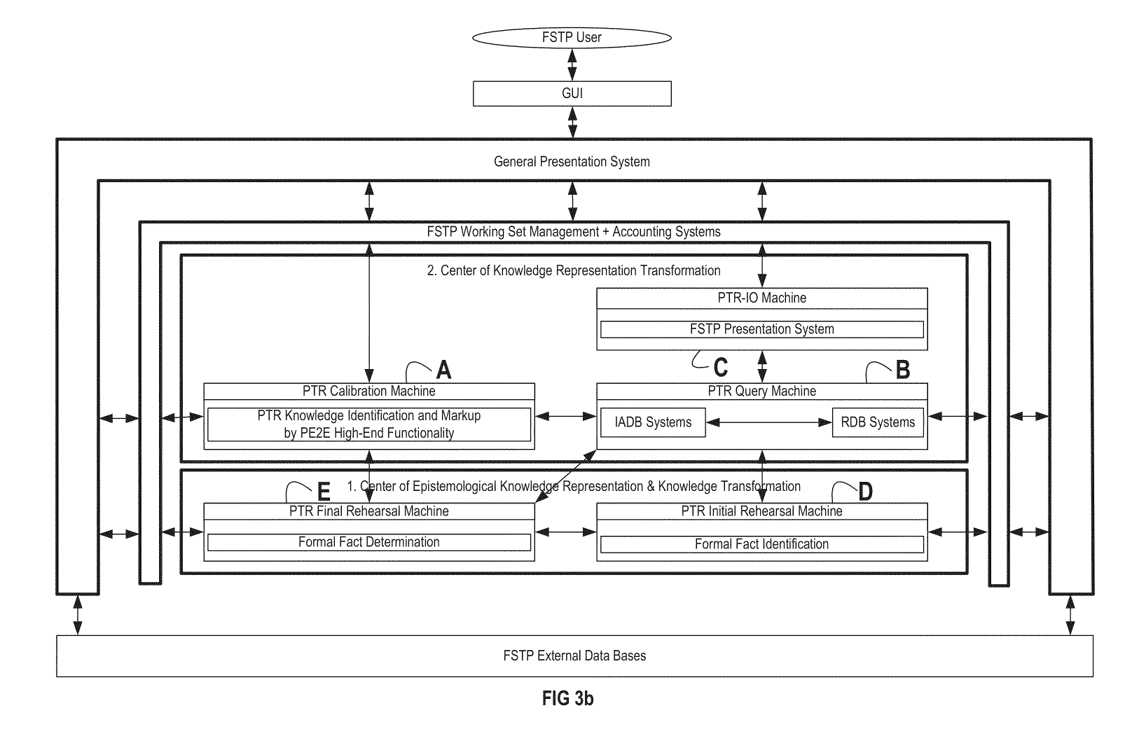

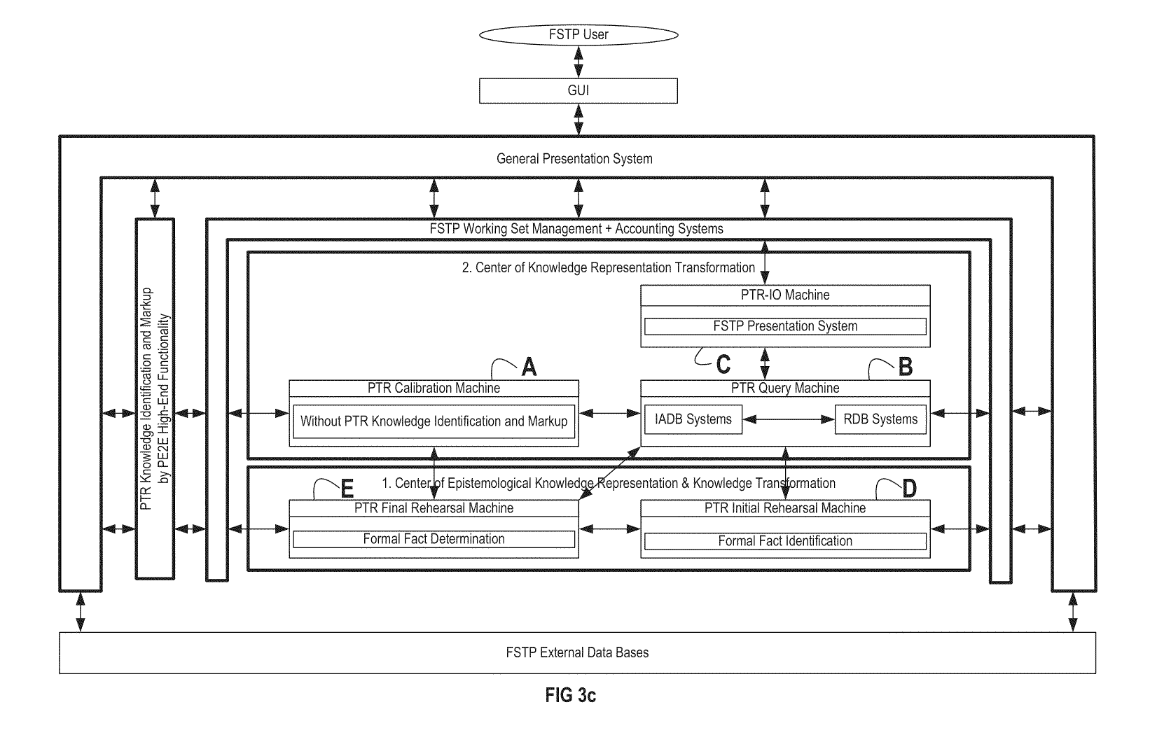

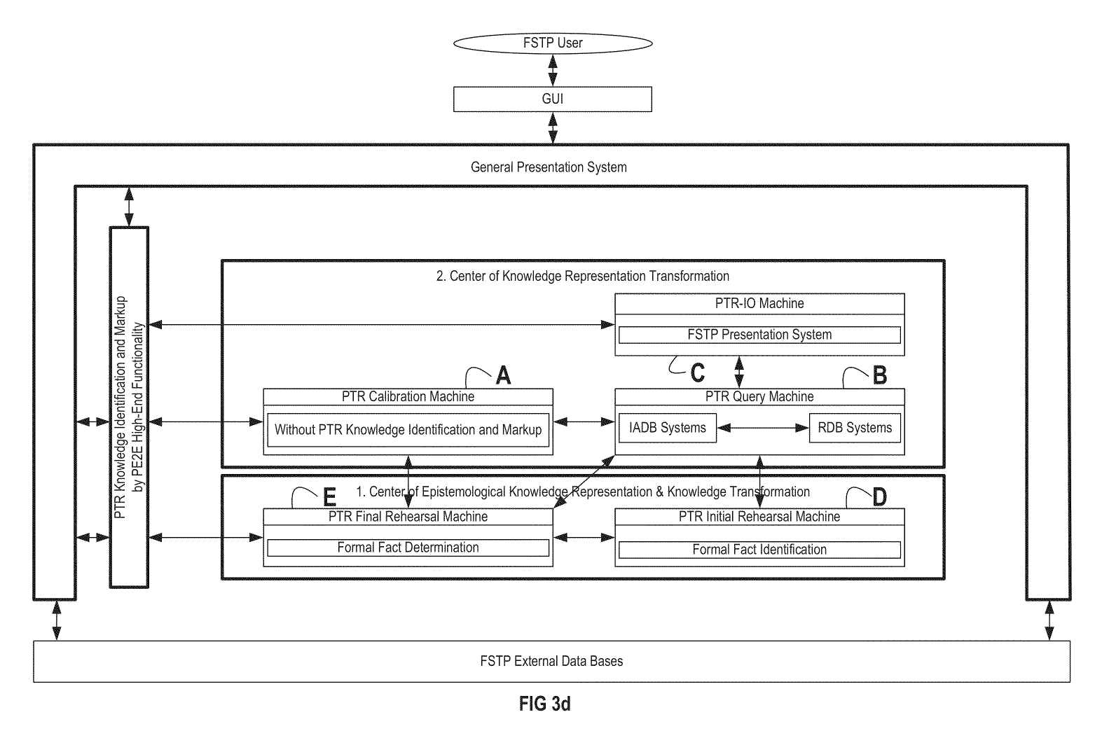

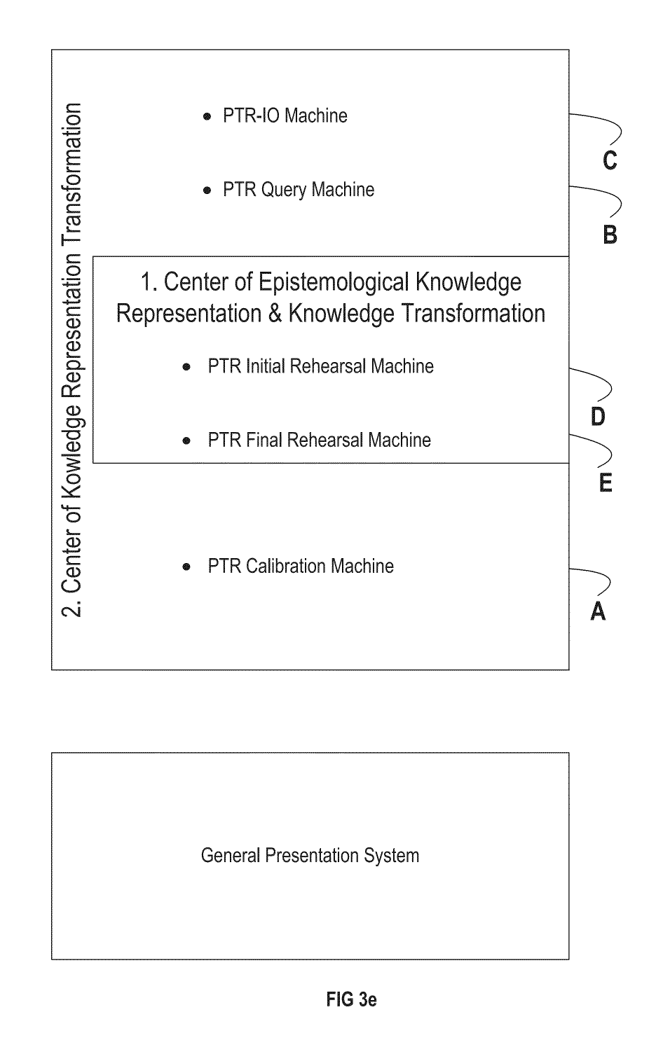

FIG. 2 shows an exemplary overall architecture of the IES'es internal services provisioning. The “General Presentation System” comprises the underlying software platform (put in terms of the “use-hierarchy” and including the operating system and computer hardware, see FIG. 3e below). IES internally, these services are provided by the

2. Center of KR(PTR) Transformations, comprising machines A-C. It enables the integrated use of a variety of existing and as such incompatible but indispensably jointly to be used technical information/mark-up/communications/storage/retrieval/input/output systems via their pre-existing technical interfaces, whereby machine
A provides “document information itemization” services, i.e. “PTR knowledge identification, itemization, and mark-up” services. Hence, it is called “PTR calibration machine”, based on usual IT and potentially provided from outside of the IES, e.g. by the “PE2E high-end service” (as explained below by FIGS. 3a-d).
B enables “PTR-PS based instant query recognizing/answering” services, i.e. a “PTR instant q/a machine”. It may be supported by two data base systems, IADBS and RDBS¹⁾, structured and filled during IES'es calibration/rehearsal for a PTR. I.o.w.: It generates from the TSII, e.g. interactively with the user, the PTR-DS—one of the claimed inventions^{V.}—for being used, e.g. via machine C of the IES—the other one of the claimed inventions^{V.}—or by any other non-IES with some q/a system of PTR facts for comprehension by external users, e.g. human ones. An example for a known PTR-PS is the FSTP Test System¹⁾.
C provides “user/KR(PTR)” communications services, i.e. is IES'es “PTR-I/O machine”.
   1. Center of KR+K(PTR) transformation, comprising machines D-E, whereby machine
D provides “PTR-PS based technical fundamental formal facts identification” services, and is called “PTR initial rehearsal machine”, as it serves for (KR) transforming PTR's (so far calibrated) technical fundamental informal facts into its technical fundamental formal facts^{III.1} and renders them primarily to E.
E provides “PTR-PS based technical primary & secondary formal facts determination” services, and is called “PTR final rehearsal machine”, as it serves for (KR as well as K) transforming PTR's technical fundamental formal facts into its technical primary & secondary formal facts^{III.1,III.3.2,V.} and renders them primarily to B.

All 5 machines are executable anytime, i.e. the IES may be in calibration, rehearsal, and/or query mode. All their above functional descriptions are only very rough exemplary outlines—just as the subsequent presentations.

FIGS. 3a-d outline the overall architecture of the internal IES services provisioning in case the services of the PTR calibration machine A are partly replaced by some non-IES services, e.g. the future PE2E high-end service (“PE2E”) or another mark-up service; while currently the functional design of none of them cares for meeting e.g. the inventors' or examiners' requirements when working on inventions, there are good reasons^{4)h.} to expect that this will dramatically change pretty soon.

FIG. 3a shows the PTR calibration machine A of the IES using the PE2E as its basis, whereby the PTR KR machine additionally provides FSTP user guidance to PE2E's usage. In FIG. 3b the PE2E service as it is, i.e. without any additional IES user guidance, is passed on to the user. FIGS. 3c and 3d depict the PE2E service invoking the IES service, whereby these invocations of the IES by the PE2E refer to the former as a compound system resp. directly to some machines selected from the IES. The differences between these four architectures 3a-d are—in all cases the PE2E service is augmented by the PTR-DS/IES services, medium-term this high-end functionality on top of the PE2E being required anyway—that these services are available to the PE2E service user to different degrees.

The main differences between the PE2E service and the PTR-DS service are briefly summarized as follows:

The two patent law/precedents based PTR-DS services—being semantics/pragmatics resp. real-time queries/answers oriented—dealing with two different KR functionalities—are of much higher legal resp. usability qualities than the PE2E service. More precisely: After a PTR has been marked-up by means of the PE2E service such that it provides the MUIs of Section V., the PTR-DS services may be provided on top of this marked-up PTR and are capable of delivering semantically/pragmatically patent law/precedents based services on a much higher legal level and instantly—two aspects not even addressed by the PE2E service.
None of these two PTR-DS services can be designed or only thought of without the FSTP technology, based on HIGHEST COURTS' precedents and new fundamental epistemological and KR insights^{*)),4),III.}. They enable world-wide uniquely far reaching and legally dependable techniques of analyzing a marked-up invention and its prior art, even enabling real-time answering all legal questions about the PTR.

FIG. 3e clarifies the (internally “sandwich structured”) overall “use-hierarchy” of the IES in all cases: The query and FSTP presentation machines/services, B and C, always may use only what the functionalities of the rehearsal machines/services, D and E, have provided to them, which always may use only what the functionality of the calibration machine/service, A has provided to D—whereby the uses of these services normally would occur iteratively and interactively and their executions may overlap in time.

The crucial point in achieving wide-spread use of a very advanced IT service, such as the PTR-DS service, is the ease of getting familiar with and of being supported by it. Both is strongly depending on the “access service” providing the PTR-DS service to a user—here the IES service. Hence a final remark is in place on the PTR-I/O Machine C of the IES. First of all: Controlled by the PTR-DS service it may check—depending upon whatsoever state the IES is in—any user action for admissibility and/or reasonability, resp. prompt such action on user request. I.e.: The user of the IES service may be safely but remorselessly guided by it's A/GUI, controlled by the PTR-DS service, in any one of the above modes and/or in any of the KRs of the PTR—also while other services are being used, such as the PE2E service. Thereby, via the A/GUI of the IES, the PTR-DS service may explain to the user at any time, automatically and/or interactively and to a detail controlled by him/her, the relevant patent law/precedents/examination/KR (including the resp. technical/epistemological/mathematical) background. E.g.: While the technical fundamental informal facts are just quotations of explicit and implicit disclosures of elements' properties (provided by documents involved), already the technical fundamental formal facts provided by the PTR-DS service (compiled by the initial rehearsal machine) enforce a rigor of understanding the PTR, which otherwise is not guaranteed. This KR transformation of the PTR^{III.3}, instantly presented by the PTR-DS service, also has been approved by the person of posc, and thus is beyond the resp. doubt—which today normally is impossible. Actually, many users even should not mingle with this background information on their own (which is indispensable today), as the result might be incalculable. Consequently, even (patent) lawyers would appreciate this PTR-DS service, because of this support—and hence the advantages and qualities of the IES or an alike PTR-DS based system.

### V. THE METHOD/APPARATUS GENERATING THE PTR-DS AND THE IES APPARATUS

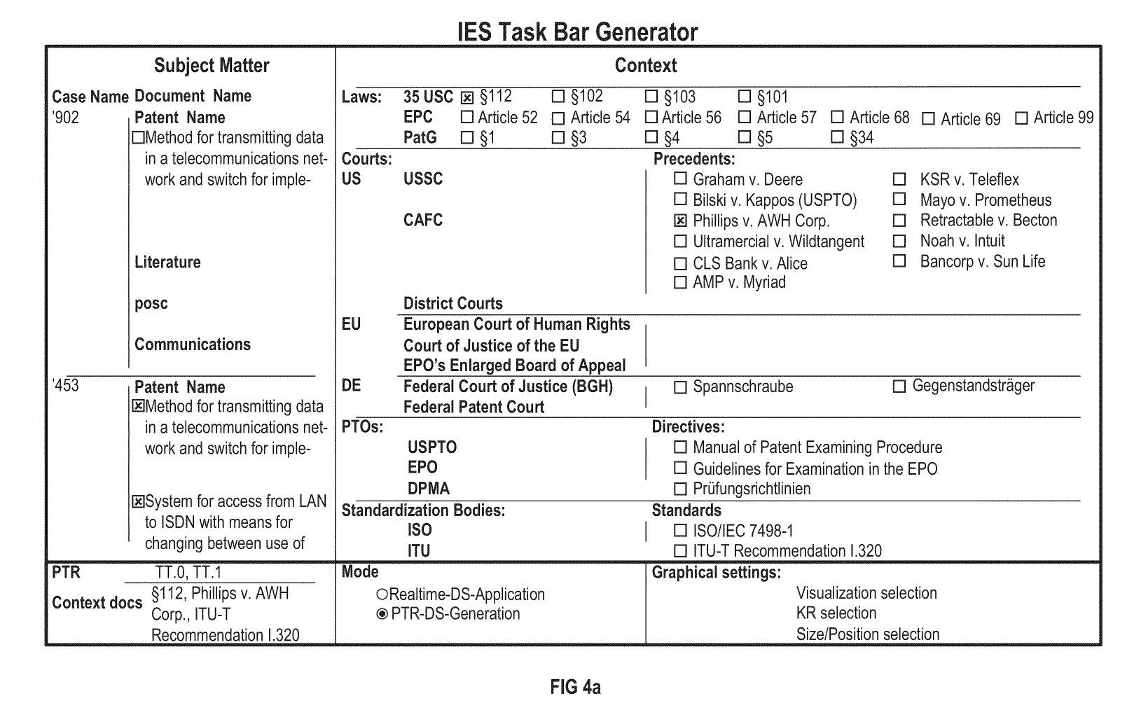

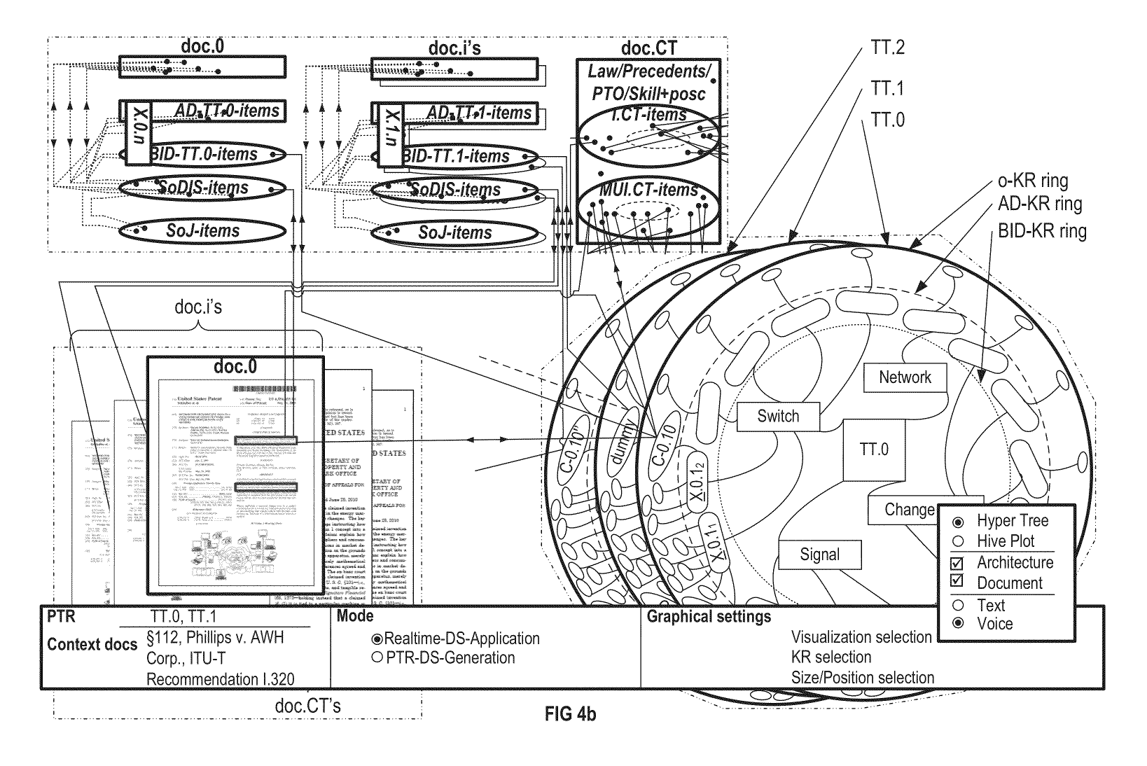

The disclosure of further details of the claimed inventions, namely of generating for a given PTR a PTR-DS and—on top of it—of the IES, is provided by means of the 18 FIGs listed below. This 7 FIGS. 1-3 first reiterate on a possible, the PTR-DS generation preparing, cooperation between, on the one side, an IES using a PTR-DS generating system, and on the other side, a future version of the PE2E service. Then the sections dealing with the 11 FIGS. 4-6 and their explanations disclose the claimed inventions in an enabling way.

FIG. 1 shows an exemplary use of an IES/FSTP system via the Internet (see Sect. IV.)

FIG. 2 shows an exemplary implementation of an IES/FSTP system (see Sect. IV.)

FIG. 3a shows an exemplary implementation of an IES/FSTP system using some PE2E service (see Sect. IV.)

FIG. 3b outlines an IES/FSTP system as of FIG. 3a but exposing some PE2E service to users (see Sect. IV.)

FIG. 3c outlines an IES/FSTP system as of FIG. 3b but exposing some more PE2E service (see Sect. IV.)

FIG. 3d outlines an IES/FSTP system as of FIG. 3c when used by the PE2E service (see Sect. IV.)

FIG. 3e shows the “sandwich-structured” use hierarchy of an IES/FSTP system (see Sect. IV.)

FIG. 4a shows a schematic screenshot of the Task Bar compilation page of the IES (see below)

FIG. 4b shows a schematic screenshot of the initial entry page to the PTR-DS Generator (see below)

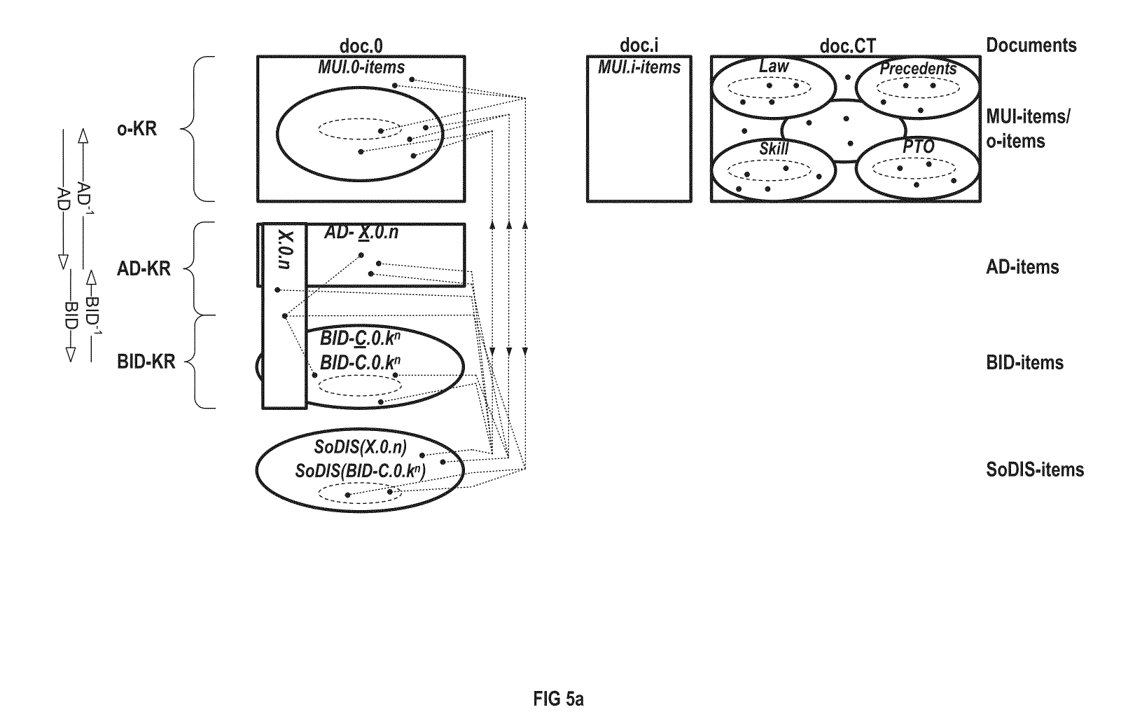

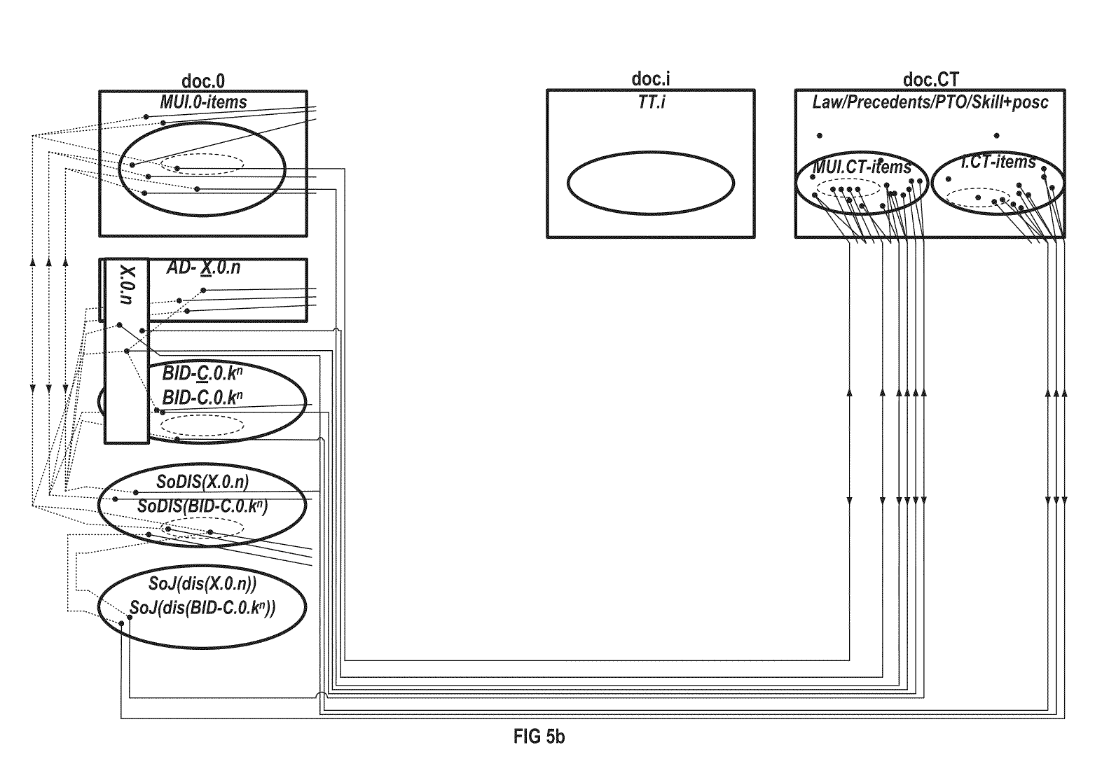

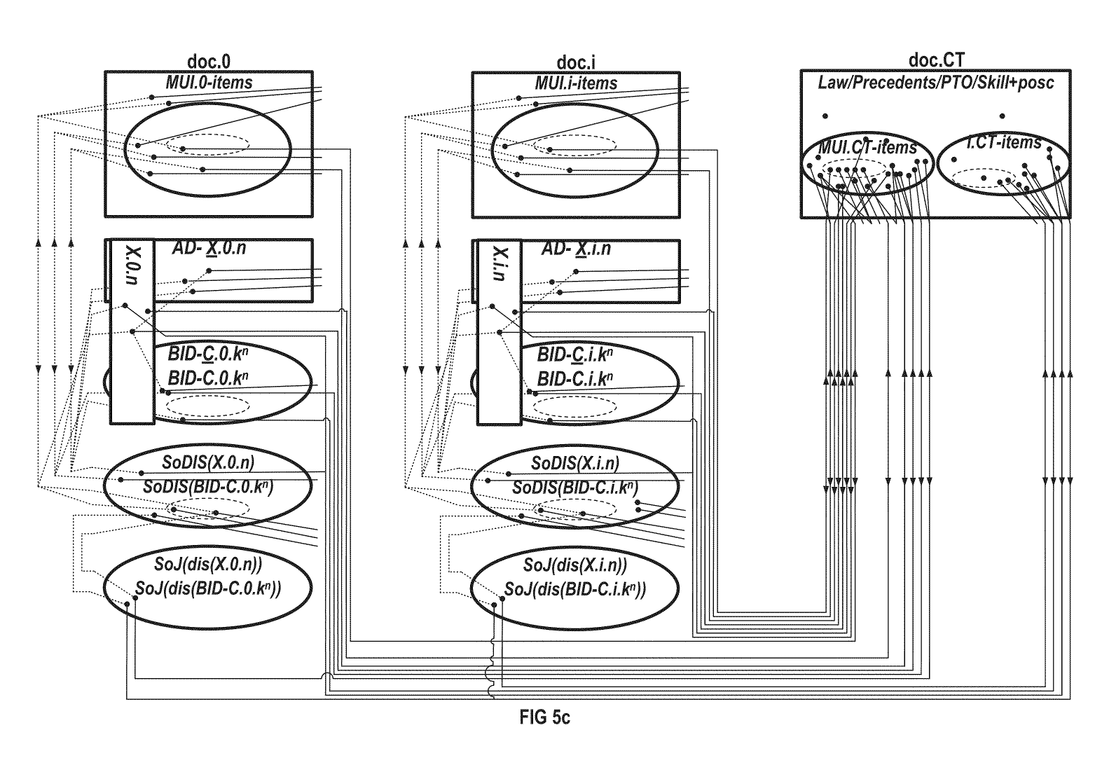

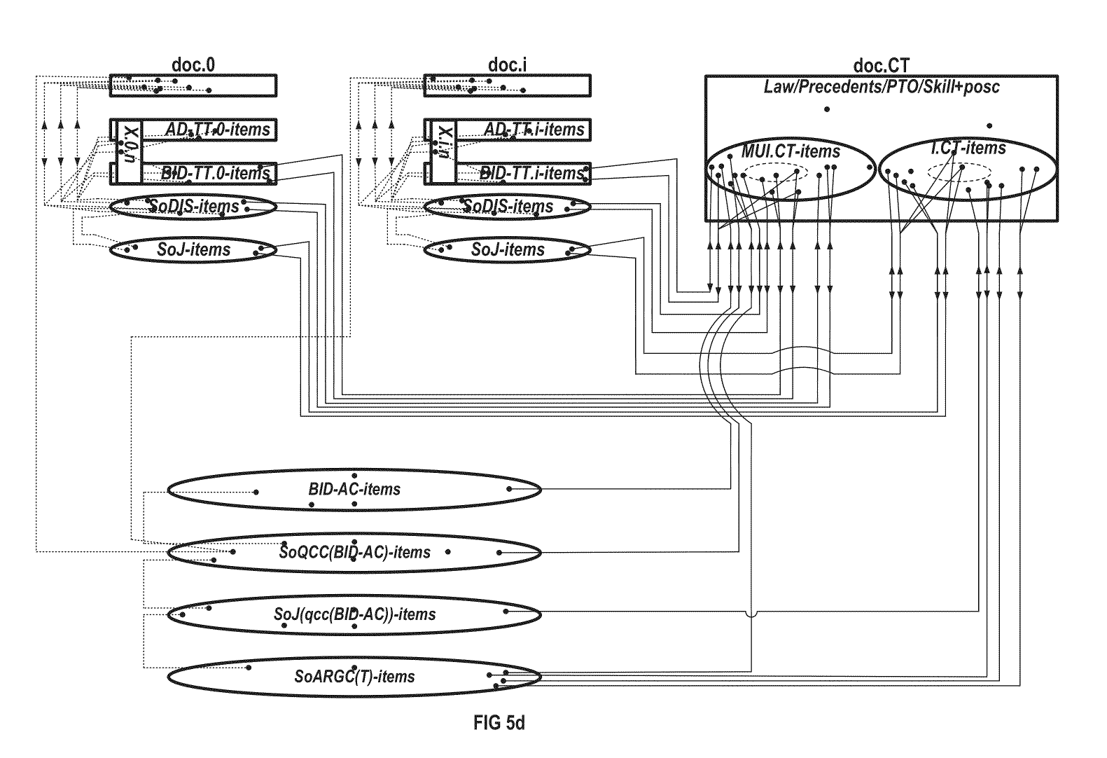

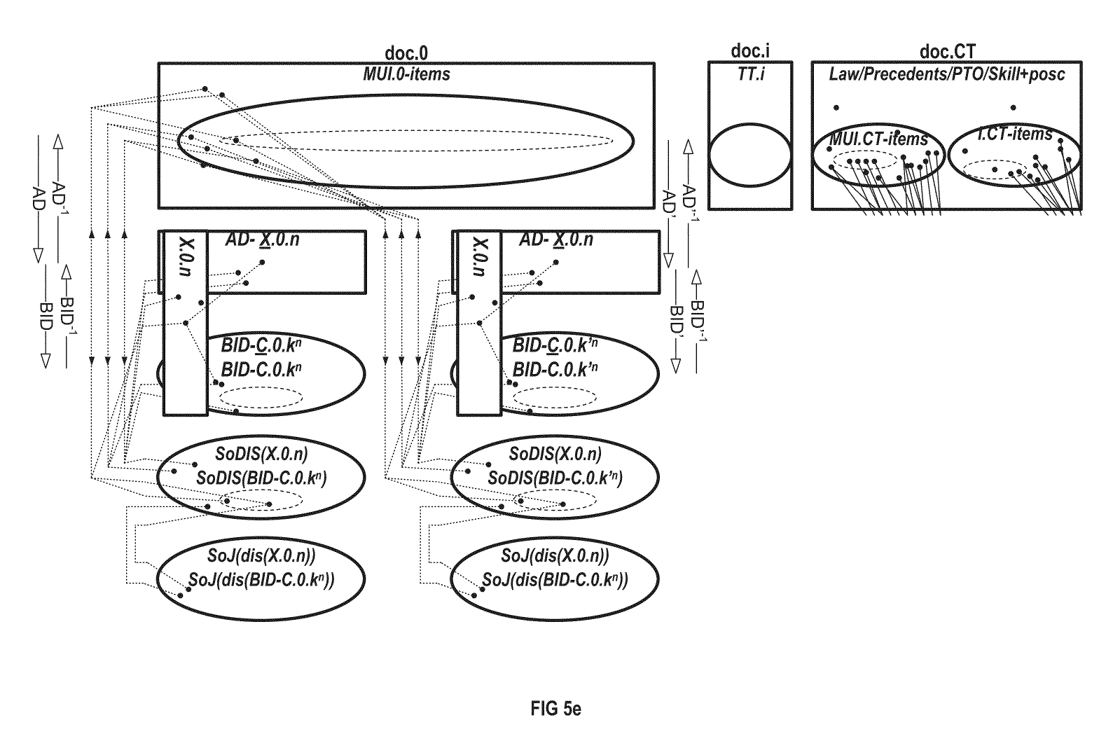

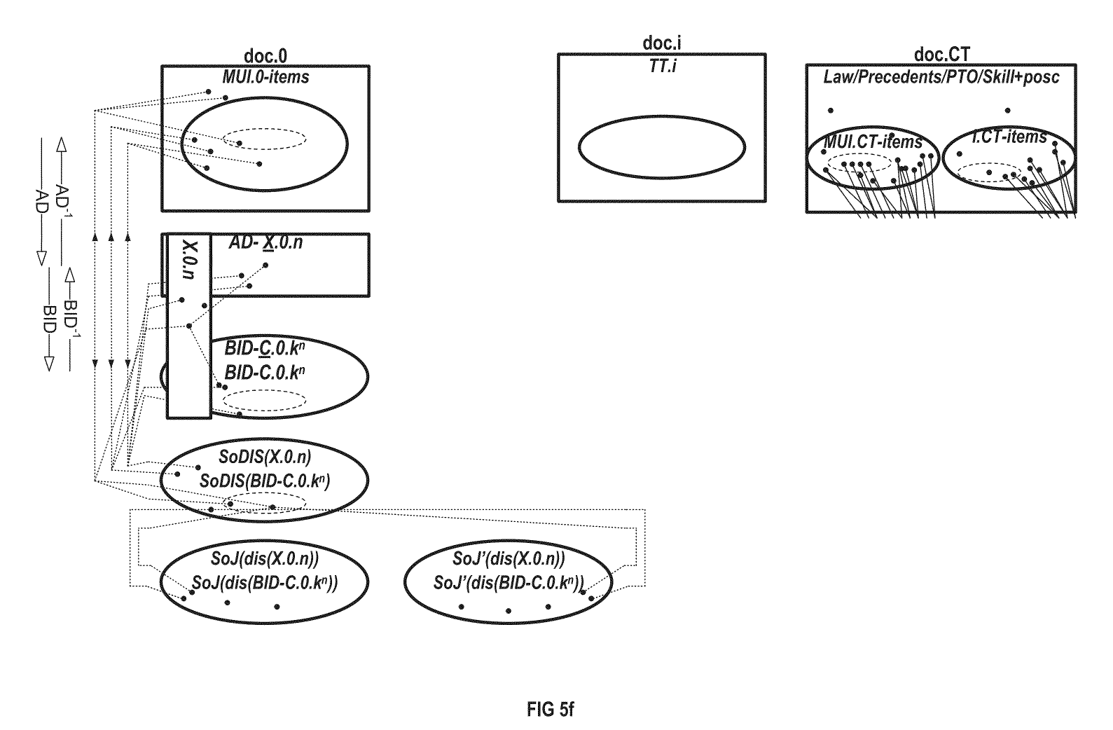

FIG. 5a shows the relational structures between MUI.0-items and generated TT.0-/i.CT-items (see below)

FIG. 5b shows the relational structures between MUI.CT-items and generated TT.0-/i.CT-items (see below)

FIG. 5c shows the relational structures between MUI.CT-items and generated TT.i-/i.CT-items (see below)

FIG. 5d shows adding the Q^{plcs}-AC-items to FIG. 5c (see below)

FIG. 5e shows adding the RT⁰-items determining Q^{plcs}-AC-items to FIG. 5a (see below)

FIG. 5f shows adding the RT⁰-items determining Q^{plcs}-AC-items to FIG. 5c (see below)

FIG. 6a provides an overview about how the IES enables its user to access the items, he/she is currently interested in, in o-/AD-/BID-KR, in “model-KR”, and in “doc-navigation-KR” (see below)

FIG. 6b shows the PTR's ANC matrix (see below)

FIG. 6c shows how the IES enables its user to scroll, for any BID-cr-C, through all tests' argument chains it is involved in (see below)

The item names used by the GUI in FIGS. 4/6 are those of a specific PTR analysis, i.e. of the '453 patent¹⁾.

The fundamental philosophy underlying the generation process of a PTR-DS for a given PTR has been described in Section III.3, split into its general principles^{4)a.-d.} oriented Subsection III.3.1 and the Subsection III.3.2, which introduces and elaborates on the concise IT notion of “concept”. Their endnotes⁴⁾⁻⁷⁾ often refer to a PTR's FSTP analysis^{4)e.-g.,9)5.}, i.e. its “FSTP Test”¹⁾, which belongs to a class of functionally equivalent algorithms and is subject to pending patent applications. The inventions of this patent application disclosed here assume familiarity with performing, for a PTR at issue here, first its FSTP analysis.

For this Section V. thus remains to disclose in its Subsection

V.1 all the details of the claimed invented methods resp. systems, as well as in
V.2 a specific subset of the total set of BID-cr-Cs embodied by the claimed inventions explained in V.1, and in
V.3 to outline why the use of these concepts by these claims' wordings actually does pro-actively^{9)5.,4)f.} indicate that the claims meet the requirements set forth under §§112, 102, 101, and 103 (as announced in ftn^{4)g.(1-8),9)5.}). This proactive indication in a patent applications' specification and its claims' wordings—that they both meet the requirements set forth by these 4 §§—is a novum, as classically both would hitherto be much less legal issues minded, i.e. would hitherto provide much less transparency as to these 4 §§.

Thus, the novel caring for legal indications in V.1-V.3 shall evidently facilitate the examinations of the claimed inventions by PTOs and eventually courts, i.e. exemplify the “paradigm change” announced above^{4)h.}.

In the following the PTR postfix “^{CT}” is often left away, as this cannot be misunderstood, i.e. for convenience.

V.1—The Claimed Inventions: Generating a PTR-DS and the IES The claimed inventions solve problems known from using a data base system in arguing about a patent. Namely, its incapability to deliver—for any query as to a PTR—the correct and complete answer in real-time. I.e.: The generated inventive PTR-DS together with the inventive IES are a PTR expert system, more precisely a real-time PTR query interpreting/answering machine. The PTR-DS by itself enables building on top of it, independently of the IES, a whole range of quite different Expert Systems (ES) controlled by the PTR-DS. Any such PTR-ES would use the PTR-DS and hence may know
all relations—there are solely finitely many—between the marked-up items of information (MUIs) of the PTR^{CT} of a given particular “context, CT”. These relate, in any legally meaning-/helpful way for a patent business practitioner, all doc.i (i.e. subject matter) items to all doc.CT (e.g. legal) items embodied by the PTR^{CT} (i.e. take into account all of a patent law and its precedents/examination-directives/ . . . , and e.g. standards/ . . . , jointly abbr. by “context”)^{9)5.}.
all reasonable queries—again there are solely finitely many—as to such relations (put e.g. in a given ES-specific presentation language, or in SQL, . . . ), hence instantly recognize any such query, and instantly answer it correctly and completely (in a representation selectable by the user).

In terms of compiler technique, the PTR-DS for a given PTR comprises: A non-inventive query parser (as it may be generated by a compiler-compiler, such as the YACC), the inventive semantic routines generating and retrieving the building blocks of answers to all queries, being items defining limitations modeled by next-to-trivial BID-cr-Cs (i.e. the semantics of these routines, i.e. what they perform on execution, are described below and in V.2), and the inventive presentation of the PTR in a data structure PTR-DS. From this PTR-DS the semantic routines—after they interactively with the user built up K(PTR-DS) during PTR-DS generation, such that it contains all technical and legal information about PTR potentially being queried—are able to instantly retrieve such information. The semantics of these semantic routines (linked to the compiler-compiler generated query interpreter, as known from compiler technique, for enabling the interpreter to deliver the queried information in real time) and hence their cooperation is explained in detail below, just as the implementation of the functionality of the IES.

For any realistic PTR, (i) the generation of its PTR-DS is possible only to a computer implementation executing the invented method and (ii) a PTR-DS is useful only for controlling a computer executing an ES. That both activities definitively exceed the capability of any human being is due

(i) to the large number of items to be generated and managed absolutely dependably during building up a PTR-DS —if one generated a PTR-DS without computer control its correctness and completeness is non-verifiable—but,
(ii) first of all, to the real-time needs of using this huge amount of detailed information in answering arbitrary queries posed as to this PTR, whereby such queries often imply legal and/or technical questions not answerable in real time at all—though they need not address much information—unless the answer has been determined in a time-consuming process earlier already and then stored in PTR-DS for later real-time use by a query.

This unavoidable huge amount of information from which instantly to retrieve ex- and/or implicitly queried ones permanently and completely, often ten thousands of items per hour, the bulk of them retrieved only for potential use—and in particular the many queries ad hoc not instantly answerable at all, as raising thoroughly to be analyzed questions—require provisions for realizing the claimed inventions' capability to instantly and permanently delivering all correct and complete answers for any query up-coming during a PTR discussion/argument. These provisions are: Proactively screening for all meaningful questions and determining/storing all their answers up-front in the PTR-DS, thus enabling delivering such queried information instantly, otherwise inevitably deliverable only in non-realtime—in particular if these answers potentially are to be confirmed^{III.3.2D4/N4}, in an argument chain^{V.2}, by the poposc's opinion. In the future, such confirmations will further going to be replaced by automated confirmation generation—currently being a matter of semantics research, i.e. not elaborated on in this patent application.

I.e: The claimed inventions of generating for any PTR its PTR-DS and of implementing an IES using a PTR-DS efficiently—both together capable of instantly answering any technical or legal query as to PTR's TT.0—definitively are not just automating processes executable by men. But, these inventions transform these processes such as to enable a computer to automatically provide a much more powerful service ever deliverable by men. Namely, to control the computer of an ES by a PTR-DS such that the ES permanently provides in real-time to any one of the—in any argument about a PTR—permanently upcoming reasonable queries (about all of the PTR's subject matter and legal items) the respective answer completely and correctly. This then is to be evaluated by a user, PTO, or court. All these technical and legal facts of a PTR, now accessible in real-time, were hitherto unavailable in real-time. Hence FSTP could alternatively stand for “facts screening and transformations into real-time presentability”.

The below box shows an evidently executable algorithm, which discloses the crucial steps to be performed by any embodiment of the claimed invention of generating a PTR-DS—being the common kernel of the TT.0s of the 3 claimed inventions. It describes the properties of its(their) elements, being user (or automatically) generable sets of different kinds, by limiting these sets' elements by BID-cr-C objects^{III.3.2,9)1.-2.}. These are marked-up therein by bold letters. Any such BID-cr-C is defined inline therein behind the “≡”—to be read as “limits the here generated set(s) to have the property described next”—if it has a trailing “^{x)}” it is explained offline by the resp. “x)-subsection”, too. The BID-cr-Cs used therein belong to the PTR^{CT} at issue or to the claimed invention(s)—as will become clear further down and evident in V.2, after having grasped the philosophy explained in V.1.

This algorithm is an annotated copy of claim 2; it hence leaves away the preamble of claim 1. Instead it stresses the properties of the elements of the claimed invention(s) by naming these elements' BID-cr-Cs^{9)1.,2.} explicitly. I.e.: Apart from the more limited access-concept in claim 2, these elements and their properties are structurally the same in both claims—claim 2 solely describes them by different wordings. The thus provided terminological redundancy facilitates grasping the limitations/properties described by the BID-cr-Cs^{III.3.2}, the claimed invention(s) is(are) based on (in particular the claims' wordings) and that its(their) here provided disclosure is evidently enabling.

The subsections a)-c) describe these inventive elements and their properties/concepts^{9)1.-2.} in detail—visualized by FIG. 5—V.2, just summarizes them. FIG. 6 then illustrate their practical use by the inventive IES.

A method according to claim 1, whereby its generated sets have the properties described in (a)-(k) by their BID-cr-Cs^{a)}:

| (a) | (a).1 “AD-TT.0-concept” ≡ it comprises | a) an element X.0.n - these sets are not AD specific - or |
|---|---|---|
| | b) a predicate AD-X.0.n, 1≦n≦N, | c) referring to AD-Cs initially not definable^{III.3.2.D3/N3-D5/N5}, and |
| | (a).2 “BID-TT.0-concept” ≡ it comprises | a) a BID-C.0.kⁿ, 1≦kⁿ≦Kⁿ, Σ^{1≦n≦N} Kⁿ = K≧N, such that |
| | b) any AD-X.0.n of (a).1 is a conjunction of the mirror predicates^{9).1-2.}BID-C.0.kⁿ of the BID-C.0.kⁿ, | |
| (b) | “SoDIS(Y.0)-concept” ≡ its element “SoDIS(Y.0))” ::= {dis(y.0)::= {MUI.0s disclosing Y.0}}^{(a),(b)}, | |
| (c) | “SoJ(dis(y.0))-concept” ≡ its element “SoJ(dis(y.0))” ::= {I.CTs justifying dis(y.0)}, | |
| | and for any 1≦i≦l in (d)-(f) | |
| (d) | “BID-TT.i-concept” ≡ it comprises | a) an element X.i.n peer to X.0.n or a peer dummy-X.i.n^{6)a}, or |

| | |
|---|---|
| | b) a BID-C.i.kⁿ, if it is = BID-C.0.kⁿ or^{6)a.} a peer dummy-BID-C.i.kⁿ, 1≦kⁿ≦Kⁿ, 1≦n≦N, |
| (e) | “SoDIS(Y.i)-concept” ≡ its element “SoDIS(Y.i)” ::= {dis(y.i) ::= {MUI.i's disclosing Y.i}}, |
| (f) | “SoJ(dis(y.i))-concept” ≡ its element “SoJ(dis(y.i))” ::= {I.CTs justifying dis(y.i)}, |
| | and further |
| (g) | “BID-AC-concept” ≡ it comprising an AC^{III.3.2,1)}of the PTR^{CT}, |
| (h) | “SoQCC(Y)-concepts” ≡ its element “QCC(Y)” ::= {qcc(y) ::= {Q-CC^{III.2}Y/mod(Q-CC) ants TT.0}}, |
| (i) | “SoJ(qcc(y))-concepts” ≡ its element “J(qcc(y))” ::= {I.CTs justifying qcc(y)}, |
| (j) | “SoARGC(T)-concept” ≡ it comprises argument chains^{a)} as to the execution of a test T, any chain limited to com- |
| | prising only T-specific sets from (a)-(i) as links, being glued together by natural language fragments, |
| (k) | “SoAccess-concept” ≡ it comprises at least one q/a-provision, which guarantees within 1 sec to |
| | (k).1 recognize in any query put in a given query language of the PTR^{CT}-DS an item generated in (a)-(j), |
| | (k).2 retrieving said item and presenting it in a representation of the PTR^{CT}-DS determinable by the user^{a)}. |

Both FIG. 4 exemplarily show how the IES user, a patent business practitioner, may establish anytime the correct working set—while generating the inventive PTR-DS or using it by the inventive IES—by selecting, in the left column of FIG. 4a, the actual marked-up subject matter documents he/she needs in this working set, and on its right side, the actual portions of the context needed therein, also marked-up to this end. Its bottom line shows the actual PTR and different modi the IES and/or the execution of the PTR-DS method/system may be in, FIG. 4b how a task bar and one of its pop-up menus may look like during actual working for generating the PTR-DS at issue by the IES.

The FIGS. 5 and 6 and their descriptions disclose the PTR-DS as consisting of classes alias types alias kinds of creative/inventive concepts (of the here claimed inventions as well as of the PTIR^{CT} under consideration by means of them) resp. these classes'/types'/kinds' objects. In colloquial language, classes as well as their objects may be called “items”—just as the MUIs—as terminologically distinguishing them is often not worthwhile, once one got familiar with the “working” of the claimed inventions, i.e. one can use them practically. FIG. 5 focus on the view of items and their relations alias properties as comprised by the PTR-DS, FIG. 6 on some schematic presentations of these items at the GUI of the IES. Both views are needed for meeting the patent practitioners' requirements an IES and/or PTR-DS got to meet. Proceeding top down in explaining these requirements, the graphics of the

FIG. 6 provide an overview about how the IES enables the user to navigate through the sets of “subject matter” items (see a) below) of a PTR in some CRT^{III.3.2,Def 5}, all of them comprised by the PTR-DS, and how he/she may navigate through the sets of subject matters of a CRT, their justifications and their use in natural language argument chains based on all of them, also comprised by the PTR-DS. A patent business practitioner performs such navigations and uses of argchains during a PTR analysis at whatever stage, e.g. in the “PTR-DS generation” mode or in the “arguing about PTR” mode.
FIG. 5 illustrate the interrelations between the terms/notions embodied by the claimed inventions—i.e. the meanings of the terms underlying both of them.

Both kinds of FIGs show representations of these subject matter and/or legal items, i.e. terms/notions, which are eventually automatically translatable into mathematical formulas, i.e. open the door for absolute preciseness and further going automation^{V.2}—both aspects not elaborated on, here.

In principle, for all PTRs—inclusively their actual contexts, implying minor impacts^{III.1}—their PTR-DSes are structurally the same and finite (see the beginning of V.1). All that varies between PTR-DSes is the number of objects of any class and their user defined aspects, in particular in argument chains. Thereby not all classes need to have an object, i.e. may be empty. Yet, the set of all (not user-defined) classes and relations between them (and inherited by their objects, if there are any) is always the same. Thus, the generation of an incarnation of a PTR-DS for a specific PTR in any CRT can start—even simpler than described above—from a prefabricated abstract model of all PTR-DSes (for the context at issue) and just copy from it, interactively user controlled, components for this incarnation's objects. Their semantic routines' parameters then again would be filled in interactively by the user (whereby deriving them from the doc.i-MUIs evidently may be vastly supported by known text processing routines). This abstract model of a PTR-DS hence may be viewed as a (flexible as highly parameterized) class declaration, the objects alias incarnations of which are the claimed invention's PTR-DSes derived from and hence specific for the PTRs (and their CRTs) underlying them. Section V.2 will reiterate on the BID-cr-Cs defining the properties of the elements—here: classes of sets—this class declaration alias abstract PTR-DS is made-up from; the same make-up then holds for any incarnation of this abstract PTR-DS, i.e. its parameterization by a concrete PTR giving rise to an object of this abstract PTR-DS, this object being called just PTR-DS (i.e. leaving away the adjective “abstract”).

Though this “abstract”/“concrete” alias “declaration”/“object” distinction is of fundamental importance in IT System Design—and for a clear understanding of the principles of thinking underlying the claimed inventions—in their practical use these differentiations probably are not worthwhile, as mentioned above already: Hence the above introduced colloquial term “item” putting away with it, as it may identify a class or an object of it. Often using this “lower degree of notional resolution”, a)-c) once more elaborate on the terms/notions here introduced and used for describing the processes driven by a patent practitioner's generation or use of a PTR-DS—and hence used by the below claims' wordings. These elaborations often refer to lines (a)-(k) in the wordings of the claims 1, 2, 11, 12 and in the excerpt from 2 and 12 in the above box. As explained above already, any one of these lines (except (k)) comprises structurally exactly the same statements as to “its” elements and their properties.

a) The FIG. 5 identify by the boxes and ellipses with bold frames the various classes the claimed inventions deal with. A PTR-DS comprises PTR specific instantiations alias objects of these classes, called “subject matter” items if representing the PTR's AD- or BID-TT.0 items (in the above box the sets of lines (a), (b), (d), (e), (g), (h)) resp. “legal” items otherwise—though this categorization is sometimes irritating, as shown by the generated item of line (k). Identified items are shown by “” in their classes—see FIG. 5a and its reconsideration for two CRTs^{III.3.2} in FIG. 5e—and may be assumed to exist prior to starting or being generated at the very beginning of using a claimed invention (if within boxes only) or to be generated later during its execution (if additionally or solely within ellipses). A priori items are usually PTR unspecific (such as the BID-cr-Cs of the claimed inventions), generated items are usually PTR specific (in particular the BID-cr-Cs of the PTR's TT.0). Both kinds are graphically not separated as this distinction in practical use seems to be insignificant. Relations between items are shown by double-headed arrows between them. Relations are no items, but are represented and described by them. Finally, under any point of view of looking at the PTR, a particular CRT^{III.3.2,D5} would be in use —whereby toggling between the CRTs/point-of-views is possible anytime.

Just for simplifying the description of this method in the box, doc.0 is viewed as implicitly comprising doc.CT —thus this doc.0 is distinct from PTR's^{III.3.1/2.} doc.0. This simplification is not used by the FIGS. 5/6. doc.CT represents the “context” of the PTR and is defined as set of documents containing marked-up information items, MUI.CTs, determining a National Patent System (by its patent laws, precedents, authorities, their patent examination directives, other law/directives/ . . . , documents of posc), and/or application specific recommendations/limitations/warnings/entitlements/warranties/costs/directives/ . . . , and/or confirmations by the poposc required^{II.3.2}, (see FIG. 5a, right box). The term “I.CT” denotes compounds from doc.CT-MUIs, just as doc.CT-MUIs.

Note that using here the terms/notions “subject matter” and “legal”/“context”—instead of the more abstract and not quite identical notions “plcs” and “pmgp”¹⁾—means temporarily turning away from the epistemological/mathematical/sub-physical^{*))} view at the PTR in favor of using the established view at it of patent practitioners.

In more detail: The legal items in FIG. 5b state the lawfulness of e.g. the disclosures DIS(Y) of a subject matter item Y of doc.0. In the simplest case, Y is an elementary^{9)1.} BID-cr-C and disclosing it means just noticing it^{7)a.}. But often something more complex got to be “disclosed” in a more complex sense—elaborated on next. The guidelines being: A disclosure comprises a set of one or several plainly lexical/syntactical/graphical MUI.i's individually or collaboratively allegedly disclosing Y (see line (b) and (e)) and is a subject matter item. And: Any subject matter item y needs a “legally hard” justification J(y)^{b)}, e.g. a dis(y)∈DIS(Y) needs its J(dis(y)).

FIG. 5c shows, to begin with, that the similar steps as for TT.0 (see the algorithm in the box) would involve any one of the TT.i's, i>0. Yet here recognizing a “disclosure” of a peer C in TT.i to the above BID-cr-C is an often different and more complex activity than just showing that this peer is noticed in TT.i—namely in all cases that TT.i does not notice this BID-cr-C but no peer at all or a peer C different from it, i.e. TT.i not-anticipates this BID-cr-C. Then “disclosing” this peer—in our notation we then denote/replace it as/by “dummy-C”—requires not only a) showing where this dummy-C is noticed in TT.i but also b) showing that dummy-C≠BID-cr-C (both by subject matter statements). I.e.: Showing the lawfulness of disclosing the dummy-C now comprises showing the lawfulness of both subject matter statements (not just of a), as in case of TT.0).

I.o.w.: Except MUIs, all objects are generated by the execution of the method/apparatus, i.e. by the steps of generating a PTR-DS according to its BID-cr-Cs, vastly supported as to any BID-cr-C by user input. In the algorithm of the above box, more precisely: of claim 1 and claim 2 (see V.2), the generated sets limited by e.g. a SoDIS(Y.0)-concept or SoDIS(Y.i)-concept have these different properties, as these BID-cr-Cs are implicitly differently defined in line (b) and (e)—they actually describe on both lines disclosures of two quite different kinds. The sets generated in line (c) and (f) up to SoJ(dis(y))—being sets of one or several plainly lexical/syntactical I.CTs individual or collaborative legal statements as to the subject matter items dis(y)—are different, too.

The same considerations as to lines (b)/(c) and (e)/(f) apply to the items Y and qcc(y) of the lines (h)/(i).

The additional legal items called “ARGC” on line (j) are vastly freely user definable and enable him/her to put, as to any test T (see further down), any sequence of items from (a)-(i)—including hard legal statements, possibly being automatically generated, anyway supposed to implement this test—into one or several “soft” and legally equivalent presentations as chains of natural language arguments, which may be more suitable for immediate use in a real-time dispute of this test.

The final legal items on line (k) may always be automatically generated, as known from Data Base Design.

Repeating this for assessing its understanding i.o.w.: Clauses (a)-(f) and (j) tell that generating e.g. a BID-cr-C item as Y in step (a).2—i.e. determining one of the “elementary cr/de properties” of one of the X.0.n^{9)1.}—and then the other identified items describing BID-cr-C's alias Y's relations to doc.0 in steps (b)/(c)/(j), is not a serial mental activity focused on this Y “as such” but comprises the three groups of iterative mental steps (also comprising other items):

(i) identifying as many as possible Y's/BID-cr-C's “subject matter affine” MUI.0s—affine by starting with tentatively assuming technically clear definitions for Y/BID-cr-C^{III.3.2,D3}—and then creating by these MUI.0s the SoDIS(Y), i.e. the set of one or several technically clearly defined^{III.3.2,D3} alternative disclosures dis(y) of Y. This property of the SoDIS(Y) is modeled by the SoDIS(Y)-concept. Thereby is assumed, any one dis(y) were legally justified—this to clarify is left to (ii) next.
(ii) identifying for any one such dis(y) as many as possible of its “disclosure legalizing affine” I.CTs—affine by starting with tentatively assuming correct legalizations of Y/BID-cr-C^{III.3.2,D3}—and then creating by these I.CTs the SoJ(dis(y)), i.e. the set of one or several alternative correct legalizations^{III.3.2,D3} of dis(y).

Note that there may be further legitimacy requirements a BID-cr-C has to meet, in addition to its lawful disclosure—such as e.g. its independency^{III.3.2, Def 2} and/or indefiniteness^{9)5.}, to be provided as part of doc.CT or by the user of the claimed inventions, but not considered here in detail—and for which to test also the other BID-cr-Cs must be taken into account and usually also other I.CTs; any such more elaborate and test specific legitimacy statement as to a BID-cr-C may be comprised by SoJ(dis(y)), as well.

Any such property of the SoJ(dis(y)) is modeled by the SoJ(dis(y))-concept. Then is ascertained that any identified item describing BID-cr-C's alias Y's relations to doc.0 is modeled as having a multitude of technically clear and precise disclosures and any one at least one legal justification.

(iii) creating for this BID-cr-C and appropriate ones of its so created further items needed for performing some test T—together representing an unwieldy insight into T's outcome—a transformation into ARGC(T), i.e. a set of convenient chains of arguments as to T, suitable for use in a dispute of BID-cr-C under T.
Then generating for the peer to this BID-cr-C in doc.i, i>0, and all doc.i related peer items in (i)-(iii) comprises, in steps (d)-(f) and (j) similar⁷⁾ steps leveraging on (i)-(iii), as known from the FSTP Test¹⁾.

As to performing steps (g)-(j) the same considerations apply as the preceding paragraphs just discussed.

Thereby, subject matter items would be supported by confirmations by the poposc, legal items referring to them by a lawyer—both of which a resp. PTO and eventually a court may approve or not.

b) For a Y of a certain BID-KR(PTR) different SoDIS(Y) and/or different SoJ(dis(y)) may exist. Yet, they all got to be consistent in this BID-KR(PTR). The same applies for any BID'-KR(PTR) isomorphic to BID-KR(PTR), as then warranted by the Theorems above^{III.3.2}. Executing the claimed method therefore enables, for many PTRs, creating and checking many redundancies. This is extremely important for early error detection and establishing robustness of the PTR-DS at issue—not elaborated on, here.
c) Summarizing the hitherto said:
FIG. 5a depicts, in the doc.0 boxes/ellipses TT.0's subject matter items available a priori in doc.0-MUIs, nevertheless generated for the PTR-DS by steps (a)-(c).
FIG. 5b additionally shows how these dis(y)-items are “legalized” by I.CT items.
FIG. 5c adds by steps (d)-(f), to this set-up of TT.0 items, the analogous set-ups of TT.i items for PTR's RS, 1≦i≦l, using the resp. simplifications known from the FSTP Testi) for determining the peer dummies in a TT.i.
FIG. 5d shows adding BID-AC-items and their related items.
FIGS. 5e and 5f—usually irrelevant for practical work, but nevertheless supposed to visualize that different maximal sets of BID-cr-Cs for TT.0 may exist for a single CRT and that even different CRTs may exist—go back to FIG. 5a. They basically show, here just for completeness, how a PTR-DS is supported by the mathematics underlying FSTP Technology, i.e. by the AD/BID bijections^{III.3.2} of Def 3, by sketching how these bijections eventually would be defined. I.e.: FIGS. 5e and 5f outline the nexus between the PTR-DS and the mathematical Theorem^{III.3.2} guaranteeing the invariance of a PTR's creativity/inventivity over all its KRs.

While the FIG. 5 visualized the relations between the terms/notions of the invented PTR^{CT}-DS, the FIG. 6 finally show that the eventual purpose of any PTR-DS is to control the execution of a computer. I.o.w.: In addition to generating, by facts screening and their transformations, a potentially specific (as application area customized) PTR^{CT}-DS for use by a decision making or marketing system of this particular area, the claimed PTR^{CT}-DS actually controls a (often different) computer system (possibly dedicated to) executing this system such that, on demand by a an application area specific query, it always instantly presents the queried subject matter and legal facts as well as the needed argument chains based on them completely and correctly. Without the invented PTR-DS it is impossible to realize a method or apparatus capable of this real-time kind of query answering. Only its generation as well as its use being based on computer-implemented processes—and, leveraging on the finiteness of the PTR, thus allowing to identify during its generation any query that later may be posed, answering it then already in a potentially time-consuming activity, and storing this answer for later instant availability—enables realizing the claimed inventions.

As to the invented IES, the FIG. 6 visualize three simple but practically very powerful graphics, which support any patent law professional while he/she legally tests a TT.0 of a PTR as to e.g. the above 4 §§ of 35 USC, thereby arguing the usual way in broad and general terms or in arbitrary detail of technical or legal issues of the resp. test. This support is instantly provided to him/her when navigating through his/her well-known set of terms/notions, questions, laws, precedents, examinations, interviews, briefs, and other directives, . . . , and through his/her well-known respective activities therewith, i.e. when he/she is “argumentatively surfing” on the often and rapidly changing surface of a dispute, which below this surface actually is dealing with a huge amount of often complex information (all of it precisely determined and stored up-front when the PTR-DS has been generated). While he/she is actually dealing with this—in an actual dispute—uncontrollable situation, his/her brain probably would not really become aware of this frightening mass of facts, as a human brain simply is not capable of maintaining in real time absolutely correctly the complete set of all the facts it actually is supposed to be aware of. In the future this—today unavoidable—deficiency of arguing about a patent will no longer be tolerable: A PTR-DS based expert system (such as the IES) namely enables avoiding a priori any by this deficiency embodied risk by a careful rehearsal prior to an upcoming dispute, be it in a patent prosecution situation or litigation situation or marketing/licensing situation.

While this rehearsal for a dispute generates additional cost, the advantage achievable by it—not only getting an analysis of this dispute, which is absolutely complete, in any technical and legal detail correct, fully precedents-consistent, and dependably/vastly the decision predicting of a PTO or court examination, but additionally also getting at any point in time during this examination in real time any information useful to this end—makes it worthwhile if enough money is at stake. This shows the practical usefulness of the claimed inventions.

In more detail: The FIG. 6 disclose 3 sets of items and their relations between them and to other items of the PTR-DS, represented as exemplary schematic graphics, which the IES is capable of deriving from a PTR-DS at any point in time. By these sets of related items—evidently they give rise to a large variety of graphical and/or other human perceptible representations not elaborated on, here—the IES enables its user to conveniently surfing on the PTR's surface in one of its CRTs, as it permanently takes place in any such dispute (see FIG. 6a). These sets also enable its surfing user to instantly access any in-depth information being discussed at a point in time, which is pertinent to any BID-cr-C of both TT.0s:

of the TT.0 of the PTR being analyzed/used—such infos, being comprised primarily by subject matter items of the PTR-DS, are concerned primarily with these BID-cr/de-Cs' concrete definitions—as well as
of the TT.0 of this patent application—such infos, being comprised primarily by legal items of the PTR-DS, are concerned primarily with these BID-cr/de-Cs' concrete legal relations to I.CTs, primarily of some tests of them as well as with chains of arguments based on both kinds of items (see FIGS. 6b-c).

Thereby

FIG. 6a is a schematic snapshot of the “survey window” of the GUI of the IES, which shows (see also FIGS. 6b-c)

(I) on the right side a PTR's stack of 3 TT.i “subject matter planes” and per TT.i its o-/AD-/BID-KR peer subject matter items—per TT.i arranged on its plane in concentric “KR rings” (delimited by dashed lines) and having KR specific shapes, the small ellipses representing BID-cr-C (resp. their peer dummy) items, one of them being selected—and

(II) on the left upper side this subject matter item, again, together with all other items pertinent to it, in particular its legal items and those of all tests as to it supported by PTR-DS (including their J and ARGC items), i.e. the part PTR-DS pertinent to it, while

(III) the left lower side shows in doc.i the mark-ups (MUI.i's) for the selected subject matter items' disclosure(s), and in doc.CT the mark-ups (MUI.CTs) implicitly and/or explicitly referred to by J and ARGC items.

The right side TT.i stack evidently serves for providing to the user a PTR specific graphical overview about the subject matter items he/she in total may be concerned with at all. More precisely, it enables the IES user to searching for, surfing among, and diving into them—and hence to accessing all items for ascertaining their proper disclosures and all their technical and legal relations provided by the PTR-DS (explained by the FIG. 5), visualized by the stacked 3 “FIG. 5 blocks” on the left upper side and the stacked doc.i's and parts of doc.CT on the left lower side.

FIG. 6b shows the ANC matrix known from the FSTP Test¹⁾: Its columns represent the BID-cr-Cs of the PTR-DS, and any entry on its lines states for the resp. doc.i, i>0, whether its peer to this BID-cr-C “ANCs” the latter^{III.1}.
FIG. 6c lists, instead of the doc.i's in FIG. 6b, exemplary argument chains items for tests of patents—tests separated by bold lines—in particular tests stereotypically occurring in patent business, such as for their meeting the 35 USC §§112/102/103/101 requirements, but also further user-selected or user-defined (e.g. as PTR specific) tests^{9).6}. In particular the user may define some AC item—by selecting it from FIG. 6b—for an “anticipation test” or a “plcs-height or pmgp-height test”^{III.3.1,1)} and have it represented in FIG. 6c as a set of ARGC lines. I.e. any such complete test may be represented as several different ARGC items, each represented by a separate line. How a specific ARGC item is made-up from other items of the PTR-DS and natural language fragments between them is exemplarily shown to the user, in FIG. 6c, in the box below this list, as this specific ARGC item is selected by the user; alternatively, this info can be conveyed acoustically to him/her.

The headline of this list is the same as in FIG. 6b. But here any Y, i.e. BID-cr-C, is split into sub-columns, each representing a dis(y) or J(dis(y)). The entry of any such sub-column on any such ARGC line indicates, whether the latter uses the former.

Note, finally, that the user may select all items of the PTR-DS in any query as to them either acoustically by just quoting them or graphically by clicking on them. No such I/O details are elaborated on here.

V.2—Inventive/Creative BID-Concepts Alias BID-cr-Cs of the Claimed Inventions: If the interpretation of the wordings of the independent claims 1 and 11 of this patent application is performed—i.e. the description of the TT.0 underlying them is construed from them—by means of BID-cr-Cs^{III.1-2,9)}, their generic notions has to be used for describing the properties of this TT.0's elements, i.e. of the sets these claims' wordings use. Exactly the same applies for the dependent claims 2 and 12 (more limited only in their final clause), though both their wordings use explicitly these BID-cr-Cs and thereby also define explicitly (and redundantly) their trivial generic meanings —while these BID-cr-Cs are not trivial at all: The AD-TT.0-concept, the BID-TT.0-concept, the SoDIS(Y.0)-concept, the SoJ(dis(y.0))-concept, the BID-TT.i-concept, the SoDIS(Y.i)-concept, the SoJ(dis(y.i))-concept, the BID-AC-concept, the SoQCC(Y)-concept, the SoJ(qcc(y))-concept, the SoARGC(T)-concept, and the SoAccess-concept. Except for the SoAccess-concept the structure of the (other 11) BID-cr-Cs are identical in all four claims.

The independent claim 22, too, uses all these BID-cr-Cs implicitly.

That these BID-cr-Cs are creative/inventive (i.e. nowhere described in skill or prior art) as well as binary and independent^{III.3.2,D2} is evident to the poposc in IT System Design. Other depending claims use further BID-cr-Cs.

V3—The Claimed Inventions Indicate that They Pass the §§112, 102, 101, 103 Tests: Up-front: If the above paradigm change^{4)h.} were in place already, this short Section were accompanied by a PTR-DS, which then represented the complete analysis of this patent application's TT.0s. The subsequent comments shall replace it.

The inventions' claims are based solely on the above defined 12 BID-cr-Cs and thus are indicated—as their disclosures evidently also meet the definiteness and enablement requirements—as passing their tests under §112.

As no applicable prior art is known they are indicated as passing their tests under §102.

Due to the latter reason, the claimed inventions, each seen as a whole, has an inventive/creative height of Q^{plcs}=Q^{pmgp}≧12 and thus is indicated as passing its §103 test.

None of the claimed inventions, each seen as a whole, is exempted from patentability. In particular none of them is solely an “abstract idea”—the other reasons for patent-ineligibility are not applicable.

The evident reason is that any one of them deals in a multitude of ways with reading from, performing modifications on, and writing on physical media—and thus is far away from any notion of “abstract”.
In addition, all three claimed inventions also pass the recently suggested functional test of a claimed invention for not being solely an abstract idea: Any one of them passes it, as reducing it by not using one of its 12 BID-cr-Cs would result in a method/apparatus not solving the problem it is supposed to solve (as summarized below) as it would fail to solve the PTR (solved by the claimed inventions) due to its inability to warrant that it answers in due time—if at all—a query for an item of information indispensably unavailable to it due to its reduction by it.

Thus, any one of the claimed inventions is indicated as passing its §101 test, too.

The PTR set out for solution by the claimed inventions is summarized as follows: They shall support solving a concrete PTR^{I.} by enabling the user of the IES^{I.}—the latter using the former's PTR-DS^{I.}, both working under pragmatic conditions^{I.} alias in a context^{I.} described by a document.CT^{V.1}—to generate, in a complete analysis and based on the mark-up of the PTR^{CT}, a PTR^{CT}-DS comprising all technical and legal facts alias relations between TT.0 and a given RS resp. a given context, such as a legal system (in the US e.g. to 35 USC §§112, 102/103, and 101) and in this case enabling the IES to instantly recognize and answer any reasonable query for any such relation.

Thereby the analysis is defined to be complete if all of the only finitely many different disclosures of the only finitely many subject matter facts/relations and for any one of these the only finitely many shortest concatenations of I.CTs legally justifying them (see V.1) are taken into account by the user when generating the PTR^{CT}-DS. This definition of the PTR implies that the scopes of the claims are not limited to comprising only algorithms/apparatus performing a complete analysis. Any algorithm/apparatus making use of all 12 above BID-cr-Cs at least once and performing or using an incomplete analysis but being extendable to performing or using a complete analysis (as just defined) belongs to their scopes—independently of how many BID-cr-Cs of the PTR's TT.0 are taken into account.

### FOOT-/ENDNOTES

^{*))} The young science of Mathematical Logic deals with “modeling” the various mathematics and which of the axioms they are based on enable proving/computing what mathematical statements [“Computability and Logic”, Boolos/Burgess/Jeffrey, 2007, Cam. Univ. Press, “BBJ”]. Axioms, formerly called e.g. hypotheses or postulates, represent items of metaphysics/fictionality/irrationality/unknown. Already at Aristotle's—probably even Echnaton's—times, “mathematical/logical models”, whatever they were called at their times, knew such metaphysical/fictional items, usually without recognizing them as such, e.g. “natural numbers”, “distance”, “straight line”, “arc”, “circle”, “irrational numbers”, . . . . Over the millennia, such models became comprising further metaphysical/fictional items, e.g. the “0”, “=”, “π”, “i”, “e”, “sin”, “√”, “∫”, . . . . The last centuries' physical/mathematical/logical models have assumed ever more and in substance increasingly metaphysical and complex items, e.g. “gravitation”, “mass”, “time”, “energy”, “set”, “algebra”, “topology”, . . . —and today identifying them by their “axiomatization” is good scientific practice.

Historically, models and their postulates/hypotheses always served for rationalizing and analyzing issues of various

either “non-craft-based” arts—i.e. of “purely mental” kinds alias Mathematics, e.g. (Euclidian) Geometry, . . . , Probability Theory, . . . , Analytical Logic [Frege], . . . , Mathematical Logic, . . . , Modern Algebra/Geometry/Topology . . . —
or “craft-based” arts for expanding their already “rationalized” parts or making these dependably provable/computable, e.g. transportation techniques, navigation techniques, construction techniques, weapon techniques, . . .

All models of the latter kinds hitherto have comprised physical axioms (called “laws of physics” or “laws of nature”, comprising any kind of “mandatory physical practices” and alike). E.g., the differential equation systems in II. model items of building construction technology, any elementary particles theory models Planck's discrete energy levels and Heisenberg's uncertainty relation, the Ptolemaic/Copernican/Einstein theories model the universe, . . . , any recognized surgery practice models disinfection practices, . . . . Modeling “any piece of the real world(s)” is allegedly enabled by “Description Logic” [DL, “The Description Logic Handbook”, Baader/Calvanese/McGuinness/Nardi/Patel-Schneider, 2. Ed., 2010, CUP], based on a specific notion of “concept”^{4):e.-g.}.

The “FSTP Model of Innovation”^{III.4} differs from the latter kind of models, i.e. is of the former kind—though it also rationalizes a part of a craft-based art, namely of the “innovation/patent” art (hitherto not seen as craft-based art, which it actually is, as it is vastly technical⁷⁾. It gets along with only the ZF and 2 new FOP preserving “creativity/innovation modeling” sub-physical axioms, i.e. dealing with pure metaphysics/mathematics. Their very substance has in principle been recognized already, when elaborating on the meaning of the since ever fundamental terms/notions of “thought” and “fact” by Leibniz/Newton/Kant/ . . . /Frege/Wittgenstein/Einstein [e.g. “Mathematik and Theoretische Physik II”, Hellwig/Wegner, de Gruyter, 1993, page 1]. Now they enable mathematically modeling HIGHEST COURTS' patent precedents^{4)a.}. Thoughts as such being invisible, rationality assumes no fact exists without a thought having created it³⁾, as it is manifested by its relations⁴⁾ alias truth set of its predicate referring to concept values^{III.3/4} of a given concept set—just as an invisible elementary particle is manifested by its condensation trail in a given fog chamber.

I.e., in so far the FSTP Model^{III.4} is unique: It mathematically models innovations in craft-based arts, e.g. in patent jurisdiction, yet below their physical aspects. All its rationality prone metaphysics items are purely mental, first of all those of its creativity facts determination as to an innovation's/TT.0's (non)obviousness, but also its pragmatic facts determination, e.g. as to (non)patentability. While creative facts determination is based on eternal scientific/mental insights and pragmatic facts determination is based on decisions by voluntaristic and/or social authorities, they both use only the laws of logic. Thus, it mathematically models inventions/innovations in craft-based arts as being of sub-physical nature, and hence is a novum^{*))}. The mathematical solution derived by using the axiomatized FSTP Model of a mathematically modeled invention/innovation problem in a craft-based art needs no experimental verification—as is indispensable with any DL/mathematical model of a problem in this art—though the FSTP Model's invention/innovation/TT.0 as such would frequently deal with physical problems.

A second characterization of the FSTP Model of innovation emphasizes its nexus between metaphysics and rationality. Notwithstanding the above said about mathematical/DL models—that they all support mathematical problem solving in craft-based arts but vastly differ from each other in their objectives—they have a common denominator: They all base on metaphysics/fiction/irrationality embodying items, called concepts, indeed being their “axioms”. These formalize said metaphysical items, i.e. disguise them as mathematical constructs. Hence, they “rationalize” such metaphysics embodying items of craft-based arts. I.e., axioms always enable leveraging on items of metaphysics—simply by mathematically modeling them.

Finally, a third characterization of the FSTP Model, on top of its two preceding characterizations, highlights its founding potentials as to a “patent technology” and even an “innovation science”, as indicated by its name's postfix “of innovation”. A usual DL model of parts of any specific craft-based art ignores by which innovations—i.e. compounds of creative/metaphysical modifications of concepts^{4):e./f.} preexisting in this art^{5):c.,III.3.3}—an increased rationalization of this part of this art has taken or is to take place for finding new mathematical problems' solutions therein. Such “everyday practicality focused” modeling of this craft-based art is useless when new ways to further rationality within this craft-based art had/are to be found.

Other than any usual DL model, the mathematical FSTP Model^{III.4} does not aim at rationalizing for any real world craft-based art any of its “techniques”⁷⁾, but focuses solely on the alleged “creativity” embodied by a new technique over its prior arts at the former's priority time—whereby the prior art in turn only exists by creativity topping its preceding prior art and skill. I.e.: The FSTP Model's definition focuses on a fundamental notion in any rationality prone art, namely on the invariant in any such art's genesis, being its knowledge evolvement—i.e. totally refrains from any other of its art specific aspects. Hence,

it gets along with elementary parts of DL, i.e. avoids mathematical/logical complexity encountered otherwise in DL [“Basic DL”, the DL Handbook, s.a.]. Yet, any of the FSTP Model's incarnations as PTR Model^{III.4}—of creativity of PTR's TT.0 over its prior art RS—mirrors its TT.p specific art, but solely as to creativity/innovation issues. And as to mathematical simplicity
it even gets along with a still “simpler” branch of finite mathematics, which is very old but only recently has become of broader interest, today called “term rewriting” [“Term Rewriting and All That”, Baader/Nipkow, Cambridge University Press, “BN”] with its self-restriction to sub-FOL⁷⁾ problems—in particular to “concepts and boolean-expressions” rewriting^{III.3}. The very simple language needed to this end would be sub-ML and is not elaborated on, here.

Also different from a creativity disliking “repetitive thinking”—as met in many arts—the “FSTP thinking” and its mathematical model of innovation¹⁰⁾ focus solely on their metaphysical/fictional/irrational items of creativity, but identify them all. Taking it as fundament in analyzing the PTR problem, this lean but complete FSTP Model of Innovation¹⁰⁾ guarantees legal security, by properly and directly mirroring its finiteness. It thus enables immediately practicing the HIGHEST COURTS' “patent precedents way of thinking”: It enables efficiently finding all minimal sets of (metaphysical/fictional/irrational) independent concept creations, which are indispensably required for mentally getting to a TT.0's innovation when starting the search for it from pertinent ordinary skill and some given prior art. This is the basic question underlying the principle of thinking about the PTR problem at probably all national HIGHEST COURTS.

For enabling determining these minimal sets, the axiomatic basis of the FSTP model is expanded, beyond the classical mathematics axioms sufficing for modeling prior art, by two more axioms⁴⁾, which enable modeling all possible creative steps performing such extensions of pertinent ordinary skill and some given prior art. These two axioms enable determining all “shortest paths of creativity” leading from the prior art RS to this innovation/TT.0, implicitly asked for and repeatedly used by HIGHEST COURTS⁴⁾. They add, to the classical axioms of mathematics, items of axiomatized metaphysics located below physics, i.e. still being purely mental, i.e. mathematical. The FSTP Model of Innovation thus expands pure mathematics such that it enables scientifically measuring creativity in the way practiced informally by the jurisdictions of HIGHEST COURTS for their legal assessments of the patentability of an innovation, in any area of technical⁷⁾ ingenuity.

¹ This paper, WO 2012/022612 A1, available at www.fstp-expert-system.com, provides in-depth explanations—especially of the FSTP-Test's error detection redundancy and its application to PTR court cases. Absurdities encountered therein on both sides of the Atlantic, due to the courts' lack of a PTR problem recognizing/analyzing instrument, will be reported in a text book.
² E. W. Dijkstra [in “Teaching and Learning Formal Methods”, by Dean et al., 1996]: “So-called ‘natural language’ is wonderful for the purposes it was created for, such as to be rude in, to tell jokes in, to cheat or to make love in (and Theorists of Literary Criticism can even be content-free in it), but it is hopelessly inadequate when we have to deal unambiguously with situations of great intricacy, situations which unavoidably arise in such activities as legislation, arbitration, mathematics or programming.”
³ Wittgenstein's early epistemological insights as to thoughts vs. facts⁴⁾ ([“Tractatus Logico-Philosophicus”, items 1-3], i.e. not tying this question to his later therein developed “high-language approach to rationality”^{*))}) endorsed, as to facts determination, the primacy to thoughts, i.e. not to their matters alias material representation^{4)a.}: He thus postulates that, prior to a fact being stated by a man, he/she necessarily had a thought of this very fact (stated in whatsoever representation^{4)e.}). Kant had already identified this fundamental deficiency of “upward tying-in” of stating facts to “thinking in natural language”²⁾ by postulating: “I maintain that in any special doctrine of nature only so much real science can be found, as there is mathematics found” [“Metaphysical Foundations of Natural Science”, 1786]. And before him, Leibniz [1646-1716] had already recognized^{*))}, that a fundamental fact, namely “time”, is a physical fact and hence must not be “downward tied-in” to the purely mental mathematics) (as falsely assumed by Newton [1643-1727]^{*)),Hellwig/Wegner}). Leibniz suggested to separately consider time as one of the several metaphysical phenomena of physics, as elaborated on by Einstein in his Relativity Theory—qualifying it as a theory of physics and not of mathematics. Thus, speaking with Kant: The here emerging craft-based art of “mathematical innovation science” taken as one of his special doctrines of nature doctrine not limited by him to be a “some physics comprising” natural science—its theorems^{III.3.2} depend only on the mathematical FSTP Model, with its two additional purely mental axioms^{4)b.,10)}, and hence therein is more mathematics found than the hitherto only known “physics based natural sciences”. I.e., more of Kant's real science can be found therein than in any one of the physics-based established natural sciences^{*))}. Therefore the sub-category of mathematical innovation science, “patent technology”—being a technology due to its vastly stereotype procedures⁷⁾—seems to be the first “not-physics-based technology” with a more powerful mathematical foundation than classical/physics-based technologies. This mathematical innovation science hence is plain real science (as seen by Kant^{4)a.,9)5.}), and patent technology then is a technology based on a new kind of natural science, namely this mathematical innovation science.
⁴ 4)a. Legal Fundamental of Mathematically Modeling COURTS' Patent Precedents The legally dependable determination of the patentability indication embodied by an invention/TT.0 over given prior art RS ought to be of matematical rigor. Yet, to this end hitherto such rigor has never been applied, as no appropriate mathematics was available. Subsequently^{III.3} this is provided, starting from taking 2 of Wittgenstein's insights as 2 new mathematical axioms, additional to the ZF axioms^{*))} of mathematics. Namely insight α) into the being of facts³⁾ of given matters as being rational relations between these matters—i.e. no facts exist as such but solely as relations between matters (just as in Relativity Theory³⁾ and subject to contextual interpretation, which post Tractatus became an issue of its own³⁾, similar to the important IT issue of “scope of variables”), being the matters' “properties”, and β) that the coming into existence of a fact, i.e. of such a relation created by a man, requires he/she has—before it exists—“conceptionalized” this property by mentally creating at least one thought of it³⁾. I.o.w.: The creation of a fact alias a matter's relation alias a matter's property (unknown at a point in time) needs a preceding clearly identifiable thought of it, which is mathematically “modeled”) by a concept representing this property^{1),4)e.-g.,III.3.2,9)1.-3.}. Such thoughts must be identified by accordingly concise claim construction, their being creative/independent^{4)a.(i)} is mathematically modeled by their concepts^{4)d.}, and only these turn out to be dependably indicating an invention's (non)patent-eligibility.

Before looking at mathematically axiomatizing by α) and β)^{4)b.} creative/inventive concepts, elaborating on i) identifying them by claims construction^{4)c.} and finally iii) leveraging on their capability of patent-eligibility indication^{4)g.}, (1) and (2) first explain ii) the concepts' fundamental role as (non)obviousness indicators for an invention. Because of ii), HIGHEST COURTS of the US, Germany and EU started ex- or implicitly using concepts for reasoning about all the issues i)-iii). Thus, concepts today are the nexus between patent precedents and mathematically modeling^{*))} it by advanced IT, in particular by KR.

(1) The X^{th} Panel of the German BUNDESGERICHTSHOF, BGH, decided a TT.0 to be nonobvious, as finding it had required from the inventor performing more than 1 “independent mental step”, if he had started the search for TT.0 from the given prior art. More precisely: In concurrence with the EPC and its “problem-solution approach”, the BGH stressed since its 1999 ground laying SPANNSCHRAUBE decision in two dozen+ of cases on the indispensability of first determining, in any patent/claim interpretation, the TT.0 as disclosed by its specification (representing its inventor) as only TT.0 enables determining the meanings (i.e. semantics^{7)b.}) of these terms in the claims' single sentence, as known by IT since long time^{4)c.}. On this firm ground the BGH went on and explicitly identified in its 2008 GEGENSTANDSTRÄGER decision (BGH X ZR 84/06) the notion of “number of mental steps”, here put with mathematical rigor as “number of independent^{7)c.} thoughts”. The BGH had already earlier repeatedly identified such thoughts in its decisions, as indicating TT.0's nonobviousness. But none of them quite made it to the notion of “number of independent thoughts”: They all used other terms representing less crucial notions for solving the PTR problem—by talking about thoughts' actual consequences, e.g. stating more than one “change of elements” or “change of their sequence of execution”, which do not yet really hint at its general solution.
(2) The US SUPREME COURT (USSC) asks in its 2005 KSR decision explicitly for checking a TT.0 for its (non)obviousness the amount of “creativity” it embodies, as the person of pertinent ordinary (“pos”) skill must not be considered as an automaton, but as the person of ordinary creativity, too (“posc”) [“Cases and Materials on Patent Law”, Adelman/Rader/Thomas, WEST, 2009, p. 2009, p. 320]. I.e.: The USSC considers a TT.0 nonobvious over prior art only if the creativity TT.0 embodies exceeds the ordinary creativity of the person of posc (thus rejects that passing the “automatics only” TSM test by a TT.0 is sufficient for proving its nonobviousness). This totally concurs with the BGH's above precedents: This USSC statement about ordinary creativity namely also asks for a rational measure of the amount of creativity embodied by TT.0—which a TT.0's inventor indispensably had to unfold for finding this TT.0 when starting the search for it from RS—whereby this rational measure should enable determining scientifically, whether the amount of creativity embodied by a TT.0 exceeds the ordinary creativity of the person of posc. The number of independent thoughts, as prompted by the GEGENSTANDSTRÄGER decision, is the indispensable logical/plcs^{III.1} fundament of any such creativity measure the USSC asks for—which its BILSKI/MAYO decisions later screen for patent-eligibility, i.e. pragmatics/pmgp^{1),4)e.-g.,III.1}.

In its MAYO vs. PROMETHEUS decision—confirmed by its e.g. AMP vs. MYRIAD GENETICS (see ^{4)g.}) and ULTRAMERCIAL vs. WILDTANGENT decisions—the USSC fundamentally expanded and explicated its “KSR thinking” by stating the absolute need of “at least one inventive concept”^{4)d.-g.,III.3.2} to be embodied by a patent-eligible invention, which is not a natural law concept, and asking whether “ . . . a claim adds enough <patent-eligible concepts> to its statement of this law of nature <concept> to allow the process it describes to qualify as patent-eligible process that applies a natural law”.

These wordings state/restate that the USSC insists in a more subtle identification than practiced hitherto not only of the quantity but also of the quality/kind of the inventive/creative concepts embodied by an invention/TT.0^{4)e.-g.}. This USSC wish (as to an invention's representation in terms of concepts, massively impacting 35 US §112, first of all^{9)5.,4)g.(2)-(5)}) implies

this invention's/TT.0's mental disaggregation into its independent^{D2/N2} “creative/inventive concepts” constituting it and
checking any one of them^{4)e.}—though it is mathematically provable to be embodied by this invention/TT.0—for its contribution to achieving this invention's/TT.0's nonobviousness, due to its being sufficiently creative/inventive (35 US §103), though, any such creative/inventive concept yet may prove non-patent-eligible due to pmgp (35 US §101)^{9)5.,4)e.-g.}.

This reasoning by the HIGHEST COURTS—as to the creativity embodied by an invention/TT.0 over its prior art RS exposing the “inventor's creativity” when developing it, i.e. the number of independent thoughts TT.0's inventor must have created for finding TT.0 starting the search for it from prior art RS—hints at the existence of a “law of innovation” being a new “law of nature”^{III.3.1}. It is immaterial, that their hints were not detailed, when issued as quoted exemplarily in (1) and (2): They nevertheless prove above any doubt that they believe that more rationality/dependability may be developed than currently practiced when checking an invention/TT.0 for its (non)obviousness by determining the number of creative/independent/inventive concepts embodied by it and using it as unquestionable resp. indicator. In the US this insight into the (non)obviousness problem is blurred by asking also for the kinds of identified creative/independent/inventive concepts, i.e. by attempting to simultaneously determine their (non)patent-eligibility, explained below^{4)f.}. In the EU the “technicity” limitation⁷⁾ for inventions avoids only becoming aware of such questions. Also, the meaning of the USSC's term “concept” caused much misunderstanding^{4)d.}. Indeed, its use of the IT meaning of this term requires some clarification, which is provided further down^{4)c.-g.,III.3.2}.

As to the above mentioned new “law of innovation” induced by the HIGHEST COURTS and defined here: It is an epistemological truth, just as any other established law of physics/chemistry/ . . . /medicine/economy/ . . . is an epistemological truth. Its existence in innovations is disclosed, up to Kant³⁾, by the mathematics it embodies, explained in detail below^{III.3.2}. Its peculiarity: Its verification needs no confirmation by physical experiments, as it namely enjoys the advantage to be modelable plainly by mathematics^{N5)iii)} based on its fully understood axioms^{4)b.,*)}. I.e.: The FSTP Model of Innovation enables rationally^{*))}/scientifically describing for any innovation its constituents under less assumptions than needed by classical laws of nature, as these always comprise physical statements and hence require also physical experiments for confirming them.

The method/system disclosed here for generating a PTR-DS^{I.,III.3.1,IV.,V.}, for a given PTR, is a specific and very implicit application of this new law of innovation—out of a whole series of potentially quite different other applications of it^{III.3.1}. Namely, this method/system uses this new law only via its use of a PTR-PS service (e.g. the service provided by the FSTP-Test¹⁾ for item wise generating the PTR's K(PTR)^{III.1}), which hence already is a specific application of this new law of innovation. It nowhere else uses this new law. In addition to this specific application of a PTR-PS service, generating a PTR-DS requires performing several application specific transformations of this K(PTR)'s representation^{III.3.1}, as IV. and V. disclose.

4)b. The Mathematical FSTP Model of Innovation—the Nexus between TT.0's Creativity, Prior Art, and Precedents. Practically, the FSTP Model of Innovation¹⁰⁾ is totally irrelevant. Its only purpose is to establish scientific rigor—by adding 2 purely mental axioms α) and β)^{4)a.} to the usual ZF axioms of mathematics^{*))}, thus achieving this rigor of mathematics. Thereby.
Axiom α) means: For a PTR, the elements X.i.n of its TT.i's are matters—their properties described by predicates X.i.n, 0≦i≦l, 1≦n≦N, referring to the PTR's concept values^{6)a.,III.3.2}—and the relations between them are defined by the ANC relations of their X.i.n, 1≦i≦l, to the peer X.0.n, 1≦n≦N. The kinds of contextual/intentionality limitations of these ANC relations (used by a PTR-PS for disaggregating, over PTR's prior art RS, these compound notions into independent elementary ones) are the same for all PTRs: the context/intentionality kinds “patent law carrying semantics, plcs” and “patent monopoly granting pragmatics, pmgp¹⁾”, the former dealing with (non)obviousness, the latter with (non)patent-eligibility.
Axiom β) means: Creating any one of the q new creative/inventive concepts, cr-C, of a q-AC/mod(q-CC), by TT.0's inventor requires he/she had created, first, the resp. q independent thoughts crating these cr-C. Any such cr-C namely represents a partial solution of the total solution provided by the invention/innovation/TT.0 for the problem set out to be solved by doc.0. Thereby, mathematically precisely: An AC is modified by a q-CC—being a sequence of q “1_concept_creations, 1-CC”s, q=0, 1, 2, . . . , each 1-CC creating at least 1 cr-C (by transforming at least one unfeasible concept from PTR's ps+pa, hence called dummy^{6),a.} an X.i.n of AC^{9)3.}, into a creative/inventive TT.0 concept)—such that AC/mod(q-CC) antsTT.0^{III.2,III.3.2}.

A patent law practitioner need not care for all that—he may use this new technique without caring its scientific foundation^{4)d.}. There are many examples of this amazing phenomenon our brains are capable of^{*))}. E.g., riding a bike. While it is really tedious to rationalize why it is possible—by explaining the role of the Coriolis forces therein when rolling straight ahead—we all are capable of doing it correctly subcortically (even without having an idea of what these forces are). Other examples are walking upright or driving a car at high speed. Yet another and very similar example of this phenomenon is the capability of an aircraft's pilot to perform an instrumental landing while heavy weather disables his natural orientation. The same applies to using a PTR-DS by an “FSTP certified” user, e.g. in an IES: After a short training on the IES, its correct use by him/her of a PTR-DS would work subcortically—without requiring from him/her to have an idea about the mathematically non-trivial foundations^{*)).,3).III.3.2} of the underlying advanced IT technologies. A well-known academic example of this phenomenon is many theoretical physicists' use of even mathematics by ignoring, where feasible to them, its founding rigor—which Hilbert put into his ironic but equally admiring statement that “physics is too hard for physicists”.

From developing fundamental sciences during the last 1½ centuries it is known to be worthwhile applying such mathematical rigor in developing the foundation of the FSTP Model of innovation¹⁰⁾. E.g., in the early development of elementary particle physics, initially the energy/Schrödinger operator was messed around with and caused confusion—as today happens with obviousness tests in patent precedents. Hilbert noticed that this confusion was caused by the then lack of conciseness of the definition of the scope of this operator, established the mathematical conciseness of the definition of its scope (“Hilbert space”) such that it admitted only reasonable “Eigen values” of atom models, and thus terminated that debacle. The FSTP Model shall likewise terminate the present debacle with obviousness and patent-eligibility indicating tests by a mathematically concise definition of its foundation and scope, such that it admits only reasonable “semantic/creative/plcs and pragmatic/pmgp height values” of a PTR problem and all of them—as asked for by HIGHEST COURTS (see (i) and (ii)).

A final remark as to commonalities between developmental innovation theories and the here presented mathematical innovation science: They are fundamentally different. E.g.: While FSTP Technology restricts itself to precisely “posc confirmed preconditions”^{III.3.1/2,5),6),7)}, based on which “micro technical”⁷⁾ innovation is at stake, developmental innovation theories analyze “macro economic” and hence only incompletely definable environments, also using somewhat different notions (e.g. “invention”, “prior art”). And: A technical^{7)a.} innovation is aggregated from a number (usually) <100 of independent thoughts alias inventive/creative concepts, while for these developmental innovations^{9)4.} it is not clear whether assuming discrete independent thoughts is meaningful, at all. But, the FSTP Model of Innovation might be put also beneath their insights by replacing its deterministic by probabilistic relations and threshold clusters—and identifying these, a priori.

4)c. National Frameworks for Patent/Claim Interpretation, i.e. for its Support by TT.0's Conceptual Disaggregation. Practically, FSTP Technology and its “concept disaggregation” is capable of cooperating with all of them. Scientifically these frameworks are still in a problematic state of development, as to the preciseness FSTP Technology is going for. The biggest one of their “common” issues is discussed next. Problems of patentability checks based on it are addressed below^{4)d.-g.}.

In patent/claim interpretation there is a broad known area of uncertainty, as to what of its invention/TT.0 actually is protected by a national patent law. Often this is not compulsorily derivable from its claim's wording and its disclosures in doc.0 to a level of preciseness making it immediately describable by predicates. Indeed, the current situation of patent/claim interpretation alias “claim construction”^{4)g.(e)}—in FSTP terms: the transformation of its technical fundamental informal into its formal such facts^{III.1}—is sometimes notionally confusing, not to say confused, often already nationally and the more internationally.

That this problematic situation with claim construction has piled up is visible from excellent textbooks covering that issue [“Cases and Materials on Patent Law”, Adelman/Rader/Thomas, WEST, 2009, Ch. 9], [“Patent Law and Policy: Cases and Materials”, Merges/Duffy, LexisNexis, 2007, Ch. 8A/B], [“The Modern Law of Patents”, Fysh/Roughton/Johnson/Cook, LexisNexis, 2010]. The following paragraphs just quote some practically important such differences in patent/claim interpretation on both sides of the Atlantic—in the US varying between examination and infringement. Though a PTR-PS may identify and take such differences into account by parameterization, their impacts strongly depend on a claims' wording^{4)g.(1)}.

(i) For claim construction, 35 USC §112 and US patent precedents allow its specification to impose a limitation^{9)5.} on the broadest possible meaning of its wording, i.e. on its terms' notions, if this wording refers to a construct and algorithm in the specification by a magic word, such as “by means”. Otherwise this claim's interpretation must ignore this limitation (unless the specification explicitly stresses this limitation is due to its patent's unusual specific terminology)—or not???^{4)g.(6)}.
(ii) The European way of claims construction avoids the means-plus-function legal instrument. Instead, the European Patent Convention (EPC) and the precedents of the BGH and EPO require determining its TT.0^{4)a.(1)} from the specification/figures and claims (as disclosed by TT.0's inventor in an enabling manner) to be a solution of the technical problem set out for resolution by the patent and then resolving notional ambiguities of its terms such that they don't contradict their meanings in the single^{5)a.} TT.0 (EPC Arts 36 & 69)—while such contradictions are admissible in US patents with contradicting claims.

These national frameworks are decisive in checking claims as to their (non-)obviousness/-patent-eligibility^{4)g.(1-8),9)5.}.

Further going, the EPO restricts a patent to have only a single independent method/apparatus claim, i.e. ignores inventors' needs in favor of patents' simplicity^{5)a.}. The US patent law knows no such rigorous restriction of patents massively limiting the inventors' creativities for achieving greater administrative simplicity—and also provides other great advantages to inventors, in particular by the new AIA (as elaborated on elsewhere). But the unfortunate (implicit and erroneous) assumption in US claims interpretation is that a claim's wording as such in natural language often is assumed as being self-explaining or else as using the legal “means-plus-function” instrument, enabling using functional limitations from this patent's specification if it there refers to a “MoT type” structure. But this approach implies a serious deficiency: It ignores

that it is known at the latest since the early days of building compilers that this self-explanation assumption is absurd (except for trivial “inventions/innovations/TT.0s”) and hence consulting the specification always is logically necessary, and
the much higher intellectual subtlety of inventions in all advanced technologies than in pre-IT times always implies that they are based on technical⁷⁾ yet non-tangible—purely mental—functional models, rendering such structures to obscurity.

Beyond such irritations, all national patent systems at least agree that patents are to be interpreted by the person of posc or at least pos^{4)a.(2)} (not a layman!). Though some courts may totally ignore this international consensus and occasionally interpret without any justification—technical terms on their own (sometimes¹⁾ implying technical and/or legal atrocities).

Finally: With all national frameworks for today's classical claim construction^{4)g.(4)}—even when performing the unavoidable^{7)c.} disaggregation into independent concepts—another problem is remaining, likely to become increasingly important as the sophistication of inventions/TT.0s increases^{4)g.(3)III.}. It occurred with at least one decision of the BGH. Here an invention/TT.0 had already been patented, when a special incarnation of exactly this TT.0 applied for a patent and was rejected as being obvious. If the FSTP Technology would have been applied at the time of inventing/drafting/examining/ granting^{4)f.} this patent would have shown that its TT.0 comprised said obvious special case, as e.g. the FSTP Test of this TT.0 would have identified all creative paths over TT.0's posc+palm^{III.3.2} to it. Hence it would not have been granted, unless the obvious special case were excluded.

4)d. Different Notions of Concepts and their Current Uses by Patent Authorities and Patent Practitioners. When it comes to running, for an invention/TT.0, its (non)eligibility resp. (non)obviousness check, the just outlined difficulties of using just the classical patent/claim interpretation are substantially increased, if it is not additionally precisely disaggregated into all its inventive concepts of the different kinds^{4)e.-g.} But, thereby the terms “inventive concept” and “independent thought” cause problems. The USSC's notion of “concept” is very close to the notion of “thought”^{4)b.}, but it makes sense to distinguish both by identifying them by different terms^{III.3.2,D1/D2,N1/2,10)}. For simplicity—and as the USSC used it—next only the notion of “concept” will be elaborated on, i.e. analogous considerations would apply when elaborating on the BGH notion of “thought”^{4)a.}.

Yet, also the term “concept” unfortunately invites misunderstandings, as may be seen from the brief descriptions of its many meanings (semantics and pragmatics) provided for it by wikipedia.com. And absolutely incredible: Even there this term's by far most important class of meanings for the pertinent scientific areas of IT (e.g. System Design, Semantic Research, Knowledge Engineering, DL^{*))}) is mentioned only in passing, as a kind of side issue—in spite of hundreds of IT text books and PhD works and thousands of professors using this class of notions since decades. I.e., there is the class of over

the millenniums grown broad meanings of the term concept, comprising a range of different flavors, all of them “macro issue oriented”, dealing with big issues such as “soul, god, love, truth, drama, faith, belief, a philosophy, a general principle” and
by IT induced specific meanings of the term concept. It, too, comprises a range of different flavors, but all of them are “micro issues oriented”, as required for enabling a precise description, in IT called “formal specification” alias “mathematical model”, of the functional and non-functional properties of any complex IT system, its modules and their interactions. The first such IT systems were large data base systems, where this notion of the term concept first was used in the early 70s for modeling them—then also starting from the above broad notion, but stepwise learning the lesson that it had to be refined to enable the needed kind of precise descriptions of properties—and then it migrated from there into other IT research areas, such as AI, semantic nets, KR, D^{*))}, for precisely specifying the incremental functional and non-functional properties (a latter one hardly representable as “step”!) of modules of their systems over other such modules, here called “inventive/creative concepts”.

While the use of the above specific IT notion of concept mostly comes along with awareness of the pitfalls of human thinking/speaking about complex systems—and how they are aggregated therein from other functionalities used by them²⁾—those who have not undergone the tedious learning process how deficient natural language often is, without exception use one or the other historic (i.e. vague) notion of concept, though silently assuming it were well-defined and understood by them.

The different notions of the term “concept”—crucial for the USSC's recent decisions^{4)a.,e.-g.}—caused irritations among patent authorities (USSC and CAFC, USPTO, CIPO) and other patent law professionals. The reason being the USSC's statement that, for an invention/TT.0 involving a natural law or an abstract idea to be patent-eligible, it should have enough patentable inventive concepts (BILSKI/MAYO, i.e. §101)—which in total got to be sufficiently creative up-front (KSR, i.e. §103)^{4)e.-g.}

Yet, such irritations are based on a fundamental misunderstanding: They always

use an above “macro-issue” notion of “concept”—as it is also used in the PCT and directives of WIPO/EPO/ . . . and the cryptical notion of “unity of invention” (the contrast of “unit of measurement of the creativity embodied by an invention”!)—and
ignore that the USSC uses an above “micro-issue” IT notion of “concept”, elaborated on below^{4)e.-g.,III.3.2.V}. Thereby the USSC pragmatically exceeds the IT class of meanings of this term by taking “1 inventive concept” as “unit of measurement of the creativity embodied by an invention”, just as the BGH^{4)a.-c.}. In IT the number of concepts seemingly never was used this way.

Currently many patent business practitioners (inventors, patent lawyers, patent examiners, IPR managers, judges, . . . ) must feel uncomfortable: They are not paid for, are not entitled to, and hence are not interested in caring for the reasons of such difficulties in patent jurisdiction, i.e. for the inconvenient insights into our all and also their deficiencies as long as only natural language is used, where precise analysis is required²⁾. The constitutional mission of any HIGHEST COURT is different. This is the reason why a latter not only strives for getting more rationality^{*))} into what it actually is doing, but also why it indeed is even responsible for identifying the direction, where this rationality is needed by patent jurisdiction and should be developed in technical⁷⁾ detail in the future—here: leveraging on the potentials of advanced IT (which didn't yet exist at the times of drafting early WIPO directives, agreeing on the PCT, founding the EPO, the USSC's GRAHAM decision, . . . ).

The FSTP Technology reflects these HIGHEST COURTS' prompts^{4)a.}. It provides an axiomatic definition of what the meaning is of a “creative/inventive concept” (representing an “independent)thought”)¹⁰⁾, as needed for putting facts determination in patent precedents/examinations onto a solid scientific basis^{4)g.}.

4)e. Disaggregating an Invention/TT.0 into its Independent Inventive Concepts of Different Kinds. The USSC's prompt as to the quantitative and qualitative disaggregation of an invention/TT.0 is a big step towards increasing the rationality^{*))} in patents' analysis, leveraging on knowledge representation research. It contends the §§101/102/103/112 and its precedents provide enough intelligence about the required legal making-up of an invention/TT.0 from inventive concepts of the different kinds, i.e. that an invention's/TT.0's indication as to its (non)obviousness and (non)patent-eligibility is doubtlessly derivable and presentable on this legal basis, thus achieving unquestionable objectivity as to patenting also in emerging business areas.

Yet, hitherto it was not clear, i) what this quantitative and qualitative disaggregation means in detail and ii) how to actually achieve it. This has changed: The below paragraphs i) and ii) are the two principle answers (their details explained later^{III.3.2}). All they say is—i.e. all the USSC asks for—is nothing else but more mental discipline when deriving these indicators for a claim, meaning that an initial clear and complete claim construction is indispensable as a dependable basis for an unquestionable determination of the various kinds of facts it embodies. I.e.: Its invention's/TT.0's disaggregation must

i) identify all “element-wise compound inventions”, which altogether compose this compound invention/TT.0—i.e. all elements and their “aggregate alias compound properties”^{III.1}—any aggregate/compound property being described alias modeled by an “element-wise aggregate/compound predicate” referring to values of casual concepts^{III.1,9)1.-3.}—and then
ii) refine any one of any element's such predicates into its resp. conjunction of BID-predicates—if it is not yet BID anyway—any “element” being a keyword of the claim's wording.

i) is just another wording for the classical claim construction, yet of increased precision as elements' properties are translated into natural language predicates. Complementing i) by ii) translates it into a refined claim construction—representing a disaggregation of the compound invention/TT.0—enabling identifying the KSR/BGH decisions' creative concepts^{4)a.}.

Any BID-concept/predicate^{9)1.-2.} indicates an item of inventivity/creativity as they all are confirmed “independent”^{D2-5/N2-5}. Beyond this legal quality, any BID-concept/predicate provides a further legal indication^{4)g.}, as they all are of one of two kinds: Either potentially excluded a priori by law/§101 from patent-eligibility or increasing the nonobviousness of the invention/innovation/TT.0. The former applies if the BID-concept at issue represents a natural law (MAYO) or an abstract idea (BILSKI); it then here is called “non-patent-eligible, npe”. The latter applies if it represents none of both—and then it is called “patent-eligible, pe”^{4)g}. Recognizing this additional legal quality is much simpler for a BID-concept than for an AD-concept^{7)b.,4)g.}.

4)f. Only Conceptual Disaggregation Enables Dependable Checks for (Non)Obviousness and (Non)Patent-Eligibility.

For a given PTR, ii) determines all its BID concepts, i.e. all inventive/creative concepts of its TT.0 over its prior art RS, without regarding their individual being pe/npe indicators^{4)e.}. All of them, as there is only a finite number of such BID concepts^{9)e.} (each to be disclosed by the finite doc.0)—defining the amount of TT.0's total inventivity/creativity. For this finite set of BID-concepts it then evidently is possible to check, which of them is put into jeopardy by its npe quality^{4)g.}.

Determining first all its npe concepts^{4)e.} is impossible, as this is an unlimited and hence infinite set.

Finally, determining both qualities of a concept in a single step—as tried by “classical” patent/claim interpretation alias claim construction^{4)g.}—is for many PTRs difficult or even impossible^{7)c.,4)e.-g.}.

The latter two alternatives disable responding to the USSC's prompt as expected by it—outlined above^{4)e.} in principle and explained below by examples^{4)g.}: Namely, to crack a PTR's knowledge for its TT.0's (non)obvious/(non)patent-eligibility checks by conceptual disaggregation of TT.0 over its prior art RS.

The i)-/ii)-claim interpretation/construction^{4)e.,g.} (by FSTP Technology) thus is the sole answer to this USSC prompt.

Intermediate summary^{4)a.-f.}: The USSC's prompt to crack K(PTR) by its conceptual disaggregation of TT.0—recently issued by its MAYO decision, but earlier already implied by its KSR and BILSKI decision, the first checking TT.0 for (non)obviousness the latter two for pe/npe—originally has been indicated by its KSR decision, where it requested for the first time that a TT.0's (non)obviousness test should check also, whether it would not be based on only an ordinary amount of skill and creativity (as owed by the person of pertinent ordinary skill and creativity, posc). I.e.: The USSC clearly stated that it considers a claim as indicated not patentable if it embodies, subject to its concepts based claim construction^{4)g.}, only a posc number of concepts being .) creative/inventive or :) not modeling an abstract idea or a natural law^{4)g.}. I.e.: The USSC thus reconciles 35 USC §§112, 102/3, 101, as discussed below^{4)g.,V.}.

4)g. Leveraging on Disaggregated Inventive Concepts in (Non)Obviousness & (Non)Patent-Eligibility Checks. The USSC originally encountered much reservations as to its (implicit) hints at IT concepts^{4)d.}, more specifically: at disaggregating compound IT concepts^{4)d.} into (independent^{4)e.}) inventive/creative concepts for checking an invention's/innovation's/ TT.0's (non)obviousness and (non)patent-eligibility^{4)e.}) Yet, IT concepts and disaggregating compound such concepts into independent ones is a technically very sound paradigm in many sciences and hence will prevail. And this (USSC induced) paradigm's application for performing said checks works just great—it takes US patent precedents to the next step of evolution.

This is exemplified below by means of 8 topical documents: the USPTO's MEMORANDUM “2012 Interim Procedure for Subject Matter Eligibility Analysis of Process Claims Involving Laws of Nature” (Jul. 3, 2012), and the 7 CAFC decisions “CLS BANK . . . vs. ALICE” (Jul. 9, 2012), “BANCORP . . . vs. SUN LIFE” (Jul. 26, 2012), “AMP vs. MYRIAD GENETICS” (Aug. 16, 2012), “RETRACTABLE TECH . . . vs. BECTON . . . ” (Oct. 31, 2011), “NOAH SYSTEMS vs. INTUIT” (Apr. 9, 2012), “ULTRAMERCIAL vs. WILDTANGENT” (Sep. 15, 2011), “PHILLIPS vs. AWH” (Jul. 12, 2005). Each of these 8 documents circles around this new paradigm—the necessity of compound concept disaggregation in testing patents/claims for compliance with the §§101, 102/103, and 112. They all practice it, increasingly, but don't yet clearly recognize and state it.

The point of departure for these explanations is that this new USSC induced paradigm enables resolving for a PTR the problem to determine for its invention/TT.0 the quantity and quality of its facts indicating its (non)patentability^{4)e.,f.}, due to its

i) (non)obviousness over its pa RS, based on the number of inventive/creative concepts^{4)a.,e.,f.} it embodies over RS, and its
ii) (non)patent-eligibility based on the number of such concepts representing abstract ideas or natural laws^{4)a.e.,f.}.

These explanations also address terminological/notional issues substantial for this new paradigm (and the above elaborations^{4)a.-f.} but not stressed or only explicitly mentioned in these documents—though being the reasons of their problems—and go directly into their presentations' crucial parts. After the above^{4)e.,f.} elaborations, proceeding this way is adequate.

Up-Front the Two Main Conclusions to be Drawn from what these 5 Documents are Unambiguously Telling:

I) The conclusion as to the momentary situation is: All 5 documents show vast notional uncertainties as to the question, what the KSR, BILSKI, and in particular the MAYO decisions mean in detail. I.e., the USPTO's MEMO indirectly and the 4 CAFC's decisions quite directly concede that they have questions about these new guidelines provided by the USSC.

Hitherto both institutions don't read these USSC decisions as its request to develop a higher level of understanding of the patent jurisdiction problems with the §§112, 103 (comprising 102), and 101—whereby it nowhere pretends to know more about this notionally higher level of understanding of these problems than just that it is needed. I.e., it feels responsible for demanding to achieve it in US patent precedents, just as it has been achieved in all areas of knowledge²⁾ it deals with. Thereby the unquestionable first step to developing it is an improved understanding, within the framework established by patent precedents since long time, of what exactly the additional facts would be this improved understanding may be based on, i.e. of their resp. indicativity when applying one of these 4 §§—and of how determining these very facts, first of all.

Instead, both institutions vastly over-interpret these USSC decisions: Namely, as allegedly already guiding to such a complete and ready-to-use higher level of understanding. Hence, they cannot apply it, as it exists therein only as the SC's fundamental insight that this better understanding of facts determination is an indispensable premiss for achieving consistent and stable patent precedents as to these 4 §§ (resp. prior to that: in the PTO's patent examination).

The above^{4)d.-f.} insights represent this improved understanding of facts determination as to an invention/TT.0 over prior art and pertinent ordinary skill and creativity. Consistency with IT (AI, NL, KR . . . ) and Mathematics/Logic/Epistemology^{*))} exclude an alternative to it within the established framework of patent law/precedents, i.e. rationality. Thereby, this improved facts determination puts no non-flawed patent into jeopardy though it may justify applying for a CIP for it, just in case.

II) The long-term conclusion is: All 5 documents indicate the need of improved claims' wordings, which reflect the subject matters of the inventions underlying them much more detailed and pinpointed at these 4 §§ than practiced hitherto. I.e., that any invention is modeled/described by the inventive/creative concepts embodied by it, in principle as above^{4)e.,f.}. The reason of this change of paradigm is that only such claim wordings will be considered by the USPTO/CAFC/USSC to provide the transparency necessary for a doubtless facts determination absolutely indispensable for assessing its invention's legal (non)obviousness and/or (non)patent-eligibility. Short-term reservations may arise, long-term the rationality will prevail.

(1) As to the USPTO's “MEMO”: It is a presentation of the impact of the MAYO decision on patent/claim examination by the USPTO in simple language, supported by several much telling examples. It thus is very helpful by conveying in practical terms, not just abstractly as above^{4)e.,f.}, the need for more concise claims wordings than they usually are hitherto, as demanded^{4)d.} by the MAYO decision. Yet, it only outlines what technically^{7)a.} makes-up this additional conciseness, which in principle has been required since ever, but of which nobody was aware prior to this decision. Accordingly, the paragraphs a)-c) deal with what the MEMO clearly states (thus implicitly confirming the above^{4)e.,f.} said about the MAYO decision), and d)-e) deal with what it does not explain in detail, in particular with shortcomings of its otherwise pinpointing examples—including stressing an important way to meeting this USSC request, which the MEMO only mentions in passing.

(a) The first sentence of the MEMO's Sect. III.A.—“Review the entire specification and claims to determine what . . . <is> . . . invented”—stresses that all disclosures of the patent application must be considered for understanding how the claim relates to and defines the invention. This fully confirms the above^{4)e.} disaggregation requirement induced by the USSC, precisely/mathematically^{*))2),III.3.2,Def3-5/Note3-5}. There is no logical alternative to this meeting the USSC requirement.
(b) In Sect. III.A., second paragraph, the first sentence starts with: “Claim analysis begins by identifying and evaluating each claim limitation . . . ”—i.e. with: Perform your claim construction as usual. This instruction means: Identify the keywords of the claim, declare them as its elements, and evaluate each of them as claim limitation, i.e. determine all its disclosed^{5)b.} relations to all other items disclosed by the patent, more precisely: determine all its disclosed properties. Yet, under the scrutiny of Sect's M.D./E. of the USPTO-MEMO, the precise meaning of this instruction is: “If you are through with the classical claim construction, start disaggregating the disclosed compound properties of the elements into their disclosed elementary properties”^{4)e.}. Disaggregating elements, standing for the claim's keywords, is impossible.
(c) The sentence of (b) continues with “ . . . and then considering the claim as a whole.”, which is re-emphasized by the MEMO's subsequent sentence. This instruction is crucial. Its meaning is not only “perform (b) correctly and completely, i.e. consider/determine all properties of all elements”—then it were just a reminder of (b)—but this also implies “thereafter there is no further conclusion that could be drawn as to the facts embodied by the claim's wording”. Alleging there are further such conclusions, i.e. resulting from “considering the claim as a whole” is outside of rationality (see also (e)); but it had to be used earlier for expressing that the elements and their properties must not be considered only in isolation.

The advantage of this simplicity of the USPTO-MEMO has its price:

(d) It seemingly ignores, at a first glance, the USSC's key statement that only a single inventive concept^{4)a.} of an invention outside of “abstract ideas” and “natural laws”, in particular one of only ordinary creativity (as put in KSR^{4)a.}), is not sufficient for its patentability. At a closer look it turns out that the MEMO does not intend to ignore the meaning of the USSC's term “concept”: It namely repeatedly instructs to search carefully for “steps” involved in the invention additional to the step of using a natural law (see Sect's III.D./E. and in particular the elaborations on practical examples in Sect's IV.A./B./E., commented on in (e)). I.e., the MEMO suggests searching in the unlimited area of such “additional steps” of whatsoever property, such properties from (b) being referred to by the USSC by the term/notion “concept”. Hence the MEMO just avoids using just the term “concept”, probably due to its currently being controversy prone^{4)d.}, not its notion.

Yet, for avoiding in the future the problems of the above line of USSC decisions—by identifying “inventive concepts” of the resp. invention to this end, as its MAYO decision explicitly demands—not at all mentioning this IT term^{4)d.} “concept” is not helpful: this unnecessarily puts into doubt the USSC suggested way of achieving transparency in a claim's wording for facilitating the determination of the facts needed by any check of its invention's (non)obviousness or (non)patent-eligibility.

(e) It seemingly narrows the MAYO decision's request—for more transparency in a claim's wording by identifying therein its invention's “inventive concepts”—to adding therein only more steps. I.e., if the MEMO had not dropped in Sect. IV.D. the term “feature”, it would have unnecessarily narrowed the meaning of this USSC's term “inventive concept” to represent only steps^{4)d.}. Indeed, none of the discussions in the MEMO of its practical examples mentions that the USSC's inventive concepts may also refer to non-functional elementary limitations imposed on a claim's wording, i.e. on the elements' properties, i.e. on its usual compound properties, as explained above^{4)d.}. Neither the MAYO decision's nor a usual IT's^{4)d.} use of the term “inventive concept”—e.g. in DL^{*))}—limits its meaning to functional issues only, rendering it problematic.

Without this limitation to additional steps in a claim's wording, i.e. allowing also additional features therein (modeled by inventive/creative concepts) renders the elaborations on the MEMO's final 2 pages incomplete: The novelty of anti-IgM antibody XYZ may comprise, besides its non-novel elementary functional property as medical drug i), the following additional 6 novel non-functional properties: Its making is ii) fully synthetic, takes only 10% of the hitherto needed resources of iii) production time, iv) water, v) energy, vi) pollution credit, and has vii) the permanent lifetime. I.e., the compound property of XYZ comprises 7 independent non-elementary properties being elementary concepts. Thus the amount of creativity XYZ embodies (over pertinent skill and prior art) is 6, as the inventive concept i) is neither novel nor patent eligible, but the other 6 inventive concepts model 6 novel creative elementary properties of XYZ—though, considered in isolation, none of them need to be novel but hitherto didn't exist in combination^{6)c.,7)b.} with concept i), and establishing this combination was not trivial, as its creation had been expensive. Hence, the creativity/inventivity embodied by TT.0 amounts to 6 showing what precisely the MEMO's phrase “ . . . claim as a whole.” in (c) says. I.e., it is not an obscure euphemism, it used to be.

In its very last paragraph the MEMO's assessment as to its claims 1 and 2 hence is correct only, if the patent applicant/owner presents its invention as described on the MEMO's page 11. I.e.: This assessment would potentially be wrong, if he/she had drafted this claim's wording by using the usual “by means” clause, and the specification actually provides the resp. construct disclosure(s) explaining the reasons for achieving the above 6 combinations or the specification actually explicitly stresses that these 6 inventive concepts were combined/aggregated into a compound inventive concept. Consequently holds: Whether an invention embodies an extraordinary amount of creativity not drawn into natural laws and/or abstract ideas is a question of “substantially representing”—i.e. not just “verbally drafting”—the patent (application) for it.

The summary of the USPTO-MEMO—more precisely: of its explanation of the technical^{7)a.} impact of the MAYO decision on the future claims wordings—thus is: For making this interim document perfect as a guideline for examiners^{4)h.}, it needs only the additional clarification (e), extending it by the USSC's notion of “inventive concept”^{4)d.}. What in detail clarification (e) should comprise becomes evident from^{V.} and the below comments on the CAFC's CLS & BANCORP decisions.

(2) As to the CAFC's “CLS case”: The CLS decision of the CAFC is much telling about the extent of uncertainty, even among best US judges, as to the challenge the USSC posed by its KSR/BILSKI/MAYO cases. The majority decision of this court of the CAFC seems in substance to be basically in line with these USSC decisions, though much of its discussion is at least blurring—except its clearer final part; yet even here its terms/notions are missing the USSC's point.

In total, the majority's opinion demonstrates that an attempt to squeeze the impacts of these USSC decisions into the hitherto only practiced framework of claim construction by means of solely the compound properties of the claim's elements—i.e. without additionally disaggregating the elements' compound properties into their inventive concepts, as now explicitly prompted by the MAYO decision (the earlier two USSC decisions prompting this only implicitly)—necessarily requires over-stretching established (as useful and formerly sufficient) arguments and their wordings, for making them cover prior to these USSC decisions not really resolved issues. The dissenting opinion expresses its dissatisfaction with this deficiency, but does not yet quite make it to the consequence of suggesting such a concept disaggregation^{4)e.}, nevertheless asks important questions the majority opinion evidently implies. By trying to answer them the majority opinion confirms its uncertainty about the challenge posed to the US patent system by the USSC, up to its constitutional responsibility to foster the innovativity of the US economy by providing to it the best possible patent system (see the above conclusion I)), i.e. by making it leverage on the significant progress achieved in advanced IT. The USSC hence demands a further going and consistent development of the US patent precedents to a higher level of quality^{4)e.} than the one established by the GRAHAM decision with its then new technical facts, meanwhile being insufficient^{2),4)g.I)} for safely further unfolding in the US its enormous economic forces of innovation by their support by patent precedents. In the CLS decision, this dialog between both opinions as to this objective got close in substance—inevitably being the above concept disaggregation^{4)e.} (see i)-ii) and the BANCORP decision below).

Thereby it is clear: Meeting this requirement posed by the USSC is impossible without support by specific patent law/precedents driven knowledge engineering^{*)),4)e.-f.,III.3.}. Patent jurisdiction and no court could have made it on its own.

After the discussion of the USPTO's MEMO in (1) the CLS decision is commented on in more brevity in A)-C) and i)-ii) —for showing how far the CAFC has advanced into this direction and for conveying clarifications of what actually is required (from this specific and pretty self-explanatory branch of knowledge engineering) for providing a dependable fundament to patent jurisdiction for checking the USSC's improved way an invention's/TT.0's patentability.

A)-C) first outline the background of the above mentioned notional shortcomings of the CLS decision:

A) Its most serious deficiency is to have not determined—prior to checking the invention's/TT.0's patent-eligibility—its creativity/inventivity as a whole by its total number of its elementary creative/inventive concepts of whatsoever kind^{4)e.-g.(1)}, i.e. not having obeyed the USSC's KSR suggestion as to identifying the invention's inventive concepts^{4)a.}, first of all.
B) Thus it gets lost in premature^{7)b.} attempts to clarify of compound concepts their “pragmatic” aspects—their being “abstract” or “drawn into natural law”, both being additional qualities to the indispensable quality of inventivity/creativity^{4)a.-f.}, the USSC identified in its BILSKI and MAYO decisions—and
C) stays unaware of the need of several “independent” inventive/creative concepts^{4)a.(1)7)c.} of an invention/TT.0 “as a whole” for enabling it to pass the legal checks by these 4 §§: Without the independency of its elementary creative concepts—and their completeness as to their description of the whole invention/TT.0—any such legal check is logically flawed^{III.3.2,7)c.}.

The items i)-ii) are short comments on notions and wordings from the CLS decision, in particular from its initial/final part, thus exemplarily showing that avoiding/applying the FSTP Technology's “concept disaggregation”—as induced by the USSC for presenting a patent/claim interpretation—implies questioning/meeting the USSC's above outlined requirements. I.e. these 2 items ignore the many other issues touched on by the majority and dissenting opinions, if needed clarified elsewhere.

i) The dissenting opinion correctly notices (p. 3, first two paragraph) that the USSC requires, for an invention's/TT.0's claim, an “inventive concept” for considering it patent-eligible under §101, and contends that the majority opinion “has failed to follow the Supreme Court's instructions—not just . . . ”. The majority tries to counter this criticism (p. 20, ftn. 2) by noticing “ . . . that is precisely what the majority has done in examining the language of the claims themselves . . . ” and recognizes “ . . . other elements or a combination of elements, <are> sometimes referred to as an ‘inventive concept’ . . . ”. While this notion of an ‘inventive concept’ of the majority is, in its ftn 2, quite close to the USSC's precise notion of it^{4)d.}, its main text (p. 21, 1.4-7) falls back to the totally vague, i.e. quite different, notion of the term “concept”^{4)d.}, when it talks about “ . . . a fundamental truth or disembodied concept, with no limitations . . . ” I.e.: The majority has not invalidated the content of the dissenting opinion—though it seemingly intended/tried to use the here to apply USSC's notion of concept (as ii) shows).
ii) The dissenting opinion further notices (p. 3, last paragraph) that the majority unduly over-stretches the compound concept “computer implementation” as inventive, if it just quotes it. The majority—in its defense against the dissenting view—notices (p. 26, second paragraph) that there are at least 7 potentially good reasons for considering this compound concept “computer implementation” as inventive. It thus concedes, implicitly but undeniably, that .) this concept actually is a compound one, and :) of these 7 elementary concepts several seemingly are inventive. I.e.: That dispute would have been avoided by disaggregating this compound concept, a priori (see also ii′) in the CAFC's BANCORP comment below).

I.e.: i)-ii) show the CLS decision is in substance consistent to the USSC's demands, notionally not really.

(3) As to the CAFC's “BANCORP case”: Similar to the CLS decision, the BANCORP decision may be viewed as being substantially in line with the demands implied by the USSC's KSR/BILSKI/MAYO decisions—but notionally it is as blurring as the CLS one. I.e.: While it seems to look for this consolidation, it not yet really provides a mind setting notional improvement as to the US patent precedents, which the USSC's KSR/BILSKI/MAYO line of decisions (including its recent vacation of the two below CAFC decisions) insinuates as necessary. It does not yet explicitly confirm the need of concept disaggregation or alike for facts determination in §101 cases—though implicitly it actually does recognize this need, too (as shown in II.)). Thus it provides another verification of the correctness of the above conclusions drawn from these USSC decisions' demands as to the facts determination problems coming along with the §§101, 102/103, and 112.

Hence, because of the consistency of all said, there is nothing principally new in the BANCORP decision and in the subsequent comment on it in I.), neither from the CAFC nor the FSTP Technology side. Yet, this decision performs an exciting “tour d'horizon” for demarcation of the problem at issue and increasing the understanding of it, i.e. as to the question of the roles of computer programs in US patents' inventions. Thus, commenting this decision, does not only serve the purpose to putting in I.) the precedingly said as to concept disaggregation in other words, once more, just for didactical reasons. This “tour d'horizon” provides, on the FSTP Technology side, further going clarifications of the question, whether and how far concept disaggregation is really helpful in dealing also with the pragmatic patenting issues encoded in the US by USC 35 §101 (pragmatics as encountered in any regional patent system, not considered here). This statement implies: Concept disaggregation—for facts determination such that it supports the application of §§102/103—is an indispensable epistemological/logical/mathematical requirement, in total an almost trivial as fundamental to rationality insight. Thereby holds also for this initial screening for and identification of all elementary creative/inventive concepts of an invention that subsequently evaluating them as to their patent-eligibility—based on what pragmatics so ever—no longer belongs to facts determination but to making legal decisions about them, up to these pragmatics. Drawing legal conclusions on top of such scientific facts determination of all these elementary inventive/creative concepts is today the area of primarily mathematical semantic research in AI, NL, KR/KE, DL, . . . —not of concept disaggregation, on which mathematical innovation theory (and FSTP Technology) is focused. Thereby both areas of mathematical information sciences are complementary:

Mathematical semantic research develops unquestionable scientific insights above the natural language level starting from the latter and aiming primarily at more and more powerful concepts, while
mathematical innovation theory—also starting from the natural language level—currently focuses primarily on developing unquestionable scientific insights diving below the natural language level (as indicated by the term/notion of compound concept disaggregation into elementary creative/inventive concepts) and so far has provided already an improved scientific understanding of this indispensable notion of concept (as used in IT^{4)d.}), and based on it fundamental results from KR^{III.3.2.}.

Subsequently I.)-III.) become more specific about the USSC's wish for clarified facts determination in the BANCORP/CLS decisions (and the implied CAFC's actual facts determination based on its use of concept disaggregation) as to applying §§112/102/103 and finally 101 in an invention's legal checks for its patent-eligibility^{4)f.}.

I.) Determining the inventive/creative facts in the BANCORP/CLS cases, i.e. determining at least the USSC's inventive/creative concepts such facts stand for, suffers from the same shortcomings outlined already in the remarks (2)A)-C) of the CLS comments. These deficiencies of classical facts determination, as still partially practiced in the BANCORP/CLS decisions, are briefly commented on in the following clauses A′)-E′), yet addressing some more details than in (2)A)-C):

A′) No determination up-front of all potentially creative/inventive concepts as required by applying §§102/103, instead
B′) useless (as a priori bound to fail^{7)b.}) attempts to determine of the actually identified sole compound concept—again the claimed invention's “computer implementation”—its patent-eligibility,
i.e. no breakthrough yet as to meeting the USSC's needs recognizable in the light of its KSR/BILSKI/MAYO decisions and resulting from elaborating on its hints^{4)a.} in a legally consistent way by using advanced IT^{4)e.-f.} (as outlined below), i.e. as to:
C′) disaggregating all compound concepts determined in A′) into elementary creative/inventive concepts (for §§102/103), of
D′) determining which of these elementary creative/inventive concepts are patent-eligible (for §§101/112), and of
E′) filtering out of the remaining elementary creative/inventive concepts a maximal set of independent ones^{III.3.2.}.

This more elaborate facts determination C′)-E′) than the one performed hitherto only has been defined by the USSC to be legally minimal. That an even more indicative facts analysis along this line is already available^{III.1.}, too, is skipped here.

The two below exemplary quotations i′) and ii′) from the BANCORP decision painstakingly show both: that it is consistent to the CLS decision as to the key issues at stake (addressed there already by i) and ii)), as well as that it nevertheless reflects already the CAFC's increased awareness of the USSC's above prompts as to both issues (elaborated on in II.)).

i′) The BANCORP's notion of ‘inventive concept’ finally turns into the specific one^{4)e.} of the USSC (p. 23, I.9: “ . . . what additional features <alias: concepts> remain in the claims.”, and p. 25, I.2: “ . . . to a very specific application of the [inventive] concept”), after the CAFC having started out from a quite different and much broader notion of the term “concept”^{4)d.} (p. 19, I.28: “ . . . a claim ‘covering’ an abstract concept, . . . ” and p. 20, I.9: “‘using a computer’ in an otherwise abstract concept . . . ”).
The first underlined quotation tells that the CAFC's initial meaning of the term concept is quite different from its USSC's meaning, according to which a claim is made-up from inventive concepts^{4)a.} (just as a fence is made-up from its parts, p. 23, I.9 and p. 25, I.2). This implies: The CAFC's initial statement that “ . . . a claim is covering an abstract concept” here still excludes its notion of concept is the one of the USSC, otherwise it had asserted “ . . . a fence is covering its parts”.
And the latter underlined quotation shows that this CAFC's initial meaning of the term “concept” is not only different, but also much broader: It namely allows using a computer within it. But this is an idea totally irreconcilable with the USSC's notion of “inventive concept” as defined in its MAYO decision^{4)a.}: to be a feature of a claim (just conceded by the CAFC, see above), i.e. to be a time- and area-less limitation^{III.3.2} but not a time-consuming action or a spatial body based one.
   ii′) The BANCORP decision also concedes, again implicitly only but yet undeniably, that .) the concept of its claimed invention of i′)—i.e. its “computer implementation”—actually is a compound concept (p. 19, I.27-29: “ . . . simply adding a ‘computer aided’ limitation . . . , without more, . . . ” and p. 23, I.12-19: “ . . . <quoting 9 features therein as potential creative/inventive elementary concepts> . . . ”), of which :) pragmatically none <of these 9 elementary concepts actually identified by concept disaggregation> is inventive/creative^{4)(e.-f.}. This important insight achieved by the CAFC is elaborated on in II.).

II.) Increased recognition, by the CAFC, of the need of concept disaggregation—as suggested by the USSC—is implicitly conceded in its BANCORP decision by reiterating the claim's sole compound concept, “computer implementation” (see i′) and ii′)) . These reiterations clearly indicate the CAFC's unease about using this concept “as it is”^{7)c.} in determining the facts for legally checking this claim resp. the invention it claims for patentability under §§102/103 and 101/112.

Consequentially, the CAFC there proceeds (almost) as required by facts determination by means of concept disaggregation, though not becoming aware of it, and hence not calling it so. E.g., in the BANCORP decision the CAFC

emphasizes (p. 11, I.24-29) that, as a rule, a §§112 and 102/103 check should be performed prior to a §101 check^{9)5.},
decomposes (p. 23, I.12-19) the sole above concept into 9 potentially creative/inventive elementary concepts, and even
notices any one potentially being an unusual combination of pertinent skill concepts^{5)d.,6)c.}, i.e. a creative/inventive concept.

The BANCORP decision thus may be seen as having made half the way to meeting the USSC's requirements^{9)5.4)a.}.

As to scientific facts determination & evaluation: The above^{4)a.-g.} has outlined, where currently the demarcation line between the “known” and the “unknown” is to be drawn—also for pertinent cutting edge IT research, not just for patent law/precedents practitioners—as to the creation of an innovation/invention/TT.0 and evaluating it, i.e. between eternal rationality^{*)),3)} (called: plcs^{III.1}) and varying social/political pragmatics (pmgp^{III.1}) always being indispensable and eventually decisive^{9)5.}.

III.) An afterthought to the BANCORP and CLS decisions as to the reach of concept disaggregation. As insinuated by the BGH's GEGENSTANDSTRÄGER and the USSC's KSR decisions (and seen from the point of view of Knowledge Representation^{III.3.2}) for a claim and its invention over posc+pa, any determination of THEIR creative/inventive facts—embodied by the invention and being the subject matter of the claim, both needed in any application of the resp. legal framework (in 35 USC §§112 and 102/103)—must be based on independent concepts disaggregation of their compound concepts^{4)e.}. As further insinuated by the USSC's BILSKI and MAYO decisions (and equally seen from the point of view of KR), the so identified creative/inventive facts should also be the basis for legally checking^{4)f.} both under §101. Then any 101 analysis got to be based on a preceding 102/103 analysis, which in turn got to be based on a preceding 112 analysis. I.e.: From the fact that these 3/4 §§ serve for 3/4 independent purposes it is logically incorrect to follow that their 3/4 checks, for a PTR, may be performed independently—this is a popular logical failure, the commitment of which leads into the nowhere and all kinds of inconsistencies (just as an empty set's elements have all properties one can think of at any point in time).

Once a clear understanding of the notion “concept”—as explicitly used in the MAYO decision (and absolutely unavoidable in most advanced IT as a first step to becoming precise therein²⁾)—is achieved^{4)d.,III.3.2}, one recognizes that the just said^{4)e.} represents never doubted fundamental principles in all regional patent systems. It yet is often ignored by their courts/authorities decisions. Not because obeying it were too tedious (what it actually mostly need not be), but because it is not understood by them how dependable facts determination could be achieved by means of this concept-oriented view or that it is achievable at all. Alone this understanding is already a higher level of evolution of patent precedents—not yet comprising the even much further reaching scientific KR insights as to legal facts determination, which are presented below^{III.3.}.

Summarizing part of this just said i.o.w.: This determination of creative/inventive concepts based on logic (i.e. plcs^{III.1.}, potentially of different legal flavor^{III.2.}) and independent concept disaggregation^{III.3.} is scientifically indispensable for any problem analysis, i.e. for any purpose it is performed for. It hence enables not only determining an invention's creative/inventive alias semantic height over posc+pa, Q^{plcs}, for §§102/103 checks, but also its pragmatic height, Q^{pmgp}, for its §101 check on top of the former one. This should not be misunderstood, once more, as predicting a court's legal §§101/102/103 decision —or even §112 decision as to its claim's wording. Yet, independent concept disaggregation enables for an invention at issue an unquestionable determination of all the facts on which the USPTO and a court should base all its legal decisions.

(4) As to the CAFC's “AMP case”: All comments on the CAFC's above CLS and BANCORP decisions also hold for its most recent AMP decision. The latter's three partially diverging opinions not only (again) provide an excellent overview about the pertinent patent precedents as to checking a modern invention under §101, here a “gene invention”. But, their elaborations also confirm the above identified uncertainties and clarification process as to what the options are for identifying its patent-eligibility indicating facts in this particular subject area. Thereby holds: While any human genome patenting issue immediately raises fundamental political/constitutional questions, the same applies—only less evidently—for probably all currently emerging areas of technology/economy/society, such as nano technology, energy technology, green technology, health technology, . . . . Their innovations and beneficial potentials, on the one side, need the protection by patent law for getting an economic chance to become broadly unfolded, but on the other side, they also are getting more and more “touchy” in the eyes of growing parts of the society, as they potentially become more and more threatening to corrupt today's whole world much further going than it evidently happens anyway and this in an irreversible manner, thereby even excluding counterattacks on them by patent law. Thus, §101—it has been right from its beginning a problematic law as comprising more or less sophisticated questions already then—is currently rapidly becoming of much more fundamental importance than it used to have hitherto. But enabling it to more scrutiny/dependability/rationality as to separating the wanted from the non-wanted inventions, the facts determination about them must be significantly improved, as requested by the USSC. At a closer look on sees: this requires reconsidering meticulously also §§112 and 102/103—in the light of this undeniable development.

Hence the eventual outcome of the USSC's endeavor as to this issue is predictable^{4)g.(5)}: The USSC's line of KSR/BILSKI/MAYO decisions will sooner or later prove to have been the booster enabling the CAFC to develop a so founded US patent precedents fit for these mega trends of the leading contemporary societies. This inevitably implies getting it on the above already outlined level of scientific systematization^{4)e.-f.}, and correspondingly the wordings of patents' claims to an according level of more transparency and hence more thorough clarification of the relation of its invention to the so further developed precedents—the latter clearly preserving its today's absolutely correct fundamental structure.

As implicitly indicated by the USSC's above line of decisions, it would continue to insist to a degree higher than practiced hitherto in separating, in a patent (application), between its creative/inventive concepts doubtlessly patent-eligible and those potentially patent-eligible. Advanced IT dealing with similar issues (System Design, . . . ), too, teaches that “separation of concerns” is achievable in a clear and systematic way only by modeling them mathematically by their resp. concepts^{4)e.-f.}.

Trusting in the fundamental principle the US citizens are famous for worldwide, to take upcoming difficulties as challenges to leverage on them, the below view at the CAFC's AMP decision, considered as an indication of both, tries to make aware that their incremental conciliation has begun already—between, on the one side, the CAFC's primarily being status quo driven, and on the other side, the USSC's primarily being mega trends driven, both institutions obeying their different responsibilities as to the US constitution. I.e., the below single short quotation from the AMP opinion suffices for showing this (implicit) evolvement of the US patent precedents—taking place via additional clarifications implying unaware underlying concepts.

Page 45, sentence 1: “‘Isolated DNA’ . . . is a ‘free-standing’ ‘portion of a larger’ ‘natural DNA molecule’”. This sentence determines that this invention does not only deal with an aggregated concept ‘natural DNA molecule’—and the remainder of this paragraph reemphasizes this. Instead, for properly understanding the subject matter of the invention, this sentence clearly performs the disaggregation of this compound concept into the 3 binary independent disclosed creative/inventive (BID) concepts ‘Isolated DNA’, ‘free-standing’, and ‘portion of a larger’, a conjunctive combination of which is part of this compound concept. The wordings of the claims 1, 2, 5 (p. 8-11) disclose that it is made up from an even larger number of creative/inventive concepts, e.g. a particular ‘coding for a BRCA1 polypeptide’, a particular ‘nucleotide sequence’, a ‘length of at least 15 nucleotides’. But, only 1 is a BID concept, already, and their claim allocation is not legal transparency minded.

This is a striking proof of the indispensability to perform, in claim wording, a BID disaggregation of any compound concept used—only partially performed by the MYRIAD claims. The so achieved advantage is that, by so separating the potentially non-patent-eligible inventive/creative concepts one can identify/count the patent-eligible inventive/creative BID-concepts. Their number tells a court, whether “ . . . a claim adds enough <patent-eligible concepts^{4)d.}> to its statement of this law of nature <concept> to allow the process it describes to qualify as patent-eligible process that applies a natural laW”, MAYO^{4)a.(2)}. Any MYRIAD claim could add a whole series of pe^{4)e.} inventive concepts to its potentially npe^{4)e.} ones.

In total, this USSC triggered progress of the US patent precedents assesses its direction pointing capability to stimulate and protect all kinds of future useful innovations, not only in and for the US society but also most other national societies.

Further going legal elaborations on this facts determination method—based on concept disaggregation—by means of the CLS, BANCORP, and AMP decisions only is impossible, as they focus solely on §§101, 102/103. To this end this method's application must be shown in a §112 case, what happens next by the CAFC's RETRACTABLE TECHS vs. BECTON decision. Fortunately, this exercise proves that there are no additional legal transparency requirements to be met by patents, in the future—in the light of the USSC's KSR/BILSKI/MAYO decisions—but just that applying it is indispensable.

Section V. provides a blueprint of such a legally transparent structure of a patent's specification/claims wording.

(5) As to the CAFC's “RETRACTABLE TECH case” (Oct. 31, 2011): It is not really surprising that finally, by this decision, also §112 comes under scrutiny. After all, the §112 application to a patent/claim is responsible for what is discussed subsequently in its §§102/103 and 101 tests. It was clear that §112 is a problematic law at the latest since the CAFC's PHILIPS vs. AWH decision. The winding through practiced there as to the §112 interpretation has finally come to an end: By now it is clear that this broad §112 interpretation provides no basis for founding on it a uniform framework for consistently applying §103 (as culminated in KSR) and §101 (as culminated in BILSKI/MAYO, tomorrow e.g. AMP)^{4)a.,}: This §112 interpretation inevitably produces massively contradictory patent precedents, i.e. intolerable legal uncertainty/unpredictability.

The preceding discussions of applying §§103 and 101 by the CAFC, i.e. having explained the IT/KR problems underlying §§103/101 checks^{4)a.-f.}, show the lack of rigor of the PHILIPS decision⁽⁸⁾—and more recently of the CAFC's “R-TECH” decision(s). It was due to the trust in the use of compound concepts when trying to logically argue based on classical claim interpretation/construction, prevailing until today, as to §112. This trust often is unjustified, as such carelessly admitted/used aggregated concepts therein frequently pose confusing questions. I.e.: Due to the blurring substance of compound concepts^{7)c.}—such as the “isolated gene” concept in the AMP case or the “correlation” concept in the MAYO case—they often support in an undissolvable way arguments e.g. in favor of the invention's/claim's patent-eligibility as well as against its patent-eligibility. These undissolvably contradictory properties of a compound concept used by a patent's claim wording are inevitable consequences of the fact that it is aggregated from “more elementary” concepts^{9)1.-2.}, of which some are patent-eligible while others are not. The only way out therefore is to disaggregate such compound concepts into their constituents, which clearly belong to one category or the other. This is achieved by disaggregating them into their BID-concepts^{III.3.2D.3}.

Disaggregating such a problematic compound concept also helps to clarify, to what extent patent-eligible concepts are “integral” to the claimed invention or just immaterial/artificial padding for it (see e.g. MAYO, p. 10, quoting BILSKI: “ . . . adding insignificant post-solution activity”). I.o.w.: Concept disaggregation often helps to recognize, whether a claimed patent-eligible feature of an allegedly patent-eligible invention/claim is actually material for the latter, as disaggregating a concept at issue enforces a priori using a finer grain of notional resolution. I.e., concept disaggregation improves the ability to recognize the existence of tight interrelations between the so isolated BID-concepts (within a compound concept), just as a magnifier or a microscope improves the ability to recognize the (non)existence of further limitations between the elementary parts it is focused on, i.e. further (non)limitations on their relations. While in the world of classical technologies the latter phenomenon is evident—that a claim's compound limitation is composed of several component (non)limitations, each being substantial for the invention although trivially not all of them are repeated by the claim's wording—in the world of emerging technologies this phenomenon so far has not been generally accepted. Here, component (non)limitations of a claim wording's compound limitation, omitted therein as being trivial for the person of posc, are often considered as non existent. In the CAFC's R-TECH case(s) opinions now again criticize this “double standards” phenomenon explicitly—though avoiding this provocative term—as outlined next (implicitly such critics has been present in all 4 above discussed cases already).

There is a very critical statement (as to ignoring component (non)limitations of a compound limitation of a claim's wording) already in the CAFC's first round of this case, its decision of Jul. 8, 2011, which is continued i.o.w. in its second round, its decision of Oct. 31, 2011: In the dissenting opinion's opening as well as its closing statement it clearly says that the meaning of a claim's term (here: of the term “body”) ought not be altered (here: limited) if not “context required”, i.e. if this is not required by the patent specification—as from a KR point of view only possible. It thus demands the same clear patent/claim alias §112 interpretation rule as the EPC one^{4)c.ii)} (excluding a contradiction between both interpretations).

Just as in the above CLS/BANCORP/AMP cases, the controversy as to the '224 and '077 patents also here arose from a compound concept—here: “body”—used by their independent claims' wordings. And again the dissent clearly recognizes this concept to be a compound one, potentially aggregated from a set of at least 6 binary independent concepts, quoted by the dissenting opinion to the above July decision, on page 3, bottom paragraph (the patents' specifications disclose even further binary independent concepts for potential aggregation by this compound concept). The dissenting opinion to the above October decision of the CAFC goes on with reiterating on the role of the specification in constructing the claims, confirms the just mentioned controversy as to the meaning of the term “body” and adds that a similar controversy exists with the compound concept “baffles”, as its BID-concept “achieves deflection” alias “being angled” is completely ignored and hence not imported into the claim. I.e.: While both dissents perform disaggregation of these compound concepts, they both refrain from declaring this disaggregation to be an indispensable activity for providing a firm fundament to claim construction up to §112.

Wrap-up of these §112 directed elaborations: Independently of any reasoning along HIGHEST COURTS' patent precedents, as practiced above (and far from the political issue whether the CAFC should give deference to district court decisions as to claim construction), there are mathematically/IT verified bedrock principles for trustworthy reasoning resp. system design—currently totally ignored by all precedents as to claim construction, i.e. §112. These principles are:

Aggregating independent into compound concepts may make them error-prone in a multiple way, e.g. make them dependent or preemptive^{9)5.}.
Statements about error-prone (e.g. dependent or preemptive^{9)5.}) concepts—as in today's claim construction, no matter how thoughtful—may be poisoned, i.e. misinterpretable/imprecise/contradictory/counter-logical—as exemplarily outlined above.

I.e.: There is not a faintest chance for patent precedents to become consistent, i.e. to avoid such misinterpretable/imprecise/contradictorv/counter-loqical/over-sophisticated statements alias decisions—and to avoid the current such courts' decision making—as long as jurisdiction tolerates §112 interpretations, and hence claim constructions, based on legally ERROR_PRONE concepts^{4)e.-f.,III.3.2,6)-7),9)5.}. And this holds also for §§102/103 and 101 interpretations. I.e.: For achieving consistent and hence predictable patent precedents based on these 4 §§, courts have no other option but to restrict the claims' wordings to use solely legally non-error-prone concepts^{9)5.}. This implies up-front disaggregating compound concepts into “clean” ones accordingly. Even then it will be difficult enough to establish in an NPS, by the resp. HIGHEST COURTS, consistent and predictable decision making—but then it is possible, at least.

(6) As to the CAFC's “NOAH case” (Apr. 9, 2012): This case provides an excellent demonstration of the necessity of the “compound concepts disaggregation (CCD)” technique in testing a claim's “§112 definitiveness”—as otherwise claim construction may easily contradict the specification. Its opinion namely convincingly presents both, the

(i) CAFC's successful initial application of this CCD technique to the compound de-concept^{III.3.2,(5)} “providing access to said file . . . so that . . . can perform . . . ” in the claim's wording of the means-plus-function clause—but not fully exploring the clarity thus created, i.e. instead of holding on to it during claim construction, forgetting it again half-way and falling back to using this compound de-concept again, which leads to the below false “disclosure fact” statement^{III.3.2,(8),9)5.}—and the
(ii) claim's “§112 intransparent” wording, which induces stating this false disclosure fact, as it—by using this error-prone compound de-C alias function⁽⁸⁾—fails to clearly hint at the cr-Cs actually embodied by the claim/invention, although the inventor duly discloses these cr-Cs alias functions in detail in the specification (but again: legally not at the point as to §112 testing, and hence ignored not only by the opinion in Section B., but seemingly even by the defender of the patent).

As to (i): The CAFC here strives for applying the CCD suggestion of the USSC's MAYO decision as to a claim's §101 test, also to the §112 test of the NOAH claim. In the opinion's DISCUSSION, the CAFC hence consequentially states the first “disclosure fact”⁽⁸⁾ that “This case involves a means-plus-function limitation with two distinct functional components. The ‘access means’ performs the function of .) providing access to the file . . . :) so that . . . can perform . . . . Thus, there are really TWO functions recited, namely: (1) providing access to the file; AND (2) . . . enabling the performance of delineated operations. Any algorithm must, therefore, address both [independent yet conjunctive] aspects of this functional language.” (page 19, last paragraph until top of page 20; .), :), [ . . . ] and emphasis added).

From this correct compound-de-concept/function interpretation, the CAFC correctly derives a second disclosure fact, saying that .) alias (1) is disclosed (thus fixing the District Court's false disclosure fact statement as to .) alias (1) “ . . . that the specification disclosed no algorithm describing how the disclosed function is to be carried out.”, page 19, middle paragraph).

Putting both statements in the more concise CCD terminology, the CAFC issued two correct disclosure facts: that the

claim's above compound de-concept comprises two independent de-Cs—here called “access” de-C and “enable-performance-of-activities” de-C (both names presenting the de-concepts' meta-semantics^{III.3.2D2-D4/N2-N4,V.,9)5.}, their precise semantics definitions being based on the enabling disclosures of their resp. cr-Cs in the specification)—and the
access de-C is disclosed in the specification—legally evaluated, too, this disclosure-fact as passing the §112 test.

The CAFC then turns to the enable-performance-of-activities de-concept and states the false disclosure fact that the specification does not disclose this de-concept. In the less concise “de/cr-C free” language of the opinion, this de-factual error is put as “ . . . we conclude that the specification . . . does not disclose an algorithm for the ‘enabling the performance’ function . . . ” (page 26, middle paragraph). The contrary is true. FIGS. 1-4 clearly show that the above CAFC identified “algorithm for the ‘enabling the performance’ function” is disclosed by all their boxes below the boxes 32 resp. 110 and their descriptions in the specification. No algorithm for an enabled function needs to be disclosed, as none of them is being patented. I.e., this summary of section B. is a wrong disclosure-fact statement (contradicting the two above correct disclosure-fact statements of A.).

Note: Once this false disclosure-fact statement is recognized, much in A. and B. and all of C. of the pages 18-28 of the opinion is obsolete, if the disclosure of this second de-concept's alias function's algorithm passes the §112 test. This is to be determined by a court, not by FSTP technique resp. its CCD technique, but here evidently is extremely likely.

As to (ii): As just explained, the algorithm of the enable-performance-of-activities function/de-concept^{9)5.}—of the CAFC's above compound de-concept disaggregation, in Section A. of its opinion—is in detail disclosed by the above identified boxes of FIGS. 1-4 of the specification and their descriptions therein: This function/de-concept “accounting and/or funds transfer activities performing enablement”, as certain situations arise, is meticulously described in the specification—as to each such operation controlled by the invention, whatsoever it is (being limited only by the requirement to be commonly known by the parties brought together by the invention's application in a transaction, as put by the beginning of the specification).

Yet, the compound de-concept in the means-for clause of the claim made Section B. assume, the term “enables performing an activity” could mean “enables achieving the semantics of this activity's accounting and/or funds transfer”—from which it derived, the specification had to disclose the activity's semantics. That this is false is shown above. And the statements i)-iv) that i) the specification “ . . . discloses nothing about how the system is programmed to enable the ‘entering, deleting, reviewing, adjusting and processing [of] the data inputs” (middle of page 21 of opinion), ii) “FIG. 3's flow chart cannot, therefore, provide the algorithm for the ‘enabling the performance’ function” (p. 23, bottom), iii) “ . . . nothing in the specification explains how the central or host computer is to be programmed to allow processing of the data.” (page 24, end of 2. paragraph), iv) the above quoted summary of section B. (from page 26), all confirm the opinion's illegally inadmissible limitations adding interpretation of the term “enables performing activities”—caused by its fallback to using the compound de-C.

This claim misinterpretation were avoided, had the opinion strictly kept up to its initial compound de-C/function disaggregation—it then would have noticed that its second function thereof alias its second elementary de-C is only the enable-performance-of-activities function, independent^{III.3.2,D2/N2} of the first function alias elementary de-C—or better: if a “means-for-accessing” and a “means-for-enabling” clause had a priori replaced the claim's “means-for-compound-function” clause.

(7) As to the CAFC's “ULTRAMERCIAL case” (Sep. 15, 2011): At the first glance at this CAFC §101 decision about the subject matter of Ultramercial's patent, its vacation by the USSC and remanding its reconsideration by the CAFC in the light of the MAYO §101 decision may be astonishing: Indeed, the subject matters of both decisions are disjoint. Though, they both raise the same absolutely fundamental questions, the MAYO decision explicitly^{4)a.(2)}, the ULTRAMERCIAL one implicitly (page 14, last 4 lines of text), namely: “How much creativity/inventivity got to be embodied by an invention for making it patent-eligible, and how would this amount of creativity/inventivity be measured/stated?”^{4)a.}.

The USSC's quest—as shown by its line of patent decisions since KSR and commented on by this footnote⁴⁾—is to increase the predictability of the US patent jurisdiction by achieving a binding answer to these most fundamental questions, a quest shared by the CAFC. The simplicity of this case facilitates clarifying much at these questions, as shown next.

A novel and nonobvious and definite claim/invention/PTR^{9)5.}, i.e. passing the §§102/103/112 tests, nevertheless may suffer from a lack of creativity/inventivity to a degree making it patent-eligible⁽⁸⁾. Common sense defines this to be the case, if —after disaggregation of all its inventive/creative steps alias cr-Cs and de-Cs^{9)1.} comprised by the claim in its “broadest” interpretation^{III.2} (being the set of all {de/cr-Cs}^{III.3.2D2/N2}, each making up the invention) into elementary de/cr-Cs of some KR—all cr-Cs were anticipated^{III.2} at the invention's priority date (comprising a claim compliant execution sequence of these cr-Cs).

In mathematical terms/notions such claimed inventions are called “potentially idempotent” as the creativity/inventivity of all their elementary cr-Cs may be zero, depending on prior art documents. I.e., their elementary cr-Cs are “plcs-potent”—as increasing the invention's plcs-height over prior art—only if some known prior art document is not considered^{III.2,5)c.,6)c.,7)}.

I.o.w.: A novel and definitive invention/claim may be nonobvious, as no set of 2 (maximally 2^{III.2}) prior art documents is known, an AC^{III.2} of which anticipates the claimed invention. Nevertheless, it may have the potentially idempotent property, being a matter of (plcs) fact, and hence be indicated as potentially patent-eligible⁽⁸⁾—to be decided by a court. To this end, the court would take into account “creativity/inventivity prone” combinations of plcs-idempotent cr-Cs, e.g., if there is a set of only 4 prior art documents of which an AC anticipates the claimed invention's cr-Cs, or if there is an execution sequence being not claim compliant in only 1 step, or . . . . I.e., there is a multitude of alternatives to be considered by a court, in particular if one inventive/creative step alias de/cr-C is patent-eligible due to one of the 3 USSC/CAFC established categories of such subject matters (“law of nature”, “natural phenomenon”, “abstract idea”), e.g. in the USSC's BILSKI and MAYO decisions.

Qualifying a claimed invention as potentially idempotent means stating a technical⁷⁾ fact and—at the best—indicating its legal evaluation by a court. I.e., this qualification is not a legal statement yet. This had to be issued by a court.

Potentially idempotent inventions exist, which do deserve protection by patent law, e.g. if this is justified by secondary considerations or if the resp. number of creative/inventive steps is so large or their combination so unusual that this fact of nonobviousness indication trumps this fact of potential idempotence—this being a legal evaluation of technical⁷⁾ facts.

This “potential idempotence” patent-eligibility exemption closes a terminological/notional gap existing in patent jurisdiction, worldwide. It could be seen as a fourth interpretation limitation of §101—in addition to the three by the USSC by today established ones—or as an interpretation limitation of §103, or eventually justify a further section in §103. Epistemologically, this potentially idempotent patent-eligibility exemption belongs to pmgp^{III.1}, i.e. to §101, and not to plcs^{III.1}, as it builds on the latter¹⁾, i.e. is a pragmatics evaluation of a syntactically/semantically (hence plainly mathematically derivable^{*))3)}) result. But the systematic of 35 USC forces the potentially idempotent patentability exemption into §103 as it does not represent another whole category of subject matter to be exempted from patent-eligibility (seen in the light of the §101 test) but it represents just another one of “ . . . the conditions and requirements of this title” qualified by §101 as not belonging to its scope, and which actually may occur resp. arise in claimed inventions of any category of subject matter (including the established exempted categories, where it would just add another aspect of non-patentability, as occurred already in BILSKI and MAYO).

The CAFC is the only US authority to set this new (qualitative/quantitative) measure of patent-eligibility indication—below the law-makers and the USSC. Thus, the USSC's remand to the CAFC, of the ULTRAMERCIAL decision for reconsideration by it—in the light of the MAYO decision—is the USSC's consequential step of inviting the CAFC to compiling its answer to the above fundamental questions such that it complies with the MAYO decision. Thereby the USSC also already outlined what this compliance implies^{4)a.(2)}. Namely that the CAFC, for maintaining its current decision about the claimed invention of the Ultramercial patent, would have to identify therein “at least one inventive concept” embodied by the invention, such that this set indicates enough inventivity/creativity “ . . . to allow the process it describes to qualify as patent-eligible process” (MAYO^{4)a.(2)}), i.e. would have to identify the extraordinarity of Ultramercial's {cr-C}. Note that Ultramercial's claimed invention does not comprise a concept belonging to one of the 3 established categories of patent-eligible subject matters.

The CAFC's reworking of its ULTRAMERCIAL decision therefore might be straightforward, as this aspect—that a new §103 aspect may have an impact on a claimed invention's patentability as its §101 test—has been implicitly excluded from its opinion (as expressed by its final sentence), and as it applied only the established §101 test in this case. That is exactly, what the USSC wants to be reconsidered: Whether this potential idempotent claimed patent yet is patent-eligible⁽⁸).

The USSC evidently noticed that the ULTRAMERCIAL and other nonobvious inventions are likely to prove potentially idempotent, as a matter of fact—and hence wants this technical⁷⁾ fact considered and commented on by the CAFC⁽⁸⁾.

(8) As to the CAFC's “PHILLIPS case” (Jul. 12, 2005): This decision about claim 1 of the '798 patent and the dissenting opinion address two fundamental issues in claim construction, i.e. in applying the §112 test to a claim/invention. Both issues are exemplified by this claim, focusing on those parts of it, the decision leverages on. These are:

“Building modules adapted to fit together . . . an outer shell with . . . , . . . and further means disposed inside the shell for increasing its load bearing capacity and comprising internal steel baffles extending inwardly from the steel shell walls.” (emphasis and and added)

The critical compound de-concept used by this claim's wording is: “ . . . <for> increasing its load bearing capacity and comprising internal steel baffles extending inwardly from the steel shell walls”.

Both issues are restated in terms of CCD technique^{(6),(7)} for demonstrating the increase of clarity it introduces into executing the §112 test—avoiding errors therein removing part of the above dissent. They are indicated by the below headlines.

“Applicability of the §112.6 means-plus-function instrument for importing limitations into the claim's meaning vs. the claim's self-contained limitations definition”: The compound de-concept, on which the claim's “means-for-function” clause is based, evidently comprises two de-concepts^{9)1.}. whereby the second one (“comprising internal steel baffles extending inwardly from the steel shell walls”) is non-functional^{4)e.,(6)}. Hence this clause does not meet the CAFC defined interpretation limitation⁽⁵⁾⁻⁽⁶⁾ for §112.6 (Sect. I, p. 5-7), i.e. cannot import further limitations into the claim's meaning from the specification. Therefore this clause is all that defines this compound de-C's compound cr-C (unlike as above⁽⁶⁾). Only then this decision disaggregates the so defined compound cr-C into 3 elementary cr-Cs (Sect. IV A, p. 31), just as above⁽¹⁾⁻⁽⁷⁾ without noticing that the compound de-C's disaggregation would have been necessary up-front for establishing clarity, i.e. before determining its compound cr-C—as checking the applicability of the §112.6 means-plus-function instrument for that clause then would have led to a different result. The compound de-concept's first disaggregated de-concept (“increasing its load bearing capacity”) then would have been recognized as purely functional and hence as potentially adding limitations imported from the specification into the claim's meaning. Both parties did not raise this issue and hence it is not further considered here.
“The facts in the §§101/102/103 tests vs. the facts in the §§112 test”: The dissenting opinion alleges that, in the decision at issue, the CAFC—based on its 1998 Cybor decision that “ . . . claim construction does not involve subsidiary or underlying questions of fact . . . ”—were “ . . . adhering to the falsehood that claim construction is a matter of law devoid of any factual component.” (p. 1-2). Yet, already the two preceding references to the decision at issue show that its legal 112 analysis of the claims of patent '798 actually does perform elaborate facts determinations. I.e.: In claim construction the CAFC indeed performs even meticulous facts determinations, this not being recognized as such by the dissenting opinion.

Performing, in claim construction, up-front the disaggregation of a compound de-C used by the claim's wording into its disaggregated concepts, untangles this terminological/notional clutter. Namely: It is known from advanced IT that this disaggregation of a compound meaning into its elementary meanings^{9)1./2.} indispensably starts—as claim construction determines the claim's and hence these concepts' meanings alias semantics—with first identifying the lexical/syntactical entities (e.g. words, wordings, graphics) in these concepts representing these meanings/semantics. Here is important that these entities may be comprised by the claim's wording or by the remaining parts of the patent's specification (explained in detail by the decision at issue) and marked-up by MUIs^{V}. Hence, the process of claim construction is nothing else but determining, up to §112 these lexical/syntactical entities (including their locations) and their meta-semantics, together here called de-Cs^{III.3.2}, as well as their precise semantics, here called their cr-Cs^{III.3.2}—both being, in a claim construction alias a §112 application, the indispensably to be determined facts, here abstracting from the question by whom.

Just for completion: The subsequent use of the cr-Cs' meanings/semantics in a 102/103 test or a 101 test strives for facts quite different from those represented by these de-/cr-Cs, determined by means of the resp. §112 application. And further going: Applying the §112 test to a claimed invention firstly determines the claimed invention's creative/inventive concepts and their semantics, i.e. its cr-Cs, as facts over pertinent skill (as outlined above), the §§102/103 tests secondly determine the claimed invention's patentability semantics as indicated by the factsm derived from the so determined cr-Cs over pertinent skill and prior art, and finally the §101 test thirdly determines the claimed invention's patent-eligibility pragmatics as indicated by the factsm derived from the so determined cr-Cs over patentability exempting constraints.

In total: The elaborations in (1)-(8) show that the “compound (de/cr-)C disaggregation, CCD” technique^{4)a.-f.} provides,

on the analytical side, firm ground for consistent and hence predictable decision making by PTOs and courts—comprising, e.g. in the US, the CAFC and USSC and the above 4 §§—and how it enables,
on the constructive side, drafting legally transparent and safe claims of patent applications (for an example see Section V).

They also show that CCD technique not only enables meeting the current requirements stated by the USSC as to the application of these 4 §§—but, on top of that, it enables meeting a whole bunch of future requirements to be met by patent precedents for achieving/preserving predictability, not yet recognized by patent precedents today. All this together justifies the above^{4)g.(4)} expectation as to the worldwide eventual acceptance in patent jurisdiction of the FSTP technique and its CCD.

In the US, for any patent threatened by its intransparent presentation of its legal relations to the 4 §§, a CIP—if still possible—might adapt it to the USSC's paradigm shift such as to improve it as requested by the 3 above USSC decisions.

4)h. Concept Disaggregation Advantages for PTOs, Law Firms, Courts, Innovation Managements. On top of treasures of soil and industry, increasingly treasures of the knowledge fuel today's economies—in particular their wealth creating engines, being the knowledge innovating enterprises. Hence, their innovations/inventions and their IPRs become crucial tangibles. This trend namely comes along not only as an explosion of the number and complexity of patenting activities, but also as an increased need of open, speedy, trustworthy, dependable, and technically absolutely unquestionable PTOs, patent law firms, and for patenting issues qualified legal courts eventually involved in their disputes—and, prior to these legal issues, of the innovation/IPR managements of many other private/public entities.

Taking e.g. the PTO business, the FSTP Technique may enable a decisive break-through of efficiency, as it

may (optionally) disburden the examiner from most of his today's work by enabling the PTO to reverse the burden of proving e.g.^{9)5.} the nonexistence of technical facts in the prior art, which anticipate this patent's invention or indicate its nonobviousness—the applicant then had to submit, together with his patent application, its PTR-DS comprising all (unquestionably analyzed and precise) indicative technical and legal facts, as identified and documented by and applied within a PTR-PS (provided e.g. by the FSTP Test and/or §§112 and 102/103 checks)—and/or of proving that the application is not flawed by an indefiniteness, preemption, dependency, . . . problem^{9)5.}. The examiner then may focus on evaluating these indicative facts presented to him, i.e. he needs to perform only a small fraction of his today's work. This reversal of proof—together with the examiner's IES'es q/a system—would multiply his capacity of careful patent analysis/throughput.
enable the examiner of a patent—before him its inventor and afterwards lawyers/jurors/judges/experts in court cases defending/attacking it—to instantly access any (XML4IP) marked-up information in any document^{V}, which contributes to its (non)indefiniteness/-obviousness/-patent-eligibility indication, removing any factual uncertainty about any such aspect, This is possible only as the PTR-DS may provide (via the IES) all meaningful chains of legal arguments as to them.
not only vastly simplify/accelerate the examiner's work, but also stabilize it as to later checks: The PTR-DS works for the IES of a court exactly the same way as for that of an examiner and for that of the applicant, including showing to them all crucial technical, legal, examination, precedents facts—comprising those annotated e.g. by the examiner or the inventor.

This change of mode of operation of a PTO will be nothing else but making it operate the same way as a building supervisory authority: The latter would not even think of determining on its own, whether a building is solidly constructed—but a priori leave providing this proof (that this construction is solid) to the building's owner. I.e.: The building supervisory authority would just check and confirm his proof or not, i.e. grant the right to erect/use this building or refuse it. I.o.w.: Today it is impossible to submit to a PTO, with a patent application, also a scientific proof of the “creative height of its invention over given prior art”, but FSTP Technology terminates this problem. It enables an inventor and/or a patent lawyer and/or an IPR manager to run this FSTP analysis of an invention/innovation/TT.0 on its own, prior to submitting it to a PTO together with his/her patent application for it—and prior to such steps, to appropriately structure additional creativity efforts as to the invention/innovation/TT.0 at issue, if needed, and thus generate another PTR-DS reflecting such improvements, too.

As to business/healthcare/green/nano/ . . . inventions—just as to any other model-based technical invention—this reversal of proof is without alternative for the innovation/IPR managements of research/marketing/ . . . organizations or PTOs. The accelerating increase of sophisticated knowledge, on which these inventions/innovations leverage, makes it unthinkable that these managements' and/or PTOs' and/or patent courts' human resources would be able to quantitatively as well as qualitatively keep up with it, already mid-term, not to speak of long term.

In the US these aspects deserve a second look as to the short term impact exerted by the KSR/BILSKI/MAYO decisions to present an invention/TT.0 in a more elaborated/disaggregated form, exposing its elementary “creative/inventive concepts”, i.e. such pe concepts^{4)e.,g.}: These worsen the known problem of the CAFC coming up next year already. The AIA, in its honorable and timely intent to unfold the potentials of innovativity of the US economy, requiring the increase of the throughput of the USPTO, caused a situation, which will shift the currently ten thousands of cases of the backlog of the 100+ members of the BPAI of the USPTO to the 10+ judges of the CAFC. This will cause its dramatic overload—without this reversal of proof.

In total, the interplay between recent HIGHEST COURTS patent precedents^{4)a.-g.} and the development of specific IT—IT^{IV.,V.} totally focusing on the needs of the important target areas “patent jurisdiction” resp. “innovation control/evaluation/marketing/using”, thus avoiding all here unwanted mathematics otherwise needed (e.g. in KR or NL or Semantics research) has proven to be extremely productive: It led to developing a paradigm^{4)e.-f.} of massively increased practical problem solution power as to facts determination problems of a PTR in any one such target area. This paradigm enables “raising the bar” philosophies as to PTOs' resp. other authorities' examining capabilities as to patents resp. other inventions/innovations/TT.0s, as well as significantly increasing the efficiency of innovation management as to all its facets^{4)h.}. I.o.w., this interplay implied the development of a paradigm, the potentials of which may cause a whole series of paradigm changes,

in patent jurisdiction towards an emerging “patent technology”, and much broader towards using
“mathematical innovation science” in probably any area of life interested in transparency of its facts and their interrelations.

Due to this new paradigm's enormous economical potential impacts, it likely is to enforce all that.

⁵ 5)a. For simplification, any claim/doc.i is limited to deal with only a single TT.i, 0≦i≦l, i.e.: discloses^{5)b.,c.} for any X.0.n at most one peer X.i.n^{5)d.}. This limitation may evidently be dropped, as otherwise the PTR is finite, too.
5)b. Any doc.i comprises ex- and implicit disclosures of its TT.i's properties, mostly being informal^{III.1}. A disclosure is
either explicit in doc.i if it contains wordings and/or graphics explicitly describing its element/property/concept^{III.3.2}, and/or
implicit in doc.i if it contains no such wordings/graphics for an element/property/concept, but the person of ordinary skill (pertinent to TT.0) knows that this element/property/concept is implied by some wordings/graphics of the specification/claim of the patent, or is a boolean expression of any such disclosures, or (EPC only) if this avoids a contradiction between the wordings' meanings in its specification and its claim.

Explicit and implicit disclosures are sometimes qualified as “intrinsic” resp. “extrinsic”—somewhat misleadingly as both kinds of disclosures are intrinsic. I.e.: The term extrinsic emphasizes, for implicit as well as explicit disclosures, that their interpretations got to be performed in compliance with elaborate external directives and/or agreements^{6),8)} as to pertinent ordinary skill(s), significantly exceeding the usual text book literature, e.g. international standards^{5)c.}.

In a PTR, the ordinary skills pertinent to its TT.0—different skills potentially pertinent^{d.} to TT.0—are by any NPS considered as implicitly disclosed completely, 0≦i≦l. Yet, such skills must not be just claimed to exist, but must be documented in an enabling way^{5)d.}; this holds for any^{5)c.} such ps-Cs. The prior art concepts of the TT.i's, the pa-Cs^{III.3.2} must be disclosed explicitly at least partially by their doc.i's, 1≦i≦l; the same applies to the disclosures of TT.0's cr-Cs by doc.0. At the time the PTR is worked on by a PTR-PS, so disclosed ps-Cs and pa-Cs are considered as having been existing at TT.0's priority date^{III.3.2}, i.e. not as to be created at TT.0 invention time, like the cr-Cs. Creating a then nowhere documented combination of ps-Cs and/or pa-Cs—and potentially also with a cr-C—requires an independent thought preceding its creation^{5)d.,6)c.}.

Hitherto concepts/predicates have been seldom explicitly disclosed as such, in patents, but just used therein by references to their values—i.e. they mostly are disclosed implicitly and incompletely only (in particular in a PTR's AD-KR^{III.1,III.3.2N3,9)R1,} “casually”) as underlying a part of its claim's or specification's wording—though often they are indispensable^{5)c.}, in particular as to the amount and kind of creativity of its TT.0, as recently repeatedly emphasized by HIGHEST COURTS⁴⁾.

5)c. The concepts/predicates of pertinent skill, ps, and/or prior art, pa^{IIi.3.2} in a PTR problem are frequently predefined by international standards, again without explicitly disclosing them as such^{5)b.}. And even thereof, the ps and/or pa used by a PTR may comprise several adjacent but yet so different areas of technology^{5)d.} that there is no person of ordinary skill with a professional familiarity with them. This is the case e.g. in telecommunications⁸⁾.

Due to the high level of notional abstraction, indispensable in such worldwide agreements on complex technologies, these ps-Cs^{III.3.2} underlying such terms/notions of pertinent skill, may be accordingly complex and highly structured (e.g. by simultaneously existing different partial orders on the components of their values^{8),9)}, such coexisting different partial orders being defined by these components and/or architecturally, e.g. their logical or topological vicinities, or their sequences and/or co-operations in performing something, such as the arrivals of components at places, or their location, or . . . ). Yet, in a PTR, of such complex concepts of its TT.i's ps-Cs and/or pa-Cs, only a small number of them and/or their components/values/relations between them may be used, potentially only a single one. I.e., most of such ps-Cs/pa-Cs and their relations are immaterial in a PTR problem [FSTP Tech. Rep. #1: “AD-/BID-KRs of the '884-PTR”¹⁾].

5)d. In addition to this potential notional complexity^{5)c.} of the ps-Cs/pa-Cs, doc.i, i≧0, may also disclose using ps-Cs and pa-Cs belonging to different technologies^{5)a.5)c.6)c.8)}—or even to the same technology—but in a hitherto unknown “combination” of these ps-Cs and pa^{5)c.8)9)1.-3.}. How to make this combination transparent is discussed below^{6)c.,V}.

An example^{1),8)} is the multiple explicit disclosure in the '884-doc.0 describing how its TT.0 technically achieves its creative data transfer (modeled by an o-cr-C^{TT.0})^{N5i),9)1.-2.}, always starting over the Internet, guarantees a data transfer time of less than 0.5 sec, i.e. enables Internet telephony. Ordinary telephony skill and ordinary Internet skill knew peer data transfers ps-C^{Int}, ps-C^{tel} with d(ps-C^{tel↓dtt})={(0, 0.5)} and d(ps-C^{Int↓dtt})={(0, ∞)}, the latter excluding Internet telephony. The '884-doc.0 explicitly discloses enablingly a very specific way of technically realizing “real-time data transfers (launched) over the Internet”¹⁾, i.e. a combination of ps-C^{Int↓dtt} with ps-C^{tel↓dtt} to a hitherto unknown combinational concept cr-C^{TT.0↓dtt} with d(cr-C^{TT.0↓dtt})={(0, 0.5)}. I.e.: At '884-doc.0 priority date in posc^{Int}+pa^{Int}+posc^{tel}+pa^{tel} no document disclosed this specific combination of known ps-Cs—one from the “Internet”—and the other one from “telephony”-telecommunications technology—into a creative/inventive cr-C^{TT.0↓dtt} in an enabling way, not even only claimed/pretended it^{6)c.}.

A creative/inventive cr-C—precedingly: cr-C^{TT.0↓dtt} combining ps-C^{Int↓dtt} and ps-C^{tel↓dtt}—is often disclosed in a PTR's doct0 by having an X.0.n referrring to its value(s), while no peer X.i.n refers to such value(s). The inadmissibility of just cherry-picking^{III.2,ii)} it from two component-cr-Cs of peers of X.0.n, i.e. referred to by X.i′.n and X.i″n—i.e. not disclosing in an enabling way how to actually achieve this combination-cr-Cs—protects this combination's creativity against attacks based on arguing it were anticipated by both posc+pa, as its constituents are known therein^{6)c.}. Note that this combination-cr-Cs, often being a BID-cr-C, must not be considered as a compound cr-C aggregated made up from these constituents^{9)1.-2.}.

⁶ 6)a. In a PTR's AD-KR^{7)c.} and an AD-AC^{III.2} of disclosed⁵⁾ AD-X.i.n's/AD-X.i.n's, i>0, an AD-X.0.n/AD-X.0.n peer to it may be completely missing for one of either the N AD-X.0.n's or the N AD-X.0.n's or the K AD-C.k's or else—in the latter case, i.e. of an existing reference to AD-C.k in AD-X.i.n of this AD-AC—this AD-C.k may be referred to by AD-X.i.n outside of U(AD-C.k) defined by TT.0. Any such “anticipation deficiency” of an AD-AC is easy to determine, eventually even automatically, as all AD-X.i.n may be brought into the same normal form^{7)a.}. Exemplarily, the FSTP-Test models such cases, within its PTR's analysis, by making a non-existing peer in doc.i's X.i.n or X.i.n exist in AC as “dummy-peer.i” just as an existing peer but with different U(C.k), both denoted by crⁱ-C.k. Both kinds of dummies stand for something fictional, i.e. markers showing where, in this AD-AC, a missing/failing X.i.n/X.i.n in doc.i requires creating a fictional AD-crⁱ-C.k by a 1-CC for making this AD-AC anticipate TT.0, after AD-AC/mod(AD-q-CC). Defining this crⁱ-C.k by the FSTP-Test for a doc.i may be subject to the limitation that this AD-crⁱ-C.k not contradict TT.i^{III.2.i)}. This may be modeled by a “dummy-limit.i”—not further elaborated on here. Note: This “AD-level” discussion is immaterial here and in part of the following, i.e. is provided only for creating problem awareness.

And: For any PTR-PS service exposing any pair of <BID-X.i.n, BID-X.0.n> currently is of interest only—for determining the BID-ANC-relation—whether it evaluates to an A or N/C (whereby C is not leveraged on, here). Once a BID-KR(PTR) is determined, this is often recognizable by an FSTP user sufficiently skilled as to his/her PTR, immediately from posc and document.i's disclosures. I.e.: BID-KR(TT.0) trivializes this decision: The formal AD- and BID-X.i.n's alias BID-cr-C.i's then are not required^{1)[SectionIII]}, but are replaced by dummies. The resp. A/N/C may therefore currently be entered by him/her interactively by/to this PTR-PS service while using it, together with all relevant technical and/or legal explanations—to be confirmed by the person of posc. Yet, eventually—as soon as advanced semantics research pursued in the FSTP project will achieve sufficiently formalizations of the meanings of the information involved—this information would be generated (at least rudimentarily) by the PTR-PS service.

As this is practically so important, once more: Proceeding this way is evidently next to trivial, after the initial o-KR(TT.0) has undergone a TT.0 normalizing RT^{III.3.2,D5/N5} into a BID-KR(TT.0)^{7)c.}—in particular, as the {X.0.n} is eventually the same for all of PTR's o-/AD-/BID-KR.

6)b. This discussion about potentially several AD-/BID-KRs of a PTR indicates already that assuming, in AD-KR, a single independent thought may actually suffice for creating an independent AD-crⁱ-C⁴⁾, often would be a gross underestimation of the complexity of the mental barriers to be overcome for its creation—in particular if this AD-cr-C is not existing at all in the prior art, but also if it exists in a doc.i, which teaches away from TT.0^{III.2}. Quite a similar problem potentially arises with AD-/BID-“combination-cr-Cs”^{5)b.} “irreducible” to AD-/BID-cr-Cs independent of each other—mathematical issues not elaborated on here. The value of AD-/BID-Q^{plcs} determined for a PTR thus is just a lower boundary for the actual number of independent thoughts embodied by its TT.0 over its RS—not implying identifying more of them in doc.0, which would always increase it^{III.3.2N1}.
6)c. And similarly: All NPSes' precedents concur that technically⁷⁾ new—i.e. nowhere documented and technically⁷⁾ non-trival—combinations of ps-/pa-Cs deserve to be considered as creative, i.e. as created by independent thoughts, i.e. as contributing to TT.0's nonobvious indication^{5)c}, over the prior art RS. Nevertheless, courts here occasionally commit absurdities¹⁾.

More precisely: The existence of ps-/pa-Cs does not imply their combinations are trivial and need not be created by independent thoughts^{5)b.} alias 1-CCs. I.o.w: A PTR-PS must not assume the creation of such a combination needs no 1-CC, as it is disclosed^{5)b.-d.} by documented ps or pa: Just mentioning this combination of ps-/pa-Cs—belonging to the same or to different technological areas—is absolutely not an enabling disclosure of an “inventive concept⁴⁾”, i.e. how this combination is technically actually achievable. In the above^{5)d.,1)} example: just adding a telephony-like patent to the RS and then cherry-picking (excluded by HIGHEST COURTS' precedents in any NPS) is neither an element-integrity preserving nor enabling disclosure of an “inventive C” in pa.

Finally: Only recently^{[EPA-G03/08 decision],4)a.-g.} it turned out that the issue of combining ps-/pa-Cs into cr-Cs is tightly related to the issue of disaggregating compound cr-Cs into finer and legally clear cr-Cs^{9)5.}—though both issues must be meticulously distinguished from each other—as they both may exert decisive impacts on the legal checks in any NPS of an innovation's/invention's/TT.0's patentability resp. patent-eligibility, e.g. in the US by the §§112, 102/103, 101^{9)5.}.

⁷ 7)a. Firstly, the term “technical” is clarified (postponing the issue of “technicity”^{7)d.}). It here serves for two purposes: For
i) reminding what distinguishes, in all our minds “technical” inventions/innovations/TT.0s (“i/i/TT.0s”) from “non-technical” inventions/innovations/TT.0s (such as “a new style of painting or music or poetry” of “fine arts”), and specifically for
ii) distinguishing, for an invention/innovation/TT.0 of a PTR, its technical aftereffects defined and elaborated on here^{III.1,III.2} from its non-technical and fundamentally different pseudo facts based on so called “secondary considerations” without clear technical foundation (e.g. “market success” or “long felt needs”)—only briefly mentioned below.

As to i): Innovations/TT.0s are called “technical” if they are derived by precisely defined concept creations controlled by precisely defined “knowledge based” practices. Such pre-existing “knowledge based” practices are called “techniques” since ever, as the properties of their elements are so simple that they enable their getting along with only simple logic based rules alias relations between them^{3),4)}. This implies: The predicates describing such relations between these practices' elements alias matters^{3),4)} are limited to be FOL predicates, at last in its BID-KRs^{7)b.,c.}. This definition of the meaning of the term “technical” of an innovation/TT.0 is reasonable, simple, and clearly defined. It avoids any problems resulting from tying the definition of this term's notion to the subject matter underlying the innovation/TT.0—i.e. from ignoring that the phenomenon “innovation/TT.0” as such is subject matter independent, a law of nature^{*)),4)d.,III.3}: It should eventually prove to be consensually/internationally acceptable/fitting. Finally, the notion of “established precisely defined knowledge” implies that the ps and pa represented by it must be documented resp. disclosed⁵⁾, both in an enabling way at TT.0's priority date.

As to ii): There are “secondary considerations” of an innovation/TT.0, which in some cases may lead to a non-technical alleged fact alias “pseudo fact”, being based on knowledge that has accrued exclusively a posteriori the priority date (e.g., the a priori not yet unquestionably/doubtlessly determinable market success of a product based on this innovation/TT.0 or its meeting an allegedly long-felt need). As opposed to this preceding kind of secondary considerations, an a posteriori analysis alias secondary consideration of an innovation's/TT.0's aftereffects not using such “a posteriori only” knowledge but knowledge that has completely been available a priori to its priority date, always leads to a technical secondary fact—although the latter often has not yet been recognized at priority date. The classical example of such a technical secondary fact determinable for a TT.0 is its removal of an established misbelief (if it existed prior to priority date). The innovative technical secondary facts always determinable for a TT.0, as presented here—and hence not been recognized at priority date of any TT.0 existing prior this patent application—are unquestionably/doubtlessly determinable, and hence provide an absolutely dependable basis for evaluating, e.g. by a court, an invention's/innovation's/TT.0's legal properties in an NPS^{9)5.}

7)b. The fundamental being of an innovation/TT.0 is of simple semantics—more precisely: “patent law carrying semantic, plcs”—though this simplicity may not be evident from its doc.0 specification^{7)a.}. The reason being that there the innovation's/TT.0's plcs simplicity is massively shadowed by a variety of non-logical contexts, such as: established deficient language²⁾, bias towards a particular application of this innovation/TT.0, lack of diligence in drafting, and alike, also pmgp^{1),4)}. Usually such non-logical or even unreasonable contexts enjoy by and/or exert on most human beings—normally unintentionally resp. unnoticed—a much higher attention/impact than objective order and/or preciseness when drafting and/or when interpreting a doc.0 disclosing an invention/innovation/TT.0. I.e., recognizing by compound concept disaggregation at its §§112/102/103/101 test times its—any technology inherent—plcs-logical simplicity, requires identifying, in doc.0 all ex-/implicit disclosures^{5),6)}: I.o.w.: This simplicity is the reason, why it often is easy to find for a PTR its normalizations^{III.3.2}, i.e. its precise BID-PTRs^{7)c.} (e.g. enabling identifying all shortest paths from prior art RS to TT.0^{4)c.}).
7)c. A PTR's AD-PTR often is blurring^{7)a.,5)b.,4)a.-g.} as to determining facts indicating the (non)obviousness of its TT.0 over RS⁴⁾ the HIGHEST COURTS' way: AD-PTR's “casual” Cs are often misleading as substantially deviating from this way. Any initial interpretation of a disclosure^{5)b.} of an AD-PTR's doc.i assumes that for any property of any element of doc.0 the peer property of the peer element in a doc.i, i>0, may be changed by a single independent thought^{4)a.-b.} such that this property of doc.i anticipates this property of doc.0. In our more precise notation^{III.1/2} this assumption reads: . . . that for any property AD-X.0.n of any element X.0.n of TT.0 the peer property AD-X.i.n^{5)a.} of the peer element X.i.n in a doc.i, i>0, may be changed by a single independent thought 1-CC such that AD-X.i.n/mod(1-CC) ants AD-X.0^{6)a.}.

This initial assumption may sometimes be correct for some PTRs and their AD-X.i.n's, but often it is wrong. One of AD-X.i.n's AD-Cs, which got to be changed by a 1-CC may, firstly, be dependent on other AD-Cs (and then may not be usable for counting independent thoughts^{4)a.(1)}), secondly, not be modifiable by a single 1-CC/independent thought (e.g. as being a highly compound C), and thirdly, its modification by 1-CC may have a “side effect” on another AD-X.i.n in AC also depending on it (and thus on AD-X.i.n's NC-relations, turning it into an A-relation), hence affecting Q^{plcs} (unless compensated^{9)3.,III.3.2D2/N2}).

Hence, for any such PTR^{9)5.} it is absolutely impossible to determine alone from analyzing its AD-KR (and its casual AD-C.k's, if identifiable at all), how many independent thoughts at least are required for creating its TT.0 starting the search for it from its prior art RS, i.e. how much creativity is embodied by its TT.0 over its prior art RS⁴⁽ⁱⁱ⁾. Then it is indispensable to transform PTR, first, from its AD-KR to independent binary Cs (BID-Cs), i.e. to its BID-KR. Patent law precedents is not yet aware of this frequently occurring difficulty with a PTR's o-/AD-KRs^{4)g.(5),9).5}, and the more is not aware of a need to “normalize” it^{III.3.2} for determining its TT.0's creative height over its prior art RS. In all these frequent cases such patent law precedents are worldwide based on extremely questionable facts—in the US §§102/103 decisions. The much broader range of problems encountered when accepting claim presentations using compound concepts, in the US affecting §§112 and 101 decisions, too, has been explained above^{4)g.(1-9)} by means of the currently most interesting cases applying these §§^{9)5.}.

Even if one should currently maintain, in a PTR analysis, that lack of reasonability—as to determining, which exactly these facts of (non)obviousness indications are and/or for what exact meanings such facts stand—and hence the BID-KR of PTR were superfluous: History teaches that, in the engineering context, such clinging to the wrong never prevailed. An important first confirmation of the correctness of this prognosis is: The preciseness of the BID-KR is indispensable for performing it as recently demanded by the USSC^{4)g.,9)5.}.

⁸ An example of an internationally standardized ps-C in telecommunications is called “Open Systems Interconnection Reference Model (OSI-RM)”. It is agreed on by all worldwide giant standardization bodies, such as ISO, ITU-T, IEEE, IEC, IETF, . . . and their national counterparts, e.g. the ANSI, DIN, AFNOR, BSI, NTT, . . . . It overarches much of telecommunications' ps, which comprises end-users communications, such as telephony applications. But, it vastly ignores e.g. ps as to signaling issues in telecommunications, being quite different from the former ps and being covered by totally different sets of international standards (such as SS7 of the ITU-T or SIP of the IETF). The top level o-ps-CN^{N5)i),9(ii)} of the OSI-RM is an “application data transfer” in a “communications connection” of OSI-RM structure, modeling a complete TRANSFER, being different from the latter's top level ps-C, modeling only signaling for establishing telephony communications connections.

These OSI-RM terms'/notions' use in the '884 patent is clear, as not explicitly and clearly stated otherwise (as required by patent law precedents in the US and the EU). This broad consensus of national/international bodies is based on their insight that using the layman's language in telecommunications inevitably creates notional chaos—by its various and in important details contradictory meanings of the layman's notions of such terms as “connection”, elaborated on below.

The OSI-RM, as an international standard, defines its terms' meanings in English wording of the person of posc^{4)a.}. I.e., the terms/notions of the OSI-RM were not chosen to be immediately graspable by the layman, but to provide to the persons skilled in the art a commonly accepted/necessary notional basis. To clarify in an international—in particular the US market addressing—telecommunications patent it had chosen the only existing internationally/nationally agreed on telecommunications Reference Model for identifying what the terms/notions are of its pertinent ordinary skill, were as strange as stating in it that it uses the “Webster's Unabridged Dictionary” for its English. I.e.: For a telecommunications patent, the pertinent telecommunications skill makes the use of the ISO OSI Reference Model absolutely indispensable.

According to this standard, the notion of “transfer” means the whole data transfer of a phone call—and should not be mixed-up with “transferring data” in some phase of this communications connection considered, i.e. with details of this transfer. Subsequently this is highlighted by capital letters for avoiding misunderstandings, where appropriate. I.e.: This TRANSFER comprises much more than just the actual transferring of data, e.g. also the “change from packet switching to line switching . . . ” therein (see col. 9:43-52). Together with col. 9:37-41 this clarifies the tight notional relation between a TRANSFER and a communications connection, and also that this change of the monitored TRANSFER results from and affects only this communications connection considered (as otherwise the line-switching connection might be overloaded a priori, thus obviously not achieving its intended real time quality). See Section II.A.1.2 for further limitations on this TRANSFER.

As to the notion of the term “connection” used multiple times here: There is no universal meaning of this term. Its notion is always depending on this term's context identified by its prefix. In telecommunications, the term “communications connection” stands for an “abstract communications application association” (see the first pages of the above OSI Reference Model) of two communicating parties—hence its name. It belongs to the OSI layer 7 (=L7), i.e. it is an “abstract application connection” alias “L7-connection”. In case of a telephone call its communications connection is the abstract telephony association between the abstract models of the telephone sets of the caller and callee. It becomes “existing”—as an association between a caller's and a callee's phone model—exactly when on the caller's end terminal the address of the callee's end terminal is identified. “Establishing” an existing connection denotes the process of performing its abstract technical realization, which comprises activities possible only after it became existing. This first step of establishing alias “setting-up” a communications connection is colloquially denoted by the term “calling”. The skilled person knows about the technical details of abstract local resource requirements and agreements to be met between the caller's/callee's terminals during call set-up. A call alias its communications connection may enter—after its “set-up phase”—into its “use phase” and eventually into its “termination phase”. In all phases a call requires performing, between its communications connection's end-terminals an end-terminal-to-end-terminal data transfer, i.e. a TRANSFER.

A call's communications connection is an end-terminal-to-end-terminal connection, while its switch-to-switch segment may use a packet-switching or a line-switching so-called “network connection” (alias “L3-connection”). In telecommunications “tech talks” these prefixes—“L7”, “application”/“communications”, “network”/“L3”, “link”/“L2”, . . . —would frequently be omitted, as they are clear to the skilled telecommunications person anyway. Accordingly: The event of a time delay (implying a delay forever and abstracting from how the first switch becomes aware of it) may occur in a large number of situations and in several locations in the TRANSFER monitored resp. its communications connection—and need not be caused by the packet-switching network, at all, but may be caused outside of it. Practical examples of reasons of possible such events are:

The first switch ran out of buffer space as needed (e.g. for packetizing the data incoming from a telephone set) when using the packet-switching network for the communications connection considered, or it ran out of other resources needed to this end (e.g. appropriate compression/decompression resources), or it cannot forward a packet to the packet-switching network (e.g. somebody has pulled the plug to it or it has encountered some internal management limitation), or it discovers unacceptable delays on the data received by the second switch or that the second switch has one of the resource mismatch problems as just identified for the first switch (the skilled person needs no explanation of how to achieve this discovery). Any of these events may occur any time after the TRANSFER began in this communications connection.
⁹ Some more remarks about concepts, predicates, KRs, and mathematically modeling HIGHEST COURTS' patent precedents.

1. For a PTR, any AD-cr/de-C is viewed as a potential “compound-cr/de-C” comprising more subtle alias “finer” concepts, often “BID-cr/de-Cs”^{D2-4/N2-4}, for short “elementary cr/de-Cs”. “compound”/“made-up from”/“composed”/“aggregated”/“integrated”/“comprising” may be defined vastly^{2.} arbitrarily, if only confirmed by the person of posc^{D2-4/N2-4}. A composition of a compound-cr-C from several BID-cr-Cs may be the product set of the sets defining the BID-cr-Cs, or of their union set, or . . . The “integration”/ . . . /“aggregation”^{III.1,D4/N4} of BID-cr/de-Cs into compound cr/de-Cs—modeling plcs-facts or disclosure facts—is misleading in inventions' §§112, 103, 101 tests^{4)g.,5)d.,6)b.}. A BID-cr-C may be arbitrarily disaggregatable into finer BID-cr-Cs [symbol] ∈pos+pa—e.g. the complex number “1+i” based binary compound concept may be disaggregated into the binary elementary concepts with dCs “1” and “i”. An AD-cr-C may already be a BID-cr-C, and not disaggregatable into finer BID-cr-Cs—the twice occurrence of a finer BID-cr-C therein may be counted only once. Compound concepts may dep, though each is composed of ind BID-cr-Cs^{D2/N2}.

The legally decisive property of BID-cr-Cs is their independency^{4)a.,D1/2,N1/2}, not their trivially achievable binarity (by rewording them): Binarity is a legally irrelevant but practical property of independent cr-Cs. I.e., their “inter-cr-C-independency-as-to-their-set-of-cr-Cs” property^{D2/N2}—based on these BID-cr-Cs' <dC, U(C)>s or just U(C)s—is legally highly significant and must be stated/confirmed by the person of posc (unless the cr-Cs are mathematically defined, see above, which may enable proving their independency mathematically, i.e. making such posc confirmations of ind redundant^{D2/N2}).

The reason, why reducing a compound cr-C into binary independent cr-Cs often is easy, results from the logical/technical^{7)a.} simplicity of most inventions/TT.0s: Their compound cr-Cs^{5)d.} are often just conjunctions^{5)d.,8)} of their BID-cr-Cs.

2. No difference needs to be made between a binary C and a predicate P over its U(C)—by taking U(C)'s dC as truth set of P. For this C this P here is called its “mirror predicate, C”, and vice versa U(C) is the binary “mirror concept” of this C.

Ignoring details, this interchangeability between binary Cs and their mirror predicates may be generalized to a conjunction of a set {C}, mirroring a binary compound concept, here called “COM{C}”. Practically, an AD-C often is such a conjunction, “disaggregatable” into a {c} of their {mirror C}. This AD-C then comprises the {C}, and its COM{C} comprises the {binary mirror Cs}. Selecting, out of PTR's identified binary Cs, a (not necessarily unique) maximal subset of ind ones, renders the non-selected ones kp within it^{D2/N2}. While in AD-KR(PTR) independency of (binary or non-binary) Cs need not exist or not be recognizable^{7)b.}, for normalizable PTRs it exists and is easily verifiable^{D2/N2}, yielding PTR's BID-KR(PTR).

3. Determining in <A> the number min^{∀}^{_{AC}}|{NC^{AC}.i.jₙ|1≦jₙ≦Jₙ}| in AC implies assuming that
at least one 1-‘CC must be performed on the BID′-C^{AC}.i.jₙ≠BID′-C.0.jₙ for achiving BID′-C^{AC}.i.jₙ/mod(1-‘CC)=BID′-C.0.jₙ, i.e. BID′-C^{AC}.i.jₙ/(mod/1-‘CC) ants BID′-C.0.jₙ and,
performing this very 1-‘CC has not side-effect on another BID′-C^{AC}i.jₙ_{^{o}}=F.i.jₙ_{^{o}}^{6 )a.} (in this AC) by turning it to BID′-C^{AC}.i.jₙ_{^{o}}T.i.jₙ_{^{o}} (i.e. making ^{6)a.} BID′-C^{Ac}.i.jₙ_{^{o}}=BID′-C.0.jₙ_{^{o}}). This requires confirmation by the person of posc^{D4/N4,D5iii)}. If it occurs in this AC, then D² holds for this BID′-C^{AC}.i.jₙ_{^{o}}:BID′-A^{AC}.i.jₙ_{^{o}} dep BID′-C^{AC}i.jₙ and this BID′-C^{AC}.i.jₙ is not counted—but instead an additional cr-C of TT.0 representing the absence therein of this dependency in TT.i.

4. Creating a cr-C—see the beginning of III.3.2—is in case 3) a “fundamental” and in cases 1) and 2) an “improvemental” innovative step, as philosophical innovation theories^{4)b.} would informally define/recognize/distinguish.

5. Compound concepts^{1.,4)g.}, used in the wording of a PTR's claim on its TT.0, may be “legally error-prone/misleading”—as to their legal interpretations based on HIGHEST COURTS' precedents—in TT.0's checks for §§112, 102/103, 101 conformance. Such a compound cr-C's use hence should be admissible in a claim's wording resp. in the claim construction based on it. This use does occur, if there is a set of finer concepts^{1.} disaggregating TT.0's compound cr-Cs, which is:

“indefinite” as to the invention's functionality and scope claimed to be protected, up to §112, modeled by this set of cr-Cs as the fundament for any further plcs and/or pmgp requirement to be met by this functionality resp. scope, or
“dependent”^{III.3.2.D2/N2} as to this set of cr-Cs, thus disabling it as a basis for determining, up to §§102/103, the invented functionality's creative/inventive “plcs-height” over prior art^{III.1}—or
“preemptive” as to this set of cr-Cs, thus disabling it as a basis for determining, up to §101, the invention's scope—and hence “pmgp-height” over prior art^{III.1}—or
“limitations-hiding” as to the invention's functionality and/or scope claimed to be protected, up to §§112/102/103/101, thus disabling this set as a basis for performing all these determinations exhaustively.
The list shows also the logic of checking the cr-Cs' legal limitations, which in total eliminate this set's misleading potentials.

I.e.: A compound creative/inventive concept should only be admitted for use in the claim wording as to an invention, if it is “legally clean”—otherwise it should be barred, at the latest, from being used in a resp. claim construction—meaning: if there is no set of creative/inventive concepts disaggregating this compound concept, which excludes being legally error-prone/misleading as it is provable to be not indefinite or dependent or preemptive or limitations-hiding (at least confirmable by the person of posc^{III.3.2D4/N4}). Otherwise this compound concept namely unavoidably enables/invites the above^{4)g.} unpredictable/inconsistent precedents. The mathematical definitions (here not needed^{V.}) of 3 of these now clearly identified legal terms/notions^{4)g.}—see the mathematical definition of the legal term/notion independent^{III.3.2D2/N2}—will be given elsewhere¹⁰⁾.

¹⁰ “Patent Technology and Mathematical Innovation Theory”, S. Schindler, to be published.

What is claimed is:

1) A computer-implemented method for generating for a “Problem of TT.0 and RS, PTR^{CT}” a data structure “PTR^{CT}-DS” for use by an expert system, the computer system executing the method having a processor for generating and a memory for storing PTR^{CT}-DS, the method comprising:
receiving a document.0 with marked-up items (“doc.0-MUIs”) of information disclosing a technical teaching TT.0, receiving a reference set RS of document.i with doc.i-MUIs disclosing technical teachings TT.i, i=1, 2, 3, . . . , and writing all document.i, i=0, 1, 2, . . . , and their MUIs—any one called a “subject matter item”—into the PTR^{CT}-DS;
receiving a context document, document.CT, comprising an authority's directives (such as the wordings of 35 USC §§112/102/103/101) with doc.CT-MUIs of their wordings, and writing document.CT and its MUIs—any one called a “legal item”—into the PTR^{CT}-DS;
and creating further items of both kinds by the execution of this method as determined by its following steps:
(a) identifying of TT.0 of said claim of doc.0
.1 one element and generating a set comprising it, and writing said set into the PTR^{CT}-DS;
.2 the property of said element and generating a set comprising it, and writing said set into the PTR^{CT}-DS;
.3 at least one creative binary independent concept—such that the conjunction of their mirror predicates describes said property—generating for each and only this one a set comprising it, and writing any said set into the PTR^{CT}-DS;
(b) generating for any set generated in (a) a set of doc.0-MUIs disclosing its element and writing said set into the PTR^{CT}-DS;
(c) generating for any set generated in (b) a set of I.CTs justifying it and writing said set into the PTR^{CT}-DS;
repeating the steps (d)-(f) for any doc.i, i>0, and therein with any item peer to one generated in (a).1 or (a).3:
(d) generating a set comprising of TT.i either an element peer to one in step (a),1—if this peer element is not existent, replace it by a dummy peer element—or a binary independent concept of TT.i peer to one in step (a).3—if it is not existent or not equal to its peer in TT.0, replace it by a dummy peer concept—and writing said set into the PTR^{CT}-DS;
(e) generating for any set generated in (d) a set of doc.i-MUIs disclosing in doc.i the item replaced in (d) and writing said set into the PTR^{CT}-DS;
(f) generating for any set generated in (e) a set of I.CTs justifying it and writing said set into the PTR^{CT}-DS;
(g) generating the set of all anticipation combinations based on the replacements of (d) and writing it into the PTR^{CT}-DS;
(h) generating for any AC generated in (g) the set of a shortest sequences of Q 1-CCs such that AC/mod(Q-CC) ants TT.0, and writing said set into the PTR^{CT}-DS;
(i) generating for any sequence of Q 1-CCs generated in (h) a set of I.CTs justifying it and writing said set into the PTR^{CT}-DS;
(j) generating for sets generated in (a)-(i), a concatenation of which represents a test T, a set of argument chains as to this T, whereby any chain is limited to comprising sets from (a)-(i) as links, which are glued together by natural language fragments,
(k) generating for any set generated in (a)-(j) a real-time-access set, if it is needed for guaranteeing that this set's retrieval and presentation is terminated in dialog-real time and writing said set into the PTR^{CT}-DS.

2) A method according to claim 1, whereby its generated sets have the properties described in (a)-(k) by their BID-cr-Cs:
```
(a) (a).1 “AD-TT.0-concept” ≡ it comprises a) an element X.0.n or
    b) a predicate AD-X.0.n, 1≦n≦N, and
  (a).2 “BID-TT.0-concept” ≡ it comprises a) a BID-C.0.kⁿ, 1≦kⁿ≦Kⁿ, Σ ^{1≦n≦N} Kⁿ = K≧N, such that
    b) any AD-X.0.n of (a).1 is a conjunction of the mirror predicates BID-C.0.kⁿ of the BID-C.0.kⁿ,
(b) “SoDIS(Y.0)-concept” ≡ its element “SoDIS(Y.0)” ::= {dis(y.0) ::={MUI.0s disclosing Y.0}},
(c) “SoJ(dis(y.0))-concept” ≡ its element “SoJ(dis(y.0))” ::= {I.CTs justifying dis(y.0)},
and for any 1≦i≦l in (d)-(f)
(d) “BID-TT.i-concept” ≡ it comprises a) an element X.i.n peer to X.0.n or a peer dummy-X.i.n, or
    b) a BID-C.i.kⁿ, if it is = BID-C.0.kⁿ or a peer dummy-BID-C.i.kⁿ, 1≦kⁿ≦Kⁿ, 1≦n≦N,
(e) “SoDIS(Y.i)-concept” ≡ its element “SoDIS(Y.i)” ::= {dis(y.i) ::= {MUI.i's disclosing Y.i}},
(f) “SoJ(dis(y.i))-concept” ≡ its element “SoJ(dis(y.i))” ::= {I.CTs justifying dis(y.i)},
and further
(g) “BID-AC-concept” ≡ it comprising an AC of the PTR^{CT},
(h) “SoQCC(Y)-concept” ≡ its element “QCC(Y)” ::= {qcc(y) ::= {Q-CC I Y/mod(Q-CC) ants TT.0}},
(i) “SoJ(qcc(y))-concept” ≡ its element “J(qcc(y))” ::= {I.CTs justifying qcc(y)},
(j) “SoARGC(T)-concept” ≡ it comprises argument chains as to the execution of a test T, any chain limited to
  comprising only T-specific sets from (a)-(i) as links, being glued together by natural language fragments,
(k) “SoAccess-concept” ≡ it comprises at least one q/a-provision, which guarantees within 1 sec to
  (k).1 recognize in any query put in a given query language of the PTR^{CT}-DS an item generated in (a)-(j),
  (k).2 retrieving said item and presenting it in a representation of the PTR^{CT}-DS determinable by the user.
```

3) A method according to claim 1 or 2, being subject to the additional limitation that for all dis(y) and J(dis(y)) of Y holds that they comprise {all doc.0-MUIs disclosing Y} respectively {all doc.CT-MUIs justifying dis(y)}.

4) A method according to claim 1 or 2, subject to the additional limitation that PTR^{CT}-DS comprises for all BID-AC-concepts all SoJ(qcc(AC))-concepts.

5) A method according to claim 1 or 2, being subject to the additional limitation that its restart due to an incremental change of an item interactively performed by the user may reuse a part of the PTR^{CT}-DS generated prior to this change.

6) A method according to claim 1 or 2, being subject to the additional limitation that the PTR^{CT}-DS is implemented as one or several data objects on one or several computer systems.

7) A method according to claim 1 or 2, being subject to the additional limitation that the user may toggle anytime between several PTR^{CT}-DSes based on different document.CTs.

8) A method according to claim 1 or 2, being subject to the additional limitation that at least one normally interactively performed step (a)-(k) of generating PTR^{CT}-DS is performed automatically.

9) A method according to claim 1 or 2, being subject to the additional limitation that user-defined “technical-secondary-fact”-items of PTR^{CT}'s TT.0 may be introduced in the PTR^{CT}-DS generation as additional items.

10) A method according to claim 1 or 2, being subject to the additional limitation that the generated PTR^{CT}-DS comprises provisions for monitoring, accounting, and reporting about a range of modes of using its concepts.

11) An apparatus, controlled by a computer-implemented method, for generating for a “Problem of TT.0 and RS, PTR^{CT}” a data structure “PTR^{CT}-DS” for use by an expert system, the computer system executing the method having a processor for generating and a memory for storing PTR^{CT}-DS, the method comprising:
receiving a document.0 with marked-up items (“doc.0-MUIs”) of information disclosing a technical teaching TT.0, receiving a reference set RS of document.i with doc.i-MUIs disclosing technical teachings TT.i, i=1, 2, 3, . . . , and writing all document.i, i=0, 1, 2, 3, . . . , and their MUIs—any one called a “subject matter item”—into the PTR^{CT}-DS;
receiving a context document, document.CT, comprising an authority's directives (such as the wordings of 35 USC §§112/102/103/101) with doc.CT-MUIs of their wordings, and writing document.CT and its MUIs—any one called a “legal item”—into the PTR^{CT}-DS;
and creating further items of both kinds by the execution of this method as determined by its following steps:
(a) identifying of TT.0 of said claim of doc.0
.4 one element and generating a set comprising it, and writing said set into the PTR^{CT}-DS;
.5 the property of said element and generating a set comprising it, and writing said set into the PTR^{CT}-DS;
.6 at least one creative binary independent concept—such that the conjunction of their mirror predicates describes said property—generating for each and only this one a set comprising it, and writing any said set into the PTR^{CT}-DS;
(b) generating for any set generated in (a) a set of doc.0-MUIs disclosing its element and writing said set into the PTR^{CT}-DS;
(c) generating for any set generated in (b) a set of I.CTs justifying it and writing said set into the PTR^{CT}-DS;
repeating the steps (d)-(f) for any doc.i, i>0, and therein with any item peer to one generated in (a).1 or (a).3:
(d) generating a set comprising of TT.i either an element peer to one in step (a),1—if this peer element is not existent, replace it by a dummy peer element—or a binary independent concept of TT.i peer to one in step (a).3—if it is not existent or not equal to its peer in TT.0, replace it by a dummy peer concept—and writing said set into the PTR^{CT}-DS;
(e) generating for any set generated in (d) a set of doc.i-MUIs disclosing in doc.i the item replaced in (d) and writing said set into the PTR^{CT}-DS;
(f) generating for any set generated in (e) a set of I.CTs justifying it and writing said set into the PTR^{CT}-DS;
(g) generating the set of all anticipation combinations based on the replacements of (d) and writing it into the PTR^{CT}-DS;
(h) generating for any AC generated in (g) the set of a shortest sequences of Q 1-CCs such that AC/mod(Q-CC) ants TT.0, and writing said set into the PTR^{CT}-DS;
(i) generating for any sequence of Q 1-CCs generated in (h) a set of I.CTs justifying it and writing said set into the PTR^{CT}-DS;
(j) generating for sets generated in (a)-(i), a concatenation of which represents a test T, a set of argument chains as to this T, whereby any chain is limited to comprising sets from (a)-(i) as links, which are glued together by natural language fragments,
(k) generating for any set generated in (a)-(j) a real-time-access set, if it is needed for guaranteeing that this set's retrieval and presentation is terminated in dialog-real time and writing said set into the PTR^{CT}-DS.

12) An apparatus, according to claim 11 controlled by a computer-implemented method, which—during its generation of sets—subsequently called “items”—additionally limits these, in the steps (a)-(k), to stand for:
```
(a) (a).1 “AD-TT.0-concept” ≡ it comprises a) an element X.0.n or
    b) a predicate AD-X.0.n, 1≦n≦N, and
  (a).2 “BID-TT.0-concept” ≡ it comprises a) a BID-C.0.kⁿ, 1≦kⁿ≦Kⁿ, Σ ^{1≦n≦N} Kⁿ = K≧N, such that
    b) any AD-X.0.n of (a).1 is a conjunction of the mirror predicates BID-C.0.kⁿ of the BID-C.0.kⁿ,
(b) “SoDIS(Y.0)-concept” ≡ its element “SoDIS(Y.0)” ::= {dis(y.0) ::={MUI.0s disclosing Y.0}},
(c) “SoJ(dis(y.0))-concept” ≡ its element “SoJ(dis(y.0))” ::= {I.CTs justifying dis(y.0)},
and for any 1≦i≦l in (d)-(f)
(d) “BID-TT.i-concept” ≡ it comprises a) an element X.i.n peer to X.0.n or a peer dummy-X.i.n, or
    b) a BID-C.i.kⁿ, if it is = BID-C.0.kⁿ or a peer dummy-BID-C.i.kⁿ, 1≦kⁿ≦Kⁿ, 1≦n≦N,
(e) “SoDIS(Y.i)-concept” ≡ its element “SoDIS(Y.i)” ::= {dis(y.i) ::= {MUI.i's disclosing Y.i}},
(f) “SoJ(dis(y.i))-concept” ≡ its element “SoJ(dis(y.i))” ::= {I.CTs justifying dis(y.i)},
and further
(g) “BID-AC-concept” ≡ it comprising an AC of the PTR^{CT},
(h) “SoQCC(Y)-concept” ≡ its element “QCC(Y)” ::= {qcc(y) ::= {Q-CC I Y/mod(Q-CC) ants TT.0}},
(i) “SoJ(qcc(y))-concept” ≡ its element “J(qcc(y))” ::= {I.CTs justifying qcc(y)},
(j) “SoARGC(T)-concept” ≡ it comprises argument chains as to the execution of a test T, any chain limited to
  comprising only T-specific sets from (a)-(i) as links, being glued together by natural language fragments,
(k) “SoAccess-concept” ≡ it comprises at least one q/a-provision, which guarantees within 1 sec to
  (k).1 recognize in any query put in a given query language of the PTR^{CT}-DS an item generated in (a)-(j),
  (k).2 retrieving said item and presenting it in a representation of the PTR^{CT}-DS determinable by the user.
```

13) An apparatus according to claim 11 or 12, being subject to the additional limitation that for all dis(y) and J(dis(y)) of Y holds that they comprise {all doc.0-MUIs disclosing Y} respectively {all doc.CT-MUIs justifying dis(y)}.

14) An apparatus according to claim 11 or 12, being subject to the additional limitation that PTR^{CT}-DS comprises for all BID-AC-concepts all SoJ(qcc(AC))-concepts.

15) An apparatus according to claim 11 or 12, being subject to the additional limitation that its restart due to an incremental change of an item interactively performed by the user may reuse a part of the PTR^{CT}-DS generated prior to this change.

16) An apparatus according to claim 11 or 12, being subject to the additional limitation that the PTR^{CT}-DS is implemented as one or several data objects on one or several computer systems.

17) An apparatus according to claim 11 or 12, being subject to the additional limitation that the user may toggle anytime between several PTR^{CT}-DSes based on different document.CTs.

18) An apparatus according to claim 11 or 12, being subject to the additional limitation that at least one normally interactively performed given function of generating PTR^{CT}-DS is performed for automatically.

19) An apparatus according to claim 11 or 12, subject to the additional limitation that user-defined “technical-secondary-fact”-items of PTIRers TT.0 may be introduced in the PTR^{CT}-DS generation as additional items.

20) An apparatus according to claim 11 or 12, being subject to the additional limitation that the generated PTR^{CT}-DS comprises provisions for monitoring, accounting, and reporting about a range of modes of using its concepts.

21) An apparatus according to claim 11 or 12, being subject to the additional limitation that it is capable of acoustic word spotting for a given set of keywords and providing graphic feedback about its alleged hits.

22) An apparatus using a PTR^{CT}-DS—i.e. using a computer-generated data structure, which is stored on a tangible medium connected to said apparatus and readable by said computer and which is based on and comprising part of a given PTR^{CT}—which is capable of retrieving items of information from the PTR^{CT}-DS defined by it and by means of the provisions provided by it to this end, whereby comprising the steps
(a) reading a set of given keywords from an input device connected to this apparatus;
(b) establishing that any one of said keywords addresses one of said items;
(c) recognizing any one of said keywords on its presentation by a user to the apparatus on an input interface of it;
(d) retrieving a copy of the item addressed as to (b) by said keyword and delivering said copy to an output device connected to this apparatus for presentation to said user;
(e) performing steps (c) and (d) within one second.

23) An apparatus according to claim 22), being subject to the additional limitation that its input device and output device are those of PCs or connectable to it.

24) An apparatus according to claim 22), being subject to the additional limitation that its graphics and/or acoustic capabilities of the input device and/or the output device are user configurable.

25) An apparatus according to claim 22), being subject to the additional limitation that it is configurable to hiding part of the information items on the PTR^{CT}-DS for a given set of users.

26) An apparatus according to claim 22), being subject to the additional limitation that it is capable of adding information to part of the information items on the PTR^{CT}-DS for a given set of users.

27) An apparatus according to claim 22), being subject to the additional limitation that one said item comprises, for a BID-cr-C disclosed by doc.0 of the PTR^{CT} underlying the PTR^{CT}-DS and for a TT.i of PTR^{CT}, 0≦i≦l, a set of references to doc.i-MUIs allegedly showing they anticipate or non-anticipate said BID-cr-C.

28) An apparatus according to claim 22), being subject to the additional limitation that one said item comprises, for a BID-cr-C disclosed by doc.0 of the PTR^{CT} underlying the PTR^{CT}-DS and for a TT.i of PTR^{CT}, 0≦i≦l, and a set of references to doc.i-MUIs allegedly showing they anticipate or non-anticipate said BID-cr-C, a set of I.CT-items of said PTR^{CT}, a concatenation of which legally justifies this allegation.

29) An apparatus according to claim 22), being subject to the additional limitation that one said item comprises a statement saying, for a BID-cr-C disclosed by doc.0 of the PTRcT underlying the PTR^{CT}-DS and for any TT.i of PTR^{CT} that said BID-cr-C is anticipated or non-anticipated by this TT.i.

30) An apparatus according to claim 22), being subject to the additional limitation that one said item comprises, for a test T of said PTR^{CT} provided by said PTR^{CT}-DS and selected by the user or defined by the user and this T allegedly being passed or failed by said PTR^{CT}, a set of I.CT-items of said PTR^{CT}, a concatenation of which legally justifies this allegation.
